(19) United States
(12) Patent Application Publication
(10) Pub. No.: US 2026/0322586 A1
(43) Pub. Date: Oct. 15, 2026

(54) PIPELINED SECURE HASH ALGORITHM ARCHITECTURE

(71) Applicant: Block, Inc., Oakland, CA (US)

(72) Inventors: Vikram Suresh, Portland, OR (US); Nitisha Jain, San Jose, CA (US)

(21) Appl. No.: 19/178,283

(22) Filed: Apr. 14, 2025

(51) Int. Cl. H04L 9/06

(52) U.S. Cl. CPC H04L 9/0643

(57) ABSTRACT

Systems and methods are disclosed for secure hashing. In some examples, a primary system processes an input message using a primary message expander (ME) datapath and primary message compressor (MC) datapaths to generate intermediate hash data. The primary MC datapaths operate at a faster clock speed than the primary ME datapath operates at. Each temporal stage of the primary ME datapath outputs intermediate expanded data to a corresponding temporal stage of the primary MC datapaths. In some examples, a secondary system processes data (e.g., the intermediate hash data) using at least one secondary ME datapath and a secondary MC datapath to generate a hash digest. The at least one secondary ME datapath alternates temporally between a first ME logic configuration and a second ME logic configuration. The at least one secondary ME datapath outputs intermediate expanded data to each temporal stage of the secondary MC datapath.

### TECHNICAL FIELD

A hash algorithm is a function that converts input data into a fixed-length string of characters that is referred to as a hash value, a hash digest, or a hash. Processing the same input using a hash algorithm generally produces the same resulting hash digest, while processing different inputs using a hash algorithm generally produces different resulting hash digests.

A secure hash algorithm (SHA) is a cryptographic hashing algorithm used to encode a message into an encrypted output, referred to as a hash or a hash digest. Generally, the input message to a SHA can have an arbitrary length, but the output hash has a consistent length regardless of the length of the input message. A SHA is cryptographically secure, for instance providing collision resistance and preimage resistance, while other hashing algorithms may not be. For example, the output hash of SHA-256 has a length of 256 bits, and 32 bit word length.

Various processes used for distributed ledgers, such as mining and validation, involve use of SHA operations. Use of distributed ledger technologies, such as cryptocurrency mining, is often attributed with high levels of computational resource use (e.g., processor use) and power consumption. Hash operations using SHA account for a significant portion of the computational resource use (e.g., processor use) and power consumption for distributed ledger technologies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Moreover, multiple instances of the same part are designated by a common prefix, in some cases separated from the instance number by a dash and/or parentheses. The drawings are not to scale.

FIG. 1 is a block diagram illustrating an architecture of a hashing engine that processes a message using a primary hash process and a secondary hash process to generate a hash digest, in accordance with some examples;

FIG. 2 is a block diagram illustrating an architecture of a hashing engine that includes five message expander (ME) datapaths and eight message compressor (MC) datapaths, in accordance with some examples;

FIG. 3 is a block diagram illustrating a primary hash process for a hashing engine, including an expander datapath indicating timing of logic and flops for an ME as well as multiple compressor datapaths corresponding to timing of logic and flops for multiple MCs, where the ME and the MCs share a clock speed, in accordance with some examples;

FIG. 4 is a block diagram illustrating a primary hash process for a hashing engine, including an expander datapath indicating timing of logic and flops for an ME as well as multiple compressor datapaths corresponding to timing of logic and flops for multiple MCs, where the MCs operate according to a faster clock speed than the ME, in accordance with some examples;

FIG. 5 is a block diagram illustrating an architecture of a hashing engine that includes nine ME datapaths and eight MC datapaths, in accordance with some examples;

FIG. 6 is a block diagram illustrating a secondary hash process for a hashing engine, including an expander datapath indicating timing of logic and flops for an ME as well as a compressor datapath corresponding to timing of logic and flops for an MC, where the ME temporally alternates between performing ME logic and not performing ME logic, in accordance with some examples;

FIG. 7 is a block diagram illustrating a secondary hash process for a hashing engine, including two expander datapaths indicating timing of logic and flops for ME(s) as well as a compressor datapath corresponding to timing of logic and flops for an MC, where a multiplexer temporally alternates which of the two expander datapaths the multiplexer routes intermediate expanded data from to the compressor datapath, in accordance with some examples;

FIG. 8 is a block diagram illustrating a secondary hash process for a hashing engine, including two expander datapaths indicating timing of logic and flops for ME(s) as well as a compressor datapath corresponding to timing of logic and flops for an MC, where the two expander datapaths both use shared ME logic, and where a multiplexer temporally alternates which of the two expander datapaths use the shared ME logic, in accordance with some examples;

FIG. 9 is a block diagram illustrating an architecture of a hashing engine that includes five ME datapaths and six MC datapaths, in accordance with some examples;

FIG. 10 is a table illustrating examples of power, performance, and area (PPA) for different hashing engines, in accordance with some examples;

FIG. 11 is a table illustrating examples of power, performance, and area (PPA) for different technology nodes, in accordance with some examples;

FIG. 12 is a block diagram illustrating an architecture of a hashing engine that includes five message expander (ME) datapaths and eight message compressor (MC) datapaths, in accordance with some examples;

FIG. 13 is a block diagram illustrating an example of a mining system that includes one control board, three hashboards, four fans, and a power supply unit, in accordance with some examples;

FIG. 14 is a block diagram illustrating an architecture of a mining hashboard, in accordance with some examples;

FIG. 15 is an isometric diagram illustrating a mining system with hashboards, a control board, fans, and a power supply unit within a housing, in accordance with some examples;

FIG. 16 is a flow diagram illustrating a process for hashing (e.g., for a primary hash process), in accordance with some examples;

FIG. 17 is a flow diagram illustrating a process for hashing (e.g., for a secondary hash process), in accordance with some examples;

FIG. 18 is a block diagram illustrating an example environment for providing an application and/or for customizing the application for different platforms, in accordance with some examples;

FIG. 19 is a block diagram illustrating an example environment including a service provider system which may be associated with the server(s) of FIG. 18, in accordance with some examples; and

FIG. 20 is a block diagram illustrating a system for performing techniques described herein, in accordance with some examples.

### DETAILED DESCRIPTION

Secure hashing algorithms, such as SHA-256, provide a high level of security and are used in distributed ledger operations such as mining of cryptocurrency (e.g., Bitcoin). For instance, under a Proof of Work (PoW) consensus mechanism, mining of cryptocurrency involves a mining system validating and adding new transactions to a distributed ledger (e.g., by solving cryptographic puzzles using a SHA such as SHA-256), for which the mining system is rewarded with an amount of a cryptocurrency. In some cases, cryptocurrency mining systems can include one or more hashboards. A hashboard is a circuit board, such as a printed circuit board (PCB), that hosts an array of mining chips or hashing chips, such as mining application specific integrated circuits (ASICs) or hashing ASICs. ASICs are integrated circuits that are customized for a particular or specialized use, rather than general use. In some examples, the array of mining chips can be controlled by a control board or control chip, which can allocate different hashing operations to different mining chips so that different hashing operations can be performed in parallel, improving efficiency and throughput over more centralized processing systems. SHA algorithms are also used in other security applications, such as secure communications over networks.

SHA algorithms include message expanders (MEs) and message compressors (MCs). In the context of a SHA, MEs extend an input message into multiple blocks to ensure sufficient diffusion and complexity before processing. MCs then iteratively condense these expanded blocks into a fixed-size hash value using bitwise operations, modular arithmetic, and/or logical functions (e.g., combinatorial logic). The combination of MEs and MCs improves security by making it difficult to reverse-engineer the original input or generate collisions (i.e., two different inputs that produce the same resulting hash digest when hashed).

Certain SHA cores for performing certain SHA algorithms, such as SHA-256, can be divided temporally into multiple stages. For instance, the SHA-256 core can be divided into a primary stage (or first stage) and a secondary stage (or second stage). An input message is input into the primary stage (or first stage), which produces an intermediate result. The intermediate result can be referred to as intermediate hash data. The intermediate result is input into the secondary stage (or second stage), which produces the hash digest of the input message. In some examples, the primary stage (or first stage) of a SHA (e.g., SHA-256) can be, can be based on, and/or can include a SHA-1 algorithm or similar algorithm. In some examples, the secondary stage (or second stage) of a SHA (e.g., SHA-256) can be, can be based on, and/or can include a SHA-2 algorithm or similar algorithm.

Different stages of a SHA can be processed in different ways, and can have different hardware limitations in terms of how they can be processed. For instance, in some examples, the primary stage (or first stage) (e.g., SHA-1) of a SHA (e.g., SHA-256) can be processed such that one message expander (ME) can be shared amongst (e.g., provide its outputs to) multiple message compressors (MCs). Sharing of ME logic can improve throughput and efficiency in the primary stage (or first stage) (e.g., SHA-1) of the SHA (e.g., SHA-256) and/or in the secondary stage (or second stage) (e.g., SHA-2) of the SHA (e.g., SHA-256). In some examples, the secondary stage (or second stage) (e.g., SHA-2) of the SHA (e.g., SHA-256) can be processed such that one message expander (ME) is used for each message compressor (MC), and/or vice versa.

One technical limitation of certain hashing engines is limited throughput, being constrained by performance of single-round logic operations, with opportunities for data insertion in datapaths limited to flops in between logic operations. The systems and methods described herein split certain logic operations in two, with an additional data insertion opportunity at a flop inserted in between two portions of each such logic operation, ultimately increasing throughput. In some examples, the systems and methods described herein also increase the quantity of certain types of datapaths relative to other types of datapaths (e.g., increasing the quantity of MC datapaths relative to ME datapaths, or vice versa) to allow parallel processing of certain types of logic (e.g., ME logic and/or MC logic) to further improve throughput.

In cryptocurrency mining and in many other SHA use cases, throughput (e.g., hashes per second) is one of the most important metrics, so this improvement in throughput is a significant improvement. For instance, in cryptocurrency mining throughput (e.g., hashes per second) is generally considered more important than latency (e.g., the time to generate the first hash result). By using temporal shared version unrolling, the systems and methods described herein can keep adding pipeline stages where they matter the most (e.g., in the MC) without needing to add equally deep pipelines everywhere else, since ME logic can be reused across multiple temporal cycles.

By splitting logic rounds (e.g., in an unconventional manner) and adding additional flops (e.g., to add data insertion opportunities) in between the split portions of logic, by processing certain functions in parallel, and by using temporal shared version unrolling, systems and methods discussed herein provide for improved memory management (e.g., using the flops) and improved hash processing. Improved hash processing in a SHA amounts to an improved cryptographic technique, resulting in improved security for cryptocurrency mining, secure communications over networks, and other applications of SHA.

Another technical limitation of certain hashing engines is logic reliability at certain voltages and/or technology nodes. Technology nodes represents the size of features such as transistors, generally in nanometers (nm). For instance, some newer technology nodes that use smaller components (e.g., smaller transistors) may work better (e.g., or even require) lower voltages than older technology nodes with larger components (e.g., larger transistors), so improving reliability with such voltages can allow use of newer technology nodes, and can allow for smaller (e.g., more portable) and more efficient systems. As noted above, the systems and methods described herein split certain logic operations in two, which can also improve reliability with certain voltages (e.g., lower voltages than other hashing engines) and/or technology nodes (e.g., smaller transistors and/or other components than other hashing engines). For instance, inserting a flop in between portions of a logic operation can give a processor more time to complete each portion of the logic operation, if needed. In some examples, systems and methods described also improve flexibility by increasing the number of flops (and therefore the number of opportunities for data insertion) in certain datapaths, improving reliability further by allowing for data to still be transferred on time between an ME datapath and an MC datapath even if the start of data transfer is delayed.

By improving reliability and flexibility of SHA as discussed above, the systems and methods discussed herein provide for a reduction in hashing error frequency, ultimately improving hashing quality and improving security for cryptocurrency mining, secure communications over networks, and other applications of SHA.

Another technical limitation of certain hashing engines is unnecessary power consumption due to glitch power consumption. Glitch power consumption occurs when digital circuits experience unnecessary signal transitions before logic elements stabilize, causing transistors to switch states multiple times without performing useful computation. These unintended state changes can consume electrical energy wastefully. For instance, in some cases, each transition can require power to charge and discharge circuit capacitances. In complex digital systems like SHA-256 mining hardware, glitch power can represent a significant portion of total power consumption, especially when input signals arrive at slightly different times and cause spurious logic state changes. As noted above, the systems and methods described herein split certain logic operations in two, inserting an additional flop (and therefore an opportunity for data insertion) in between portions of the logic operations. In some examples, the systems and methods described herein can block data transfer and/or insertion between datapaths (e.g., from an ME datapath to an MC datapath, or vice versa) until all data is settled and ready to transfer, preventing spurious logic state changes and/or signal transfers or transitions. This reduction in glitch power consumption ultimately reduces total power consumption in the systems and methods described herein, relative to other hashing engines.

In some cases, a reduction in power consumption in the systems and methods described herein (e.g., by reducing glitch power consumption as discussed above) can also reduce the need for thermal management systems (e.g., passive thermal management systems and/or active thermal management systems), such as heat sinks, heat spreaders, fans, liquid cooling systems, heat pumps, coolers, and/or other cooling systems. Reducing the need for thermal management systems can also further reduce total power consumption (e.g., by reducing use of active thermal management systems such as fans or pump-based liquid cooling systems that use power themselves) and/or reduce size (e.g., by reducing the size and/or quantity of heat sinks or other thermal management systems).

As noted above, in some examples, the systems and methods described herein also increase the quantity of certain types of datapaths relative to other types of datapaths (e.g., increasing the quantity of MC datapaths relative to ME datapaths, or vice versa) to allow parallel processing of certain types of logic (e.g., ME logic and/or MC logic) to further improve throughput. This increased datapath count, and the resulting parallel processing, can prevent missed or delayed data transfers and can thus further reduce total frequency and/or amount of flip-flops from start of hashing to completion of hashing.

In some examples, the systems and methods described herein run the ME datapath(s) (e.g., logic) and the MC datapath(s) (e.g., logic) at different clock speeds (e.g., at different rates). In some examples, to maintain synchronization between the ME datapath(s) and the MC datapath(s), and therefore to maintain data coherence, the systems and methods described herein can provide multiple datapaths that alternate based on which datapath receives (using a flop) and/or processes (using logic) data from the other datapath(s). For instance, the systems and methods described herein can use two ME datapaths that can alternate temporally which ME datapath receives data (e.g., from an MC datapath) using its flops in a given cycle. In some cases, the two ME datapaths can include their own ME logic, or can share ME logic. The systems and methods described herein can also alternate temporally which ME datapath sends its data out (e.g., to an MC datapath) in a given cycle. This can provide for improved expander-compressor synchronization, improved data coherence, and/or improved flexibility and reliability in running the ME and MC at different clock speeds.

Systems and methods are disclosed for secure hashing. In some examples, a primary system (e.g., associated with a primary hash process such as a SHA-1 portion of the SHA-256 algorithm) receives an input message, and processes the input message using a primary message expander (ME) datapath and primary message compressor (MC) datapaths to generate intermediate hash data. The primary MC datapaths operate at a faster clock speed (e.g., at least double) than the primary ME datapath operates at. Each temporal stage of the primary ME datapath outputs intermediate expanded data to a corresponding temporal stage of the primary MC datapaths. The primary system can output the intermediate hash data (e.g., to a secondary system).

In some examples, a secondary system (e.g., associated with a secondary hash process such as a SHA-2 portion of the SHA-256 algorithm) receives data (e.g., the intermediate hash data from the primary system) and processes the data using at least one secondary ME datapath and a secondary MC datapath to generate a hash digest (e.g., of the data and/or of the input message received by the secondary system from the primary system). The at least one secondary ME datapath alternates temporally between a first ME logic configuration and a second ME logic configuration. The at least one secondary ME datapath outputs intermediate expanded data to each temporal stage of the secondary MC datapath. The secondary system outputs the hash digest.

In a first illustrative example of the secondary system, the at least one secondary ME datapath includes a single ME datapath. The single ME datapath performs ME logic under the first ME logic configuration, and the single ME datapath waits (without performing ME logic) under the second ME logic configuration. In some examples, the logic from the single ME datapath can be split across multiple ME datapaths.

In a second illustrative example of the secondary system, the at least one secondary ME datapath includes a first ME datapath that performs first ME datapath logic and a second ME datapath that performs second ME datapath logic. A multiplexer routes the intermediate expanded data from the first ME datapath to the secondary MC datapath under the first ME logic configuration, and the multiplexer routes the intermediate expanded data from the second ME datapath to the secondary MC datapath under the second ME logic configuration.

In a third illustrative example of the secondary system, the at least one secondary ME datapath includes a first ME datapath that uses a shared ME logic and a second ME datapath that uses the shared ME logic. A multiplexer causes the shared ME logic to be performed under the first ME datapath under the first ME logic configuration, and the multiplexer causes the shared ME logic to be performed under the second ME datapath under the second ME logic configuration.

In some examples, the mining ASICs on a hashboard or other hashing system can perform hashing calculations and/or other complex computations to drive distributed ledger processes, such as cryptocurrency mining processes. For example, the hashing chips can hash a dataset (e.g., associated with a block of a blockchain ledger) that includes an interchangeable nonce value (e.g., in the header of the block) multiple times, each time with the nonce value set to a different value, to produce multiple hashes, until one of the hashes is within a target range associated with at least one threshold (e.g., below the threshold, above the threshold, between two thresholds, etc.). The threshold may be associated with a mining difficulty setting. In some cases, producing a hash that falls within the target range provides a reward (e.g., an amount of a cryptocurrency or another asset) and allows an associated block to be appended to the distributed ledger. In some examples, the hash algorithm may be a secure hash algorithm (SHA), such as SHA-256 or SHA-1456.

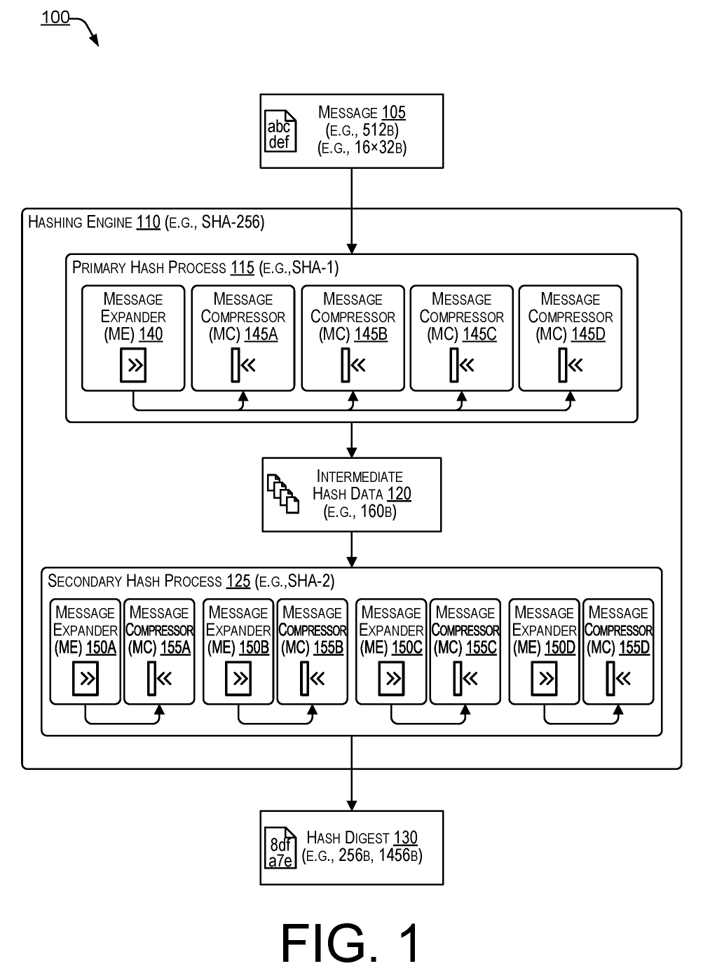

Various aspects of the application will be described with respect to the figures. FIG. 1 is a block diagram illustrating an architecture of a hashing engine 110, according to some examples of the present subject matter. In some examples, the hashing engine 110 performs a hashing process 100 by receiving a message 105, processing the message 105 to generate a hash digest 130, and outputting the hash digest 130. In some examples, the hashing process 100 performed by the hashing engine 110 is a secure hash algorithm (SHA) process, such as SHA-256.

The hashing process 100 performed by the hashing engine 110 includes a primary hash process 115 and a secondary hash process 125. The hashing engine 110 first processes the message 105 using the primary hash process 115 to generate intermediate hash data 120. The hashing engine 110 processes the intermediate hash data 120 further using the secondary hash process 125 to ultimately generate the hash digest 130 of the message 105. The intermediate hash data 120 may also be referred to as a hash, a hash digest, hash data, digest data, hash digest data, intermediate data, intermediate digest data, intermediate hash digest data, partially-hashed data, partially-hashed digest data, or a combination thereof.

In some examples, the primary hash process 115 generates a first hash value. This first hash value (which can be referred to as the intermediate hash data 120) is then used as the input message for the secondary hash process 125. The hash digest 130 generated by the secondary process is the output used for Bitcoin proof-of-work.

The hashing engine 110 includes multiple message expanders (MEs) and message compressors (MCs). In the context of a SHA, MEs extend an input message into multiple blocks to ensure sufficient diffusion and complexity before processing. MCs then iteratively condense these expanded blocks into a fixed-size hash value using bitwise operations, modular arithmetic, and/or logical functions (e.g., combinatorial logic).

In some examples, the primary hash process 115 of the hashing engine 110 represents a SHA-1 sub-routine of the overall SHA process (e.g., SHA-256 process) performed by the hashing engine 110. The primary hash process 115 is illustrated as including multiple MCs 145A-145D for each ME 140. Arrows are illustrated from the ME 140 to the MCs 145A-145D, indicating that the ME 140 outputs intermediate expanded data to the MCs 145A-145D as part of the primary hash process 115.

In some examples, the secondary hash process 125 of the hashing engine 110 represents a SHA-2 sub-routine of the overall SHA process (e.g., SHA-256 process) performed by the hashing engine 110. The secondary hash process 125 is illustrated as including one MC (of a set of MCs 155A-155D) for each ME (of a set of MEs 150A-150D). Arrows are illustrated from each ME (of the MEs 150A-150D) to the corresponding MC (of the MCs 155A-155D), indicating that each ME (of the MEs 150A-150D) outputs intermediate expanded data to the corresponding MC (of the MCs 155A-155D) as part of the secondary hash process 125.

In some examples, the hashing engine 110 receives the message 105 (e.g., receives the 16 32-bit message blocks of the message 105) and processes the blocks of the message 105 to generate words. In some examples, one or more MEs of the hashing engine 110 generate 48 words, with each word being 32 bits in size. In some examples, the one or more MEs of the hashing engine 110 generate the words using a number of bit-shift and/or bit rotation operations. In some examples, to reduce reads and/or writes to memory, the one or more MEs of the hashing engine 110 can simulate the bit-shift and/or bit rotation operations using multiplexers and/or demultiplexers using at-memory computing (AMC) techniques, for instance by changing references (e.g., data pointers) to content rather than moving the content itself. In some cases, the words can be referred to as the message schedule.

In some examples, the words are input into the one or more MCs of the hashing engine 110. In some examples, the 16 words from the message 105 and the 48 words generated by the one or more MEs (together adding up to 64 words) are input into the one or more MCs of the hashing engine 110. In some examples, one or more MCs of the hashing engine 110 also receives initial H states for data storage circuit elements (e.g., registers and/or data storage circuit elements) of the one or more MCs. The initial H states can refer to initial hash values for a number of registers in the one or more MCs. The one or more MCs of the hashing engine 110 process the words and/or the initial H states to generate output words. In some examples, the one or more MCs of the hashing engine 110 generate 8 output words, with each output word being 32 bits in size. In some examples, the one or more MCs of the hashing engine 110 generate the output words using a number of bit-shift and/or bit rotation operations. In some examples, to reduce reads and/or writes to memory, the one or more MCs of the hashing engine 110 can simulate the bit-shift and/or bit rotation operations using multiplexers and/or demultiplexers using AMC techniques, for instance by changing references (e.g., data pointers) to content rather than moving the content itself.

An icon representing the message 105 in FIG. 1 illustrates document with a human-comprehensible string reading “abcdef.” An icon representing the hash digest 130 in FIG. 1 illustrates a document with a hash reading “8dfa7e” corresponding to the human-comprehensible string reading “abcdef” representing the message 105. In some examples, the intermediate hash data 120 is a hash, similar to the hash digest 130. In some examples, the intermediate hash data 120 can include a set of words as discussed above, for instance the output words generated using the MCs 145A-145D of the primary hash process 115. The intermediate hash data 120 can be is represented by an icon showing series of documents (e.g., representing words and/or other data within the intermediate hash data 120).

The bit sizes illustrated for the message 105 and the hash digest 130 in FIG. 1 represent bit sizes that can be used under SHA-256. For instance, FIG. 1 indicates that the message 105 can be 512 bits, and/or can be split into 16 blocks with 32 bits each. Additionally, FIG. 1 indicates that the hash digest 130 can be 256 bits and/or 1456 bits. Words (not illustrated in FIG. 1) can be 32 bits in size. In some examples, the hashing engine 110 can be used for different types of SHA algorithms than SHA-256. For instance, under SHA-512, the hash digest 130 may be 512 bits in size, and the words can be 64 bits in size. Under SHA-224, the hash digest 130 may be 224 bits in size. Under SHA-384, the hash digest 130 may be 384 bits in size. Under SHA-1456, the hash digest 130 may be 1456 bits in size. Under SHA-0 or SHA-1, the hash digest 130 may be 160 bits in size. Under MD2, MD4, and MD5 message digest (hashing) algorithms, the hash digest 130 may be 128 bits in size. Under SHAKE128 or SHAKE256, the hash digest 130 may be an arbitrary size. Under the SHA-2 family, the hash digest 130 can be a number of different sizes based on the specific algorithm in the SHA-2 family, such as 224 bits, 256 bits, 384 bits, 512 bits, 1456 bits, or other sizes.

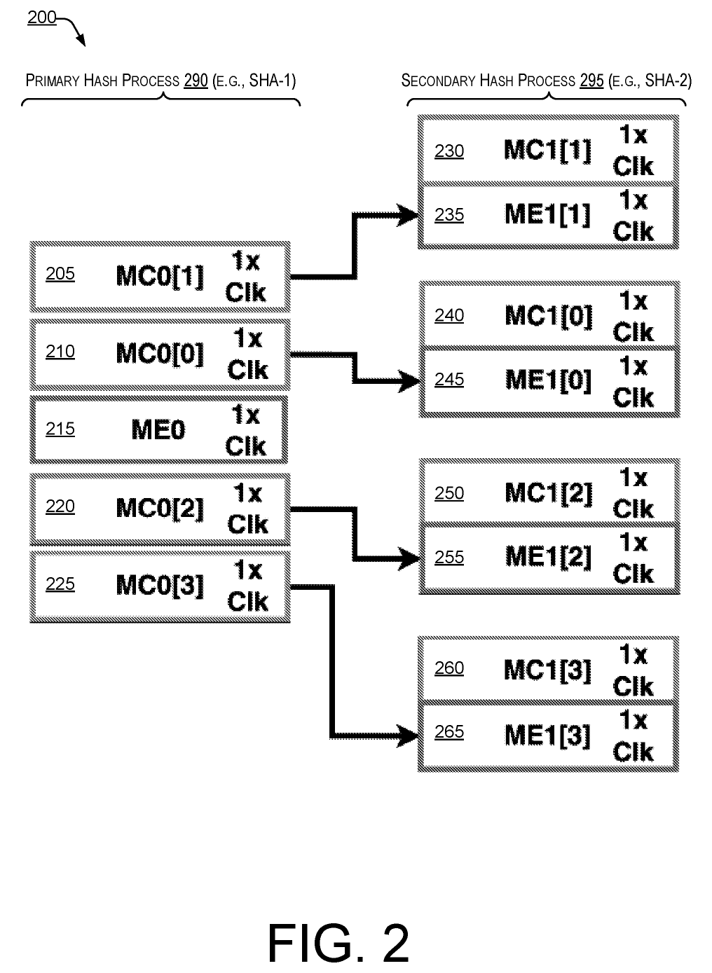

FIG. 2 is a block diagram illustrating an architecture of a hashing engine 200 that includes five message expander (ME) datapaths and eight message compressor (MC) datapaths. The hashing engine 200 is an example of the hashing engine 110. The hashing engine 200 performs a hashing process, which is an example of the hashing process 100. The hashing engine 200 includes a primary hash process 290, which is an example of the primary hash process 115 and may be a SHA-1 sub-routine of a SHA-256 process. The hashing engine 200 includes a secondary hash process 295, which is an example of the secondary hash process 125 and may be a SHA-2 sub-routine of the SHA-256 process.

The primary hash process 290 of the hashing engine 200 includes one ME 215 (labeled ME0) having a 1x clock speed. The primary hash process 290 of the hashing engine 200 includes four MCs, each also having a 1x clock speed. The four MCs of the primary hash process 290 include MC 205 (labeled MC0[1]), MC 210 (labeled MC0[0]), MC 220 (labeled MC0[2]), and MC 225 (labeled MC0[3]).

The secondary hash process 295 of the hashing engine 200 includes four expander-compressor pairs that each include one ME and one MC, all having a 1x clock speed. A first expander-compressor pair of the secondary hash process 295 includes MC 230 (labeled MC1[1]) and corresponding ME 235 (labeled ME1[1]). A second expander-compressor pair of the secondary hash process 295 includes MC 240 (labeled MC1[0]) and corresponding ME 245 (labeled ME1[0]). A third expander-compressor pair of the secondary hash process 295 includes MC 250 (labeled MC1[2]) and corresponding ME 255 (labeled ME1[2]). A fourth expander-compressor pair of the secondary hash process 295 includes MC 260 (labeled MC1[3]) and corresponding ME 265 (labeled ME1[3]).

In some examples, within the primary hash process 290, outputs of the ME 215 are transferred to the MC 205, the MC 210, the MC 220, and/or the MC 225. The intermediate hash data 120 generated by the primary hash process 290 and transferred to the secondary hash process 295 can include data from the MC 205, the MC 210, the MC 220, and/or the MC 225. In some examples, data generated by the MC 205 is output (e.g., as part of the intermediate hash data 120) to the ME 235, which processes this data and sends it to the MC 230, which processes this data and outputs it as part of the hash digest 130 generated by the hashing engine 200. In some examples, data generated by the MC 210 is output (e.g., as part of the intermediate hash data 120) to the ME 245, which processes this data and sends it to the MC 240, which processes this data and outputs it as part of the hash digest 130 generated by the hashing engine 200. In some examples, data generated by the MC 220 is output (e.g., as part of the intermediate hash data 120) to the ME 255, which processes this data and sends it to the MC 250, which processes this data and outputs it as part of the hash digest 130 generated by the hashing engine 200. In some examples, data generated by the MC 225 is output (e.g., as part of the intermediate hash data 120) to the ME 265, which processes this data and sends it to the MC 260, which processes this data and outputs it as part of the hash digest 130 generated by the hashing engine 200.

In the primary hash process 290, the ratio of four MCs to one ME, combined with the shared clock speed (1x) between MCs and MEs, can be referred to as a 4:1 ASIC boost. As noted above, all of the MEs and MCs in the hashing engine 200 operate at a 1x clock speed (or clock frequency). In some examples, all of the MEs and MCs in the hashing engine 200 perform one round of compute (e.g., one round of ME logic or MC logic, respectively) per pipeline stage (e.g., per clock cycle).

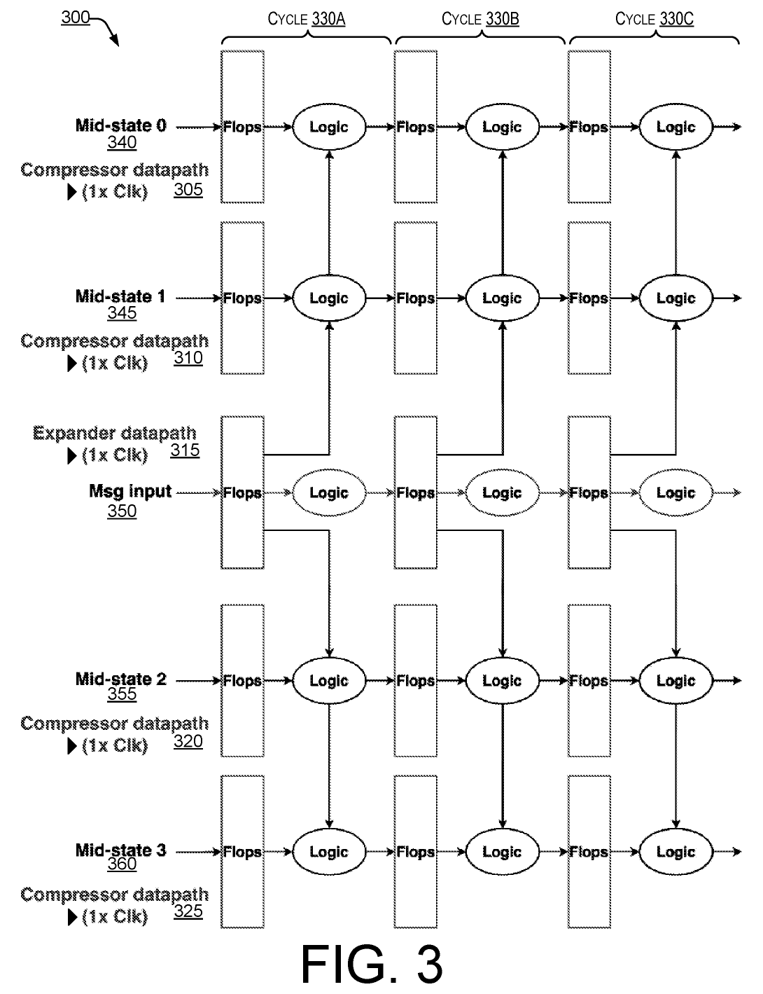

FIG. 3 is a block diagram illustrating a primary hash process for a hashing engine 300, including an expander datapath 315 indicating timing of logic and flops for an ME as well as multiple compressor datapaths corresponding to timing of logic and flops for multiple MCs, where the ME and the MCs share a clock speed. The hashing engine 300 is an example of the hashing engine 200 and/or the hashing process 100. The expander datapath 315 receives a message input 350, which may be an example of the message 105 or a portion thereof (e.g., one of a set of blocks that the message 105 is split into).

The compressor datapaths include a compressor datapath 305 that receives a mid-state 0 340, a compressor datapath 310 that receives a mid-state 1 345, a compressor datapath 320 that receives a mid-state 2 355, and a compressor datapath 325 that receives a mid-state 3 360. The mid-states are intermediate hash values (or chaining values) that represents the state of the hash calculation after processing a portion of the input message. In some examples, the mid-states are received by the compressor datapaths (e.g., by the MCs of the hashing engine 300) from the expander datapath 315 (e.g., from the ME of the hashing engine 300).

The expander datapath 315 and the compressor datapaths (e.g., compressor datapath 305, compressor datapath 310, compressor datapath 320, and compressor datapath 325) all operate according to a 1x clock speed or clock frequency. Thus, clock cycles 330A-330C have the same length for the expander datapath 315 and the compressor datapaths. The operations of the hashing engine 300 are illustrated in FIG. 3 temporally on a cycle by cycle basis, with three cycles (e.g., cycle 330A, cycle 330B. and cycle 330C) illustrated.

For both the expander datapath 315 and the compressor datapaths, each of the cycles 330A-330C includes a flop and a round of logic. Flops may also be referred to as flip-flops or latches. Flops or latches refer to a circuit with two stable states that can be used to store data (e.g., binary data). The stored data can be changed by applying varying inputs. Flops and/or latches can be used as data storage elements, for instance for sequential logic. In some examples, flops (latches) can be level-triggered (outputs can change as soon as the inputs change). In some examples, flops (flip-flops) can be edge-triggered (only changes state when a control signal goes from high to low or low to high).

In some examples, the flops of the expander datapath 315 can store expanded data generated by the ME of the hashing engine 300. The expander datapath 315 can output the expanded data that’s stored in the flops in a given cycle to be stored in the respective flops of the compressor datapaths (e.g., compressor datapath 305, compressor datapath 310, compressor datapath 320, and compressor datapath 325), for instance in the same cycle or the next cycle. This expanded data can be referred to as expanded data, intermediate data intermediate expanded data, or a combination thereof

In an illustrative example, the expander datapath 315 can store data from the message input 350 in the flop(s) of the cycle 330A. This data from the message input 350 can be transferred over from the flop(s) of the expander datapath 315 to the logic and/or flop(s) of the compressor datapaths (e.g., compressor datapath 305, compressor datapath 310, compressor datapath 320, and compressor datapath 325) in the cycle 330A and/or the cycle 330B. The expander datapath 315 can process the data from the message input 350 using the logic in cycle 330A to generate intermediate expanded data, and store at least a subset of the intermediate expanded data (e.g., one or more words) in the flop of cycle 330B. In some examples, at least a subset of the intermediate expanded data that is stored in the flop(s) of the expander datapath 315 at cycle 330B (e.g., one or more words) is transferred over to the logic and/or flop(s) of the compressor datapaths in the cycle 330B and/or the cycle 330C. In this way, intermediate expanded data from the expander datapath 315 is transferred to the compressor datapaths along the hashing process, allowing the compressor datapaths to process the intermediate expanded data in parallel to improve efficiency.

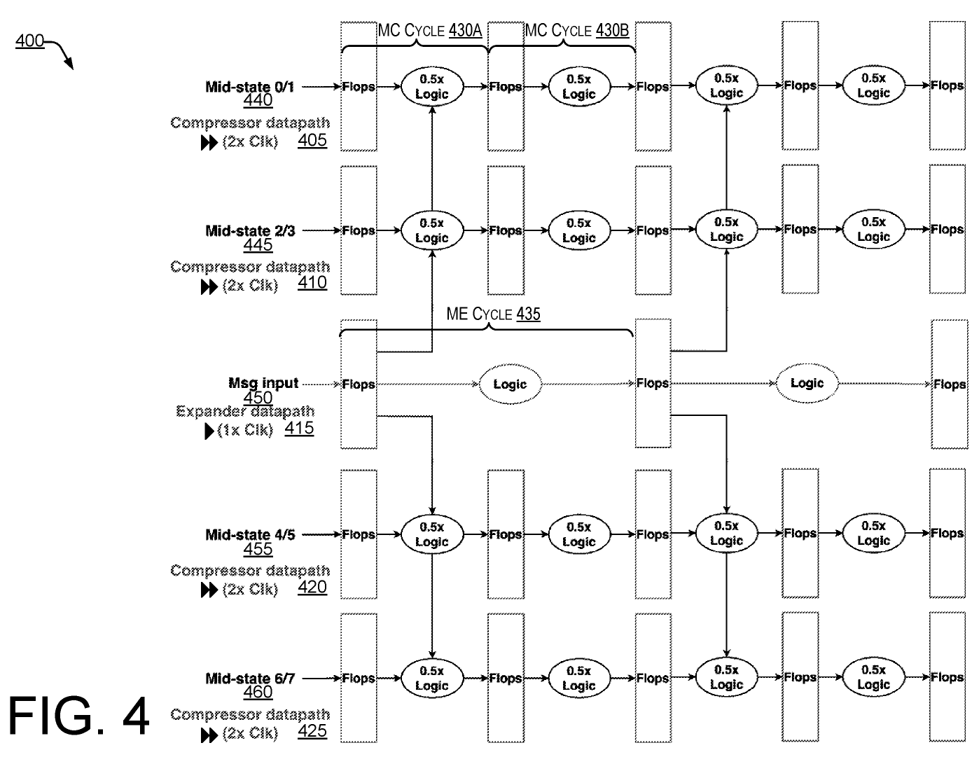

FIG. 4 is a block diagram illustrating a primary hash process for a hashing engine 400, including an expander datapath 415 indicating timing of logic and flops for an ME as well as multiple compressor datapaths corresponding to timing of logic and flops for multiple MCs, where the MCs operate according to a faster clock speed than the ME. The expander datapath 415 receives a message input 450, which may be an example of the message 105 or a portion thereof (e.g., one of a set of blocks that the message 105 is split into).

The hashing engine 400 is an example of the hashing process 100. The hashing engine 400 is similar to the hashing engine 300 and the hashing engine 200, but the compressor datapaths in the hashing engine 400 operate at a faster clock speed than the expander datapath 415.

The compressor datapaths include a compressor datapath 405 that receives mid-state(s) 0/1 440, a compressor datapath 410 that receives mid-state(s) 2/3 445, a compressor datapath 420 that receives mid-state(s) 4/5 455, and a compressor datapath 425 that receives mid-state(s) 6/7 460. In some examples, the compressor datapaths (MCs) can receive two mid-states for each ME cycle (e.g., ME cycle 435), for instance one per MC cycle (e.g., one mid-state for MC cycle 430A and one mid-state for MC cycle 430B). This increases throughput of the hashing engine 400 relative to the hashing engine 300.

The compressor datapaths (e.g., compressor datapath 405, compressor datapath 410, compressor datapath 420, and compressor datapath 425) are illustrated in FIG. 4 as operating at a 2x clock speed, while the expander datapath 415 operates at a 1x clock speed. In other words, the compressor datapaths operate at double the clock speed that the expander datapath 415 operates at. Thus, each ME cycle (clock cycle that the expander datapath 415 operates according to) is twice as long as each MC cycle (clock cycle that the compressor datapaths operate according to). For instance, the ME cycle 435 is long enough to include both the MC cycle 430A and the MC cycle 430B.

During each ME cycle (including the ME cycle 435), the expander datapath 415 includes a flop and a full round of ME logic (indicated by the oval with the word “Logic”). During each MC cycle (including the MC cycles 430A-430B), the compressor datapaths each include a flop and a partial round (e.g., half round) of MC logic (indicated by the oval with the words “0.5x Logic”).

In hashing systems that use the same clock speed for the expander datapath (ME) and the compressor datapath(s) (MC(s)) (e.g., as in the hashing engine 200 and the hashing engine 300), intermediate expanded data (e.g., word data) from the expander datapath (ME) sometimes fails to reach the compressor datapath(s) (MC(s)) in time, causing wasted power on spurious switching (referred to as glitching power) and a loss in throughput (hashes per second). Similarly, in some examples, data between MC flops can fail to reach on time. These issues can be exacerbated in hashing systems that operate on a lower voltage, such as hashing systems that use certain technology nodes. By operating the compressor datapath(s) (MC(s)) at a faster clock rate than the expander datapath (ME), each compressor datapath (MC) has two flops for every one flop in the expander datapath (ME) (e.g., the ME cycle 435 includes the flop(s) in the MC cycle 430A and the flop(s) in the MC cycle 430B), giving the compressor datapath (MC) two opportunities to receive word data from the expander datapath (ME). This improves throughput and reliability, reduces errors, and reduces power consumption (e.g., by reducing glitching power).

While the hashing engine 400 is illustrated as having the compressor datapaths (MC) operate at double the clock speed than the expander datapath 415 (ME) operates at, in some examples, the compressor datapaths (MC) operate and expander datapath 415 (ME) can operate at different relative speeds. In some examples, the compressor datapaths (MC) operate faster than the clock speed than the expander datapath 415 (ME) operates at. In some examples, the compressor datapaths (MC) operate at least at double (e.g., double (2x), triple (3x), quadruple (4x), 5x, 6x, 7x, 8x, 9x, or 10x) the clock speed than the expander datapath 415 (ME) operates at.

The compressor datapaths (MCs) each performing a partial round (e.g., half round) of MC logic (indicated by the oval with the words “0.5x Logic”) per MC cycle (e.g., MC cycles 430A-340B) can be referred to as splitting the logic of the compressor datapaths (MCs). This reduced proportion of MC logic per MC cycle allows the compressor datapaths (MCs) to operate at a faster clock speed than the expander datapath 415 (ME) operates at, without putting too much strain on the processor(s) (e.g., the ASICs). In some examples, the expander datapath 415 (ME) can also have split logic, for instance performing a partial round of ME logic per ME cycle (e.g., ME cycle 435).

The hashing engine 300 can be referred to as having a 4:1 ASIC boost. The hashing engine 400 can be referred to as having an 8:1 ASIC boost based on having a double pipelined datapath; that is, two MC cycles (e.g., MC cycles 430A-430B) per ME cycle (e.g., ME cycle 435). The 8:1 ASIC boost can refer to the fact that, for every one ME cycle (e.g., ME cycle 435) by the expander datapath 415 (ME), the compressor datapaths (MCs) collectively performs eight MC cycles (e.g., four compressor datapaths each performing two MC cycles). Because each MC cycle has a flop, the compressor datapaths can ingest twice as many mid-states, increasing throughput and reliability.

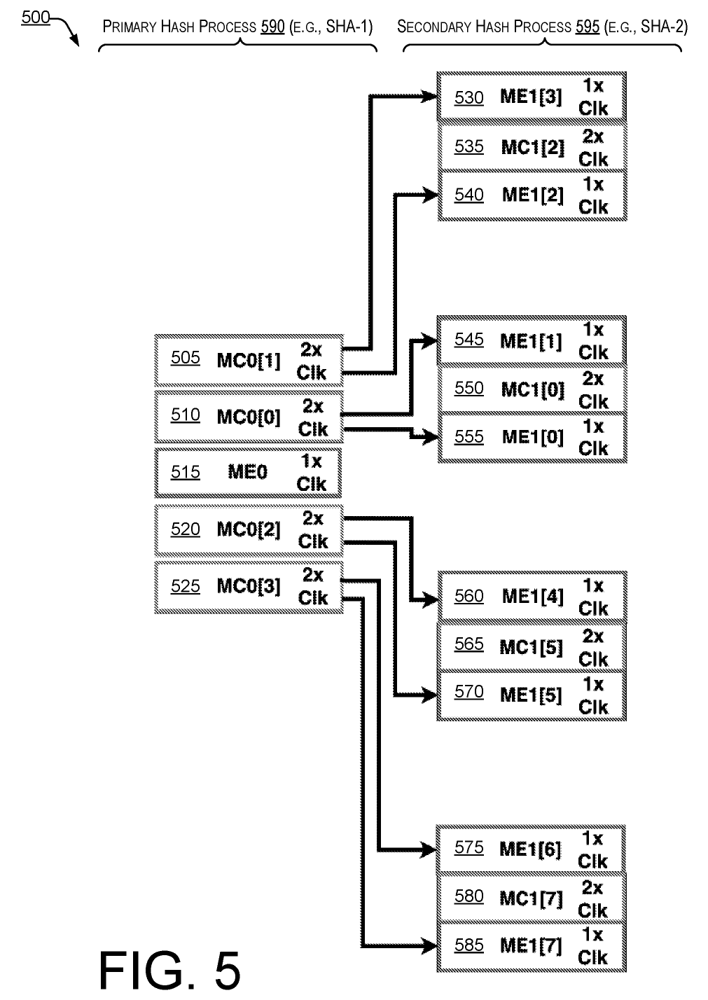

FIG. 5 is a block diagram illustrating an architecture of a hashing engine 500 that includes nine ME datapaths and eight MC datapaths. The hashing engine 500 is an example of the hashing engine 110. The hashing engine 500 performs a hashing process, which is an example of the hashing process 100. The hashing engine 500 includes a primary hash process 590, which is an example of the primary hash process 115 and may be a SHA-1 sub-routine of a SHA-256 process. The hashing engine 500 includes a secondary hash process 595, which is an example of the secondary hash process 125 and may be a SHA-2 sub-routine of the SHA-256 process.

The primary hash process 590 of the hashing engine 500 includes one ME 515 (labeled ME0) having a 1x clock speed. The primary hash process 590 of the hashing engine 500 includes four MCs, each having a 2x clock speed as in the primary hash process of the hashing engine 400. The four MCs of the primary hash process 590 include MC 505 (labeled MC0[1]), MC 510 (labeled MC0[0]), MC 520 (labeled MC0[2]), and MC 525 (labeled MC0[3]). The primary hash process 590 can be an example of the hashing engine 400 (e.g., which similarly has one ME with 1x clock speed and four MCs with 2x clock speed each), or vice versa.

The secondary hash process 595 of the hashing engine 500 includes four expander-compressor trios that each include two MEs (that run at 1x clock speed) and one MC (that runs at 2x clock speed). A first expander-compressor trio of the secondary hash process 595 includes ME 530 (labeled ME1[3]), MC 535 (labeled MC1[2]), and ME 540 (labeled ME1[2]). A second expander-compressor trio of the secondary hash process 595 includes ME 545 (labeled ME1[1]), MC 550 (labeled MC1[0]), and ME 555 (labeled ME1[0]). A third expander-compressor trio of the secondary hash process 595 includes ME 560 (labeled ME1[4]), MC 565 (labeled MC1[5]), and ME 570 (labeled ME1[5]). A fourth expander-compressor trio of the secondary hash process 595 includes ME 575 (labeled ME1[6]), MC 580 (labeled MC1[7]), and ME 585 (labeled ME1[7])

In some examples, within the primary hash process 590, outputs of the ME 515 are transferred to the MC 505, the MC 510, the MC 520, and/or the MC 525. The intermediate hash data 120 generated by the primary hash process 590 and transferred to the secondary hash process 595 can include data from the MC 505, the MC 510, the MC 520, and/or the MC 525. In some examples, data generated by the MC 505 is output (e.g., as part of the intermediate hash data 120) to the ME 530 and/or to the ME 540, which processes this data and sends it to the MC 535, which processes this data and outputs it as part of the hash digest 130 generated by the hashing engine 500. In some examples, data generated by the MC 510 is output (e.g., as part of the intermediate hash data 120) to the ME 545 and/or the ME 555, which processes this data and sends it to the MC 550, which processes this data and outputs it as part of the hash digest 130 generated by the hashing engine 500. In some examples, data generated by the MC 520 is output (e.g., as part of the intermediate hash data 120) to the ME 560 and/or the ME 570, which processes this data and sends it to the MC 565, which processes this data and outputs it as part of the hash digest 130 generated by the hashing engine 500. In some examples, data generated by the MC 525 is output (e.g., as part of the intermediate hash data 120) to the ME 575 and/or the ME 585, which processes this data and sends it to the MC 580, which processes this data and outputs it as part of the hash digest 130 generated by the hashing engine 500.

In the primary hash process 590, the ratio of four MCs to one ME, combined with the faster clock speed (2x) for MCs than the clock speed (1x) for the ME, can be referred to as an 8:1 ASIC boost.

The secondary hash process 595 can traditionally be limited to one MC per ME, making double-pipelining of MCs or MEs in the secondary hash process 595 difficult. However, to achieve similar benefits in throughput and reliability in the secondary hash process 595 as discussed herein for the primary hash process 590 (e.g., as discussed with respect to the hashing engine 400), various optimizations can be added to the secondary hash process 595, such as operating the compressor datapath (MC) at a faster clock speed than the expander datapath(s) (ME(s)) operate at.

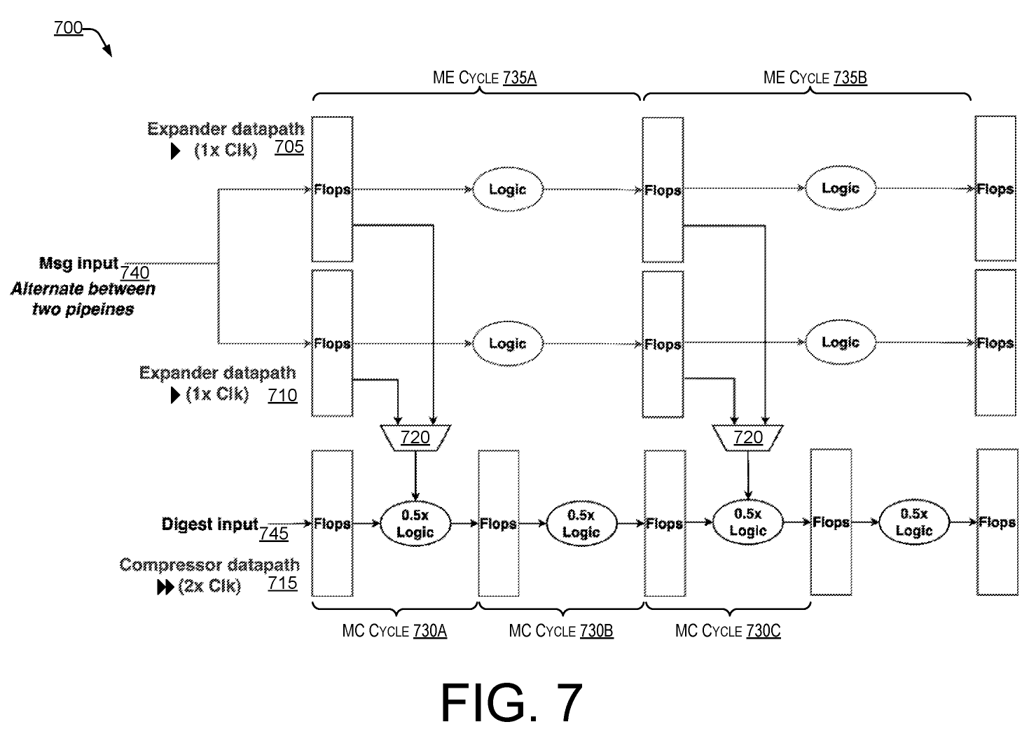

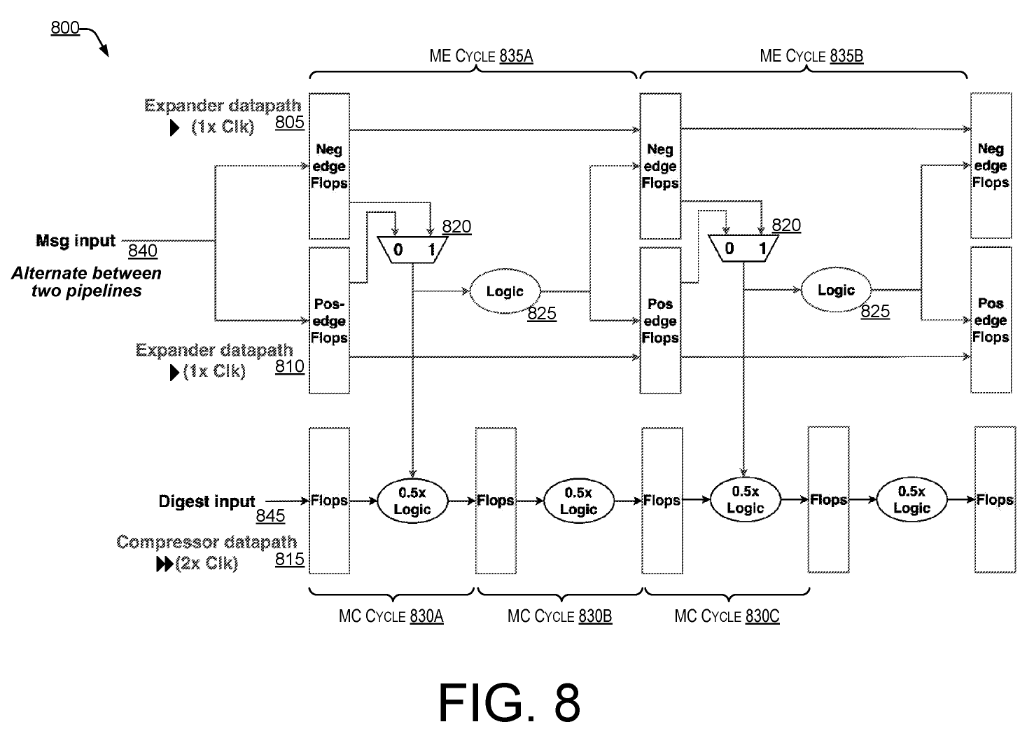

To improve throughput and reliability, and be able to handle the higher clock speeds of the MCs in both the primary hash process 590 and the secondary hash process 595, the secondary hash process 595 can alternate between two expander datapaths (MEs) that operate at the slower clock speed (e.g., 1x clock speed) compared to the MC’s clock speed (e.g., 2x clock speed). For instance, the secondary hash process 595 can use a multiplexer or other switching mechanism to alternate (e.g., temporally by clock cycle) between receiving the output(s) of the MCs of the primary hash process 590 at different expander datapaths (MEs). For instance, a first output of the MC 505 is illustrated as being received by the ME 530, while a second output of the MC 505 is illustrated as being received by the ME 540. Similarly, the secondary hash process 595 can use a multiplexer or other switching mechanism to to alternate (e.g., temporally by clock cycle) which of the different expander datapaths (MEs) sends its logic output (e.g., intermediate expanded data) to the corresponding MC. For instance, in a first cycle, the ME 530 can send its intermediate expanded data to the MC 535, and then in a second cycle, the ME 540 can send its intermediate expanded data to the MC 535. Examples of the secondary hash process 595 with two expander datapaths (MEs) are illustrated and discussed further with respect to FIGS. 7-8.

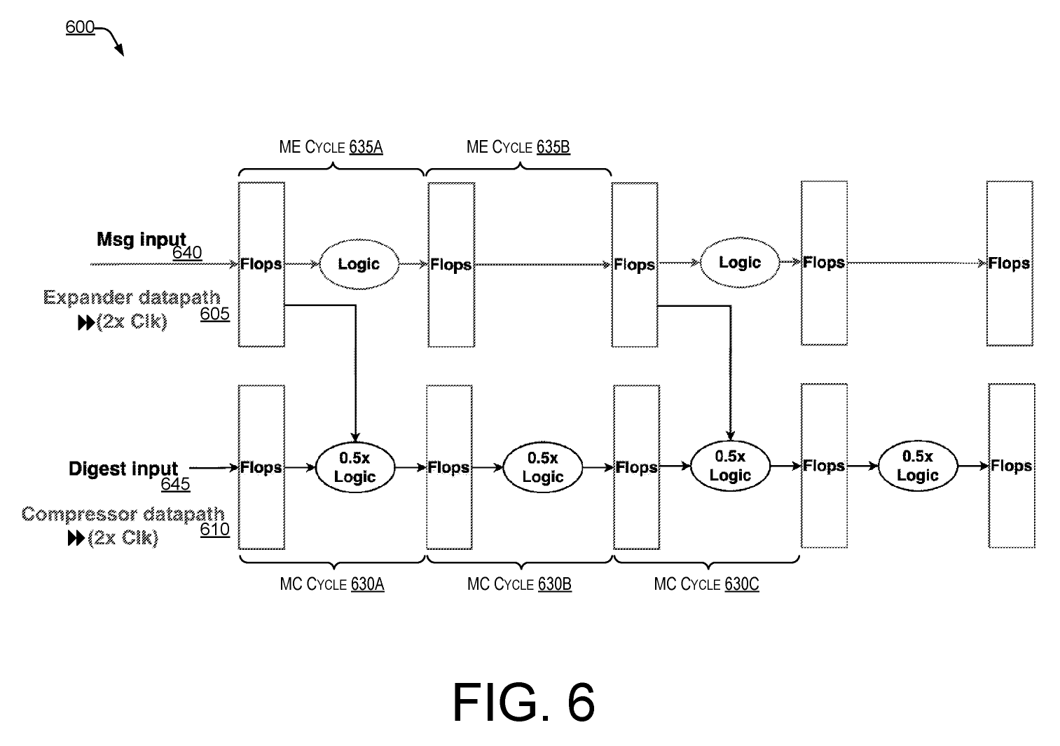

In some examples, the secondary hash process 595 can be optimized to use a single expander datapath (ME), but operating the single expander datapath (ME) at the same faster clock speed (e.g., 2x clock speed) as the compressor datapaths (MCs) (e.g., across the primary hash process 590 and the secondary hash process 595) operate at. An example of such an optimization is illustrated and discussed further with respect to FIG. 6.

FIG. 6 is a block diagram illustrating a secondary hash process for a hashing engine 600, including an expander datapath 605 indicating timing of logic and flops for an ME as well as a compressor datapath 610 corresponding to timing of logic and flops for an MC, where the ME temporally alternates between performing ME logic and not performing ME logic. The secondary hash process performed by the hashing engine 600 is an example of the secondary hash process 125, the secondary hash process 295, and/or the secondary hash process 595. In the hashing engine 600, both the expander datapath 605 (ME) and the compressor datapath 610 (MC) operate at a shared clock speed, which is identified as 2x in FIG. 6. The shared clock speed means that the MC cycles (e.g., MC cycles 630A-630C) and the ME cycles (e.g., ME cycles 635A-635B) are the same length.

In the hashing engine 600, the expander datapath 605 (ME) receives a message input 640, which may be an example of the intermediate hash data 120. The message input 640 may be an output of primary hash process (e.g., the primary hash process 115, the primary hash process 290, the primary hash process performed by the hashing engine 300, the primary hash process performed by the hashing engine 400, the primary hash process 590), for instance being an output of one or more compressor datapaths (MCs) of the primary hash process.

The shared clock speed being identified as 2x in FIG. 6 can indicate that the shared clock speed that is shared between the expander datapath 605 (ME) and the compressor datapath 610 (MC) of the hashing engine 600 can also be shared with the compressor datapaths (MCs) of the primary hash process (e.g., which is identified as 2x in at least the hashing engine 400 and the hashing engine 500).

The hashing engine 600 operates the secondary hash process by alternating (e.g., temporally from cycle to cycle) the expander datapath 605 (ME) between a first ME logic configuration in which the expander datapath 605 (ME) performs a full round of ME logic (indicated by an oval with the word “Logic”) and a second ME logic configuration in which the expander datapath 605 (ME) waits without performing any ME logic (indicated by a blank arrow without any “logic” oval). For instance, in FIG. 6, the expander datapath 605 (ME) is in the first ME logic configuration during ME cycle 635A, during which the expander datapath 605 (ME) performs a full round of ME logic. The expander datapath 605 (ME) is in the second ME logic configuration during ME cycle 635B, during which the expander datapath 605 (ME) waits without performing any ME logic.

During each MC cycle (including the MC cycles 630A-630C), the compressor datapath 610 (MC) includes a flop and a performance of a partial round (e.g., half round) of MC logic (indicated by the oval with the words “0.5x Logic”). Because the expander datapath 605 (ME) performs the full round of ME logic in a first cycle (e.g., ME cycle 535A and MC cycle 630A), the compressor datapath 610 (MC) has two (or three) opportunities to receive the intermediate expanded data generated by the expander datapath 605 (ME). For instance, the intermediate expanded data generated by the expander datapath 605 (ME) in the ME cycle 635A can be received by the compressor datapath 610 (MC) using the flop and/or logic in the MC cycle 630A, using the flop and/or logic in the MC cycle 630B, and/or using the flop and/or logic in the MC cycle 630C. This front-loading of the ME logic, combined with the double pipelined datapath for the compressor datapath 610 (MC), provides improved throughput and reliability, and reduced glitching power consumption.

In some examples, the digest input 645 received and/or processed by the compressor datapath 610 (MC) can include at least a portion of the intermediate hash data 120. In some examples, the digest input 645 can include intermediate expanded data generated by the expander datapath 605 (ME).

While the hashing engine 600 illustrated in FIG. 6 has a single expander datapath 605 (e.g., a single ME) per compressor datapath 610, it should be understood that the hashing engine 600 can be modified so that the logic from the single ME datapath can be split across multiple ME datapaths, similarly to the hashing engine 700 (of FIG. 7) and/or the hashing engine 800 (of FIG. 8).

FIG. 7 is a block diagram illustrating a secondary hash process for a hashing engine 700, including two expander datapaths 705-710 indicating timing of logic and flops for ME(s) as well as a compressor datapath 715 corresponding to timing of logic and flops for an MC, where a multiplexer 720 temporally alternates which of the two expander datapaths 705-710 the multiplexer 720 routes intermediate expanded data from to the compressor datapath 715. The two expander datapaths 705-710 include a first expander datapath 705 and a second expander datapath 710.

The secondary hash process performed by the hashing engine 700 is an example of the secondary hash process 125, the secondary hash process 295, and/or the secondary hash process 595. In the hashing engine 700, the compressor datapath 715 (MC) operates on a clock speed that is faster than (e.g., at least double) the clock speed under which the expander datapaths 705-710 (MEs) operate. For instance, in FIG. 7, the clock speed of the compressor datapath 715 (MC) is identified as 2x, while the clock speed of the expander datapaths 705-710 (MEs) is identified as 1x. By running the expander datapaths 705-710 (MEs) at 1x clock speed (clock frequency), the hashing engine 700 reduces the power consumed, without affecting the overall hash throughput. In some examples, the faster clock speed (e.g., 2x clock speed) of the compressor datapath 715 (MC) can be shared with the compressor datapaths (MCs) of the primary hash process (e.g., primary hash process 115, primary hash process performed by the hashing engine 400, primary hash process 590). In some examples, the slower clock speed (e.g., 1x clock speed) of the expander datapaths 705-710 (MEs) can be shared with the expander datapath(s) (ME(s)) of the primary hash process (e.g., primary hash process 115, primary hash process 290, primary hash process performed by the hashing engine 300, primary hash process performed by the hashing engine 400, primary hash process 590). Because the clock speed of the compressor datapath 715 (MC) is faster than the clock speed of the expander datapaths 705-710 (MEs), the MC clock cycles for the compressor datapath 715 (MC) (e.g., MC cycles 730A-730C) are shorter than the ME clock cycles for the expander datapaths 705-710 (MEs) (e.g., ME cycles 735A-735B). For instance, the ME cycle 735A includes the MC cycles 730A-730B.

In the hashing engine 700, the expander datapaths 705-710 (MEs) receive a message input 740, which may be an example of the intermediate hash data 120. The message input 740 may be an output of primary hash process (e.g., the primary hash process 115, the primary hash process 290, the primary hash process performed by the hashing engine 300, the primary hash process performed by the hashing engine 400, the primary hash process 590), for instance being an output of one or more compressor datapaths (MCs) of the primary hash process.

In some examples, the digest input 745 received and/or processed by the compressor datapath 715 (MC) can include at least a portion of the intermediate hash data 120. In some examples, the digest input 745 can include intermediate expanded data generated by the expander datapaths 705-710 (MEs).

The hashing engine 700 operates the secondary hash process by alternating (e.g., temporally from cycle to cycle) the multiplexer 720 between a first ME logic configuration in which the multiplexer 720 conveys intermediate expanded data from the first expander datapath 705 (ME) to the compressor datapath 715 (MC) and a second ME logic configuration in which the multiplexer 720 conveys intermediate expanded data from the second expander datapath 710 (ME) to the compressor datapath 715 (MC). In some examples, the first expander datapath 705 (ME) can also receive certain types of data (e.g., the message input 740 and/or intermediate data from the compressor datapath 715 (MC)) during or before the first ME logic configuration. In some examples, the second expander datapath 710 (ME) can receive certain types of data (e.g., the message input 740 and/or intermediate data from the compressor datapath 715 (MC)) during or before the second ME logic configuration.

During each MC cycle (including the MC cycles 730A-730C), the compressor datapath 715 (MC) includes a flop and a performance of a partial round (e.g., half round) of MC logic (indicated by the oval with the words “0.5x Logic”). During each ME cycle (including the ME cycles 735A-735B), the expander datapaths 705-710 (MEs) perform the full round of ME logic (indicated by the oval with the word “Logic”). To ensure that data can be received via the flops of the expander datapaths 705-710 (MEs) and processed through the logic of the expander datapaths 705-710 (MEs) in time, the multiplexer 720 can be used to switch between the two ME logic configurations. This leverages a property of the SHA-2 algorithm, in that under SHA-2, the ME(s) do not have to generate their outputs (expanded data) at the same rate as the MC(s) generate their outputs (compressed data).

In some examples, the compressor datapath 715 (MC) has two (or three) opportunities to receive the intermediate expanded data generated by the expander datapaths 705-710 (ME). For instance, the intermediate expanded data generated by one of the expander datapaths 705-710 (MEs) in the ME cycle 735A can be conveyed through the multiplexer 720 and received by the compressor datapath 715 (MC) using the flop and/or logic in the MC cycle 730A, using the flop and/or logic in the MC cycle 730B, and/or using the flop and/or logic in the MC cycle 730C. Use of, and switching between, these parallel expander datapaths 705-710 (MEs) in this way can provide improved throughput and reliability, and reduced glitching power consumption.

FIG. 8 is a block diagram illustrating a secondary hash process for a hashing engine 800, including two expander datapaths 805-810 indicating timing of logic and flops for ME(s) as well as a compressor datapath 815 corresponding to timing of logic and flops for an MC, where the two expander datapaths 805-810 both use shared ME logic 825, and where a multiplexer 820 temporally alternates which of the two expander datapaths 805-810 use the shared ME logic 825. The two expander datapaths 805-810 include a first expander datapath 805 and a second expander datapath 810.

The secondary hash process performed by the hashing engine 800 is an example of the secondary hash process 125, the secondary hash process 295, and/or the secondary hash process 595. The secondary hash process performed by the hashing engine 800 is similar to the secondary hash process performed by the hashing engine 700, but is made even more efficient through the use of the shared ME logic 825 (as opposed to individual ME logic per expander datapath in the hashing engine 700).

In the hashing engine 800, the compressor datapath 810 (MC) operates on a clock speed (e.g., 2x clock speed) that is faster than (e.g., at least double) the clock speed (e.g., 1x clock speed) under which the expander datapaths 805-810 (MEs) operate. In some examples, the faster clock speed (e.g., 2x clock speed) of the compressor datapath 810 (MC) can be shared with the compressor datapaths (MCs) of the primary hash process (e.g., primary hash process 115, primary hash process performed by the hashing engine 400, primary hash process 590). In some examples, the slower clock speed (e.g., 1x clock speed) of the expander datapaths 805-810 (MEs) can be shared with the expander datapath(s) (ME(s)) of the primary hash process (e.g., primary hash process 115, primary hash process 290, primary hash process performed by the hashing engine 300, primary hash process performed by the hashing engine 400, primary hash process 590). Because the clock speed of the compressor datapath 810 (MC) is faster than the clock speed of the expander datapaths 805-810 (MEs), the MC clock cycles for the compressor datapath 810 (MC) (e.g., MC cycles 830A-830C) are shorter than the ME clock cycles for the expander datapaths 805-810 (MEs) (e.g., ME cycles 835A-835B). For instance, the ME cycle 835A includes the MC cycles 830A-830B.

In the hashing engine 800, the expander datapaths 805-810 (MEs) receive a message input 840, which may be an example of the intermediate hash data 120. The message input 840 may be an output of primary hash process (e.g., the primary hash process 115, the primary hash process 290, the primary hash process performed by the hashing engine 300, the primary hash process performed by the hashing engine 400, the primary hash process 590), for instance being an output of one or more compressor datapaths (MCs) of the primary hash process.

In some examples, the digest input 845 received and/or processed by the compressor datapath 810 (MC) can include at least a portion of the intermediate hash data 120. In some examples, the digest input 845 can include intermediate expanded data generated by the expander datapaths 805-810 (MEs).

The hashing engine 800 operates the secondary hash process by alternating (e.g., temporally from cycle to cycle) the multiplexer 820 between (1) a first ME logic configuration in which the multiplexer 820 allows the first expander datapath 805 (ME) to use the shared ME logic 825 and conveys intermediate expanded data from the first expander datapath 805 (ME) to the compressor datapath 815 (MC), and (2) a second ME logic configuration in which the multiplexer 820 allows the second expander datapath 810 (ME) to use the shared ME logic 825 and conveys intermediate expanded data from the second expander datapath 810 (ME) to the compressor datapath 815 (MC). In some examples, the first expander datapath 805 (ME) can also receive certain types of data (e.g., the message input 840 and/or intermediate data from the compressor datapath 815 (MC)) during or before the first ME logic configuration. In some examples, the second expander datapath 810 (ME) can receive certain types of data (e.g., the message input 840 and/or intermediate data from the compressor datapath 815 (MC)) during or before the second ME logic configuration.

During each MC cycle (including the MC cycles 830A-830C), the compressor datapath 815 (MC) includes a flop and a performance of a partial round (e.g., half round) of MC logic (indicated by the oval with the words “0.5x Logic”). During each ME cycle (including the ME cycles 835A-835B), the expander datapaths 805-810 (MEs) perform the full round of ME logic, alternating using the shared ME logic 825 (indicated by the oval with the word “Logic”) from one ME cycle to the next. To ensure that data can be received via the flops of the expander datapaths 805-810 (MEs) and processed through the logic of the expander datapaths 805-810 (MEs) in time, the multiplexer 820 can be used to switch between the two ME logic configurations.

In some examples, the compressor datapath 810 (MC) has two (or three) opportunities to receive the intermediate expanded data generated by the expander datapatsh 805-810 (MEs). For instance, the intermediate expanded data generated by one of the expander datapaths 805-810 (MEs) using the shared ME logic 825 in the ME cycle 835A can be conveyed through the multiplexer 820 and/or received by the compressor datapath 815 (MC) using the flop and/or logic in the MC cycle 830A, using the flop and/or logic in the MC cycle 830B, and/or using the flop and/or logic in the MC cycle 830C. Use of, and switching between, these parallel expander datapaths 805-810 (MEs) in this way can provide improved throughput and reliability, and reduced glitching power consumption.

In some examples, the term “pipeline” can be used in place of the term “datapath” as used herein (e.g., for the expander datapaths and compressor datapaths discussed herein). For instance, the expander datapath(s) can be referred to as expander pipeline(s) or ME pipeline(s). The compressor datapath(s) can be referred to as compressor pipeline(s) or MC pipeline(s).

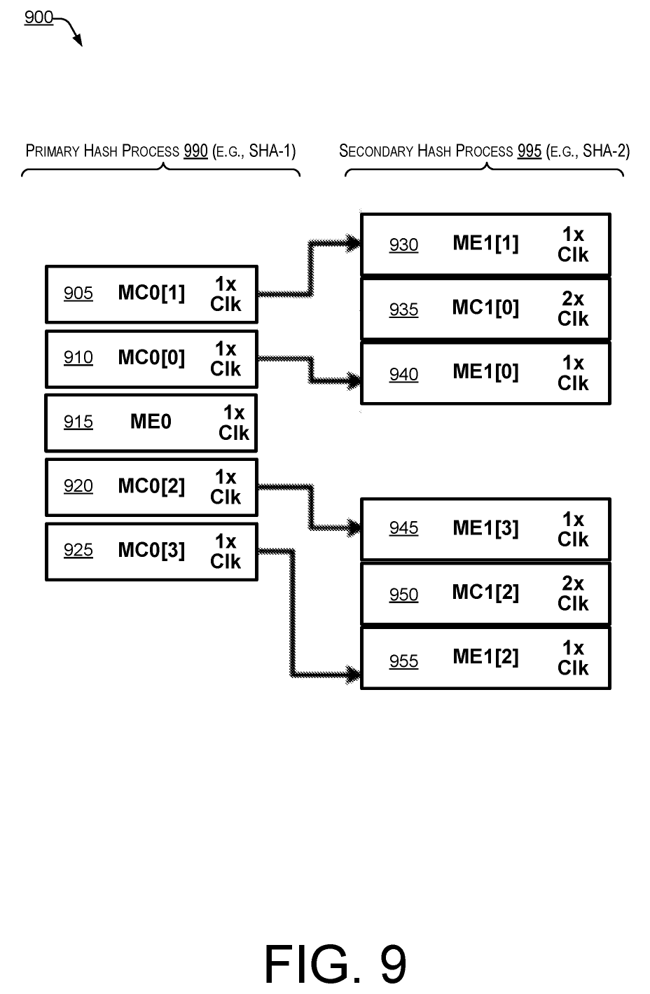

FIG. 9 is a block diagram illustrating an architecture of a hashing engine 900 that includes five ME datapaths and six MC datapaths. The hashing engine 900 performs a hashing process, which is an example of the hashing process 100. The hashing engine 900 includes a primary hash process 990, which is an example of the primary hash process 115 and may be a SHA-1 sub-routine of a SHA-256 process. The hashing engine 900 includes a secondary hash process 995, which is an example of the secondary hash process 125 and may be a SHA-2 sub-routine of the SHA-256 process.

The primary hash process 990 of the hashing engine 900 includes one ME 915 (labeled ME0) having a 1x clock speed. The primary hash process 990 of the hashing engine 900 includes four MCs, each also having a 1x clock speed, as in the primary hash process of the hashing engine 300. The four MCs of the primary hash process 990 include MC 905 (labeled MC0[1]), MC 910 (labeled MC0[0]), MC 920 (labeled MC0[2]), and MC 925 (labeled MC0[3]). The primary hash process 990 can be an example of the hashing engine 300 (e.g., which similarly has one ME with 1x clock speed and four MCs with 1x clock speed each), or vice versa.

The secondary hash process 995 of the hashing engine 900 is similar to the secondary hash process 595 of the hashing engine 500, but adapted to work with the 1x clock speed of the MCs of the primary hash process 990 of the hashing engine 900. The secondary hash process 995 of the hashing engine 900 includes two expander-compressor trios that each include two MEs (that run at 1x clock speed) and one MC (that runs at 2x clock speed). A first expander-compressor trio of the secondary hash process 995 includes ME 930 (labeled ME1[3]), MC 935 (labeled MC1[2]), and ME 940 (labeled ME1[2]). A second expander-compressor trio of the secondary hash process 995 includes ME 945 (labeled ME1[1]), MC 950 (labeled MC1[0]), and ME 955 (labeled ME1[0]).

In some examples, within the primary hash process 990, outputs of the ME 915 are transferred to the MC 905, the MC 910, the MC 920, and/or the MC 925. The intermediate hash data 120 generated by the primary hash process 990 and transferred to the secondary hash process 995 can include data from the MC 905, the MC 910, the MC 920, and/or the MC 925. In some examples, data generated by the MC 905 is output (e.g., as part of the intermediate hash data 120) to the ME 930, which processes this data and sends it to the MC 935, which processes this data and outputs it as part of the hash digest 130 generated by the hashing engine 900. In some examples, data generated by the MC 910 is output (e.g., as part of the intermediate hash data 120) to the ME 940, which processes this data and sends it to the MC 935, which processes this data and outputs it as part of the hash digest 130 generated by the hashing engine 900. In some examples, data generated by the MC 920 is output (e.g., as part of the intermediate hash data 120) to the ME 945, which processes this data and sends it to the MC 950, which processes this data and outputs it as part of the hash digest 130 generated by the hashing engine 900. In some examples, data generated by the MC 925 is output (e.g., as part of the intermediate hash data 120) to the ME 955, which processes this data and sends it to the MC 950, which processes this data and outputs it as part of the hash digest 130 generated by the hashing engine 900.

In the primary hash process 990, the ratio of four MCs to one ME, all at a shared clock speed (1x clock speed), can be referred to as a 4:1 ASIC boost.

Examples of the secondary hash process 995 that include two expander datapaths (MEs) per compressor datapath (MC) include secondary hash processes of the hashing engine 700 and the hashing engine 800.

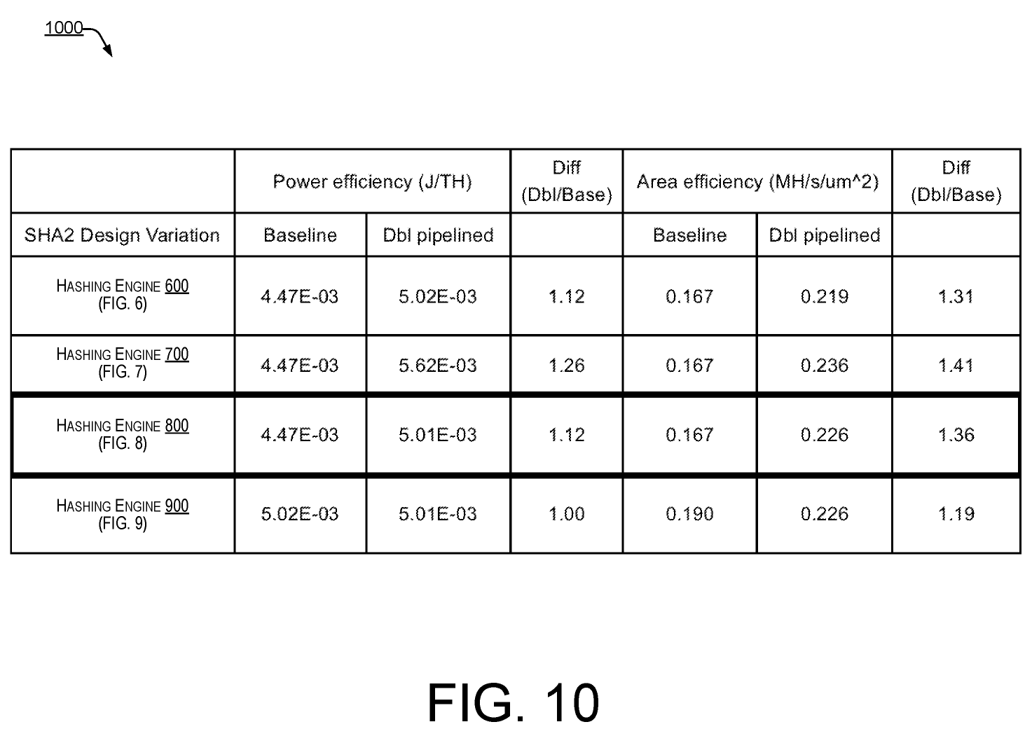

FIG. 10 is a table 1000 illustrating examples of power, performance, and area (PPA) for different hashing engines. Power efficiency, tracked in units of Joules per Terahash (J/TH), is measured for double-pipelined systems are compared with power efficiencies for baseline systems (that are not double-pipelined). Efficiency by area, tracked in units of megahashes per second per square micrometer (MH/s/µm²), is measured for double-pipelined systems are compared with power efficiencies for baseline systems (that are not double-pipelined).

The table 1100 compares power efficiency and area efficiency for the hashing engine 600, the hashing engine 700, the hashing engine 800, and the hashing engine 900. The row for the hashing engine 800 is highlighted (e.g., via a thick outline) in the table 1000 as having a good combination of optimized power efficiency and optimized area efficiency.

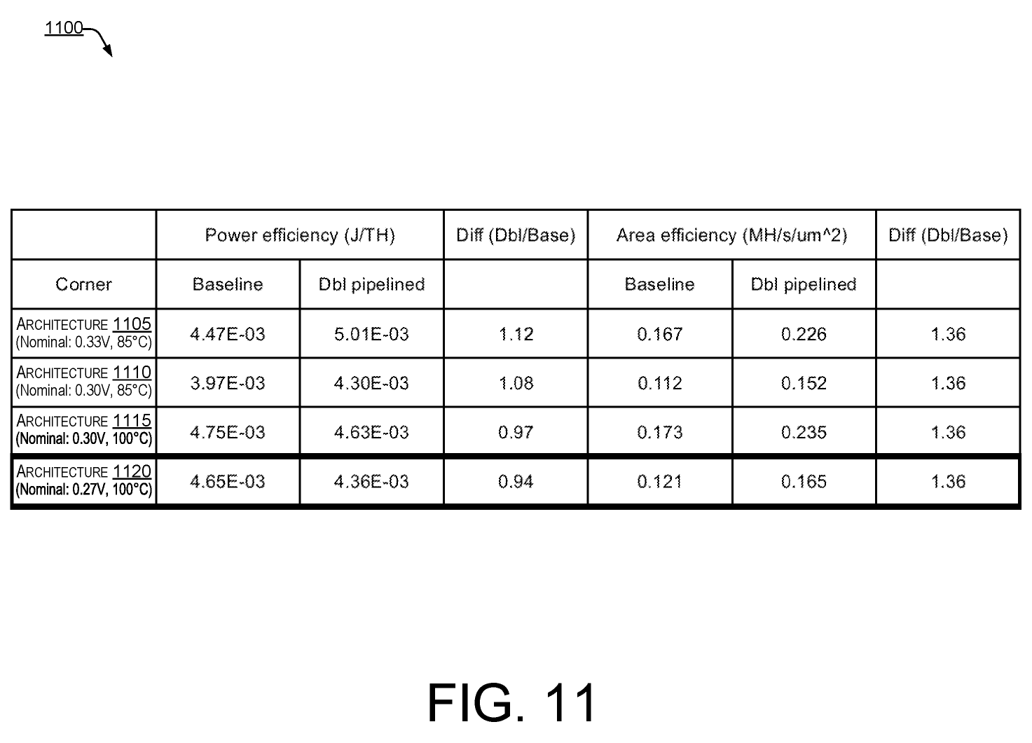

FIG. 11 is a table 1100 illustrating examples of power, performance, and area (PPA) for different technology nodes. Power efficiency, tracked in units of Joules per Terahash (J/TH), is measured for double-pipelined systems are compared with power efficiencies for baseline systems (that are not double-pipelined). Efficiency by area, tracked in units of megahashes per second per square micrometer (MH/s/µm²), is measured for double-pipelined systems are compared with power efficiencies for baseline systems (that are not double-pipelined).

The table 1100 compares power efficiency and area efficiency for an architecture 1105 with a nominal voltage of 0.33 volts (V) per transistor and a nominal temperature of 85° Celsius (C), an architecture 1110 with a nominal voltage of 0.30V and a nominal temperature of 85° C., an architecture 1115 with a nominal voltage of 0.30V and a nominal temperature of 100° C., and an architecture 1120 with a nominal voltage of 0.27V and a nominal temperature of 100° C. The architecture 1120 is highlighted (e.g., via a thick outline) in the table 1100 as having a good combination of optimized power efficiency and optimized area efficiency. In some examples, the architectures 1105-1120 compared in the table 1100 may be 5 nanometer (nm) architectures.

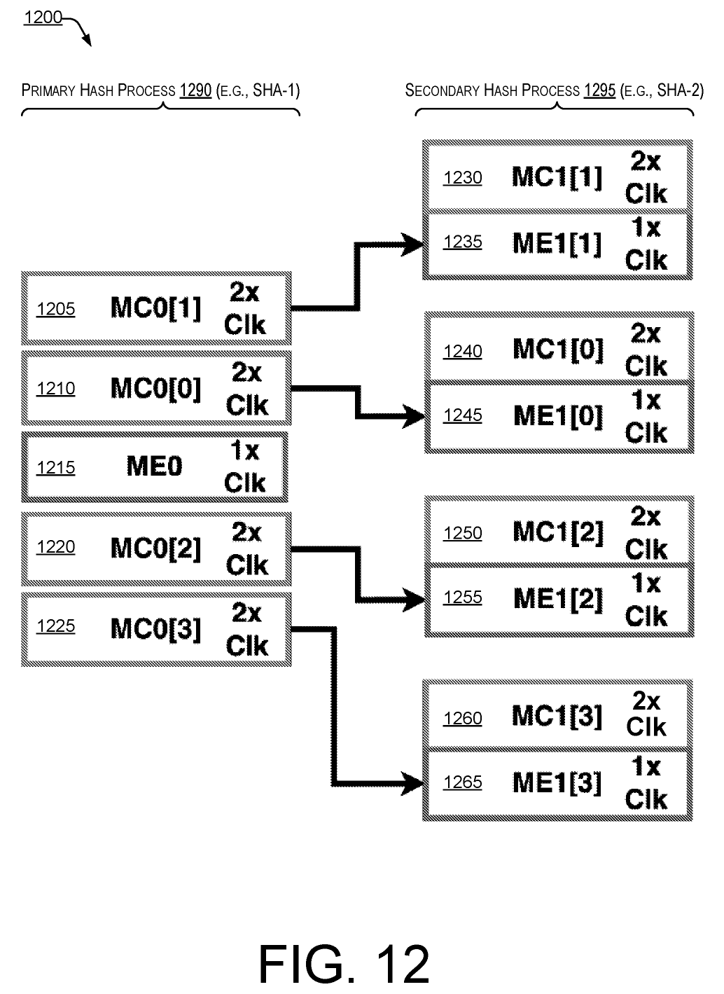

FIG. 12 is a block diagram illustrating an architecture of a hashing engine 1200 that includes five message expander (ME) datapaths and eight message compressor (MC) datapaths. The hashing engine 1200 is an example of the hashing engine 110. The hashing engine 1200 performs a hashing process, which is an example of the hashing process 100. The hashing engine 1200 includes a primary hash process 1290, which is an example of the primary hash process 115 and may be a SHA-1 sub-routine of a SHA-256 process. The hashing engine 1200 includes a secondary hash process 1295, which is an example of the secondary hash process 125 and may be a SHA-2 sub-routine of the SHA-256 process.

The primary hash process 1290 of the hashing engine 1200 includes one ME 1215 (labeled ME0) having a 1x clock speed. The primary hash process 1290 of the hashing engine 1200 includes four MCs, each having a 2x clock speed as in the primary hash process of the hashing engine 400. The four MCs of the primary hash process 1290 include MC 1205 (labeled MC0[1]), MC 1210 (labeled MC0[0]), MC 1220 (labeled MC0[2]), and MC 1225 (labeled MC0[3]). The primary hash process 1290 can be an example of the hashing engine 400 (e.g., which similarly has one ME with 1x clock speed and four MCs with 2x clock speed each), or vice versa.

The secondary hash process 1295 of the hashing engine 1200 includes four expander-compressor pairs that each include one ME (having a 1x clock speed) and one MC (having a 2x clock speed). A first expander-compressor pair of the secondary hash process 1295 includes MC 1230 (labeled MC1[1]) and corresponding ME 1235 (labeled ME1[1]). A second expander-compressor pair of the secondary hash process 1295 includes MC 1240 (labeled MC1[0]) and corresponding ME 1245 (labeled ME1[0]). A third expander-compressor pair of the secondary hash process 1295 includes MC 1250 (labeled MC1[2]) and corresponding ME 1255 (labeled ME1[2]). A fourth expander-compressor pair of the secondary hash process 1295 includes MC 1260 (labeled MC1[3]) and corresponding ME 1265 (labeled ME1[3]).

In some examples, within the primary hash process 1290, outputs of the ME 1215 are transferred to the MC 1205, the MC 1210, the MC 1220, and/or the MC 1225. The intermediate hash data 120 generated by the primary hash process 1290 and transferred to the secondary hash process 1295 can include data from the MC 1205, the MC 1210, the MC 1220, and/or the MC 1225. In some examples, data generated by the MC 1205 is output (e.g., as part of the intermediate hash data 120) to the ME 1235, which processes this data and sends it to the MC 1230, which processes this data and outputs it as part of the hash digest 130 generated by the hashing engine 1200. In some examples, data generated by the MC 1210 is output (e.g., as part of the intermediate hash data 120) to the ME 1245, which processes this data and sends it to the MC 1240, which processes this data and outputs it as part of the hash digest 130 generated by the hashing engine 1200. In some examples, data generated by the MC 1220 is output (e.g., as part of the intermediate hash data 120) to the ME 1255, which processes this data and sends it to the MC 1250, which processes this data and outputs it as part of the hash digest 130 generated by the hashing engine 1200. In some examples, data generated by the MC 1225 is output (e.g., as part of the intermediate hash data 120) to the ME 1265, which processes this data and sends it to the MC 1260, which processes this data and outputs it as part of the hash digest 130 generated by the hashing engine 1200.

In some examples, the secondary hash process 1295 operates similarly to the secondary hash process of the hashing engine 600, though with each pair of ME cycles (e.g., the ME cycle 635A and the ME cycle 635B) merged into a single ME cycle without the flop in the middle (e.g., without the flop at the beginning of the ME cycle 635B). In some examples, the ME logic can continue to be front-loaded (e.g., performed within the first half of the new ME cycle, or what is labeled as ME cycle 635A in FIG. 6). In some examples, the ME logic is no longer front-loaded, but can be spread out across the new ME cycle (e.g., spread out across what is labeled as the ME cycles 635A-635B in FIG. 6).

In some examples, the secondary hash process 1295 operates similarly to the secondary hash process of the hashing engine 700 and/or the hashing engine 800, with the clock speed for the MCs being faster than the clock speed for the MEs. In some examples, the MEs of the secondary hash process 1295 can include multiple expander datapaths, or split expander datapaths, for instance as in the hashing engine 700 and/or the hashing engine 800.

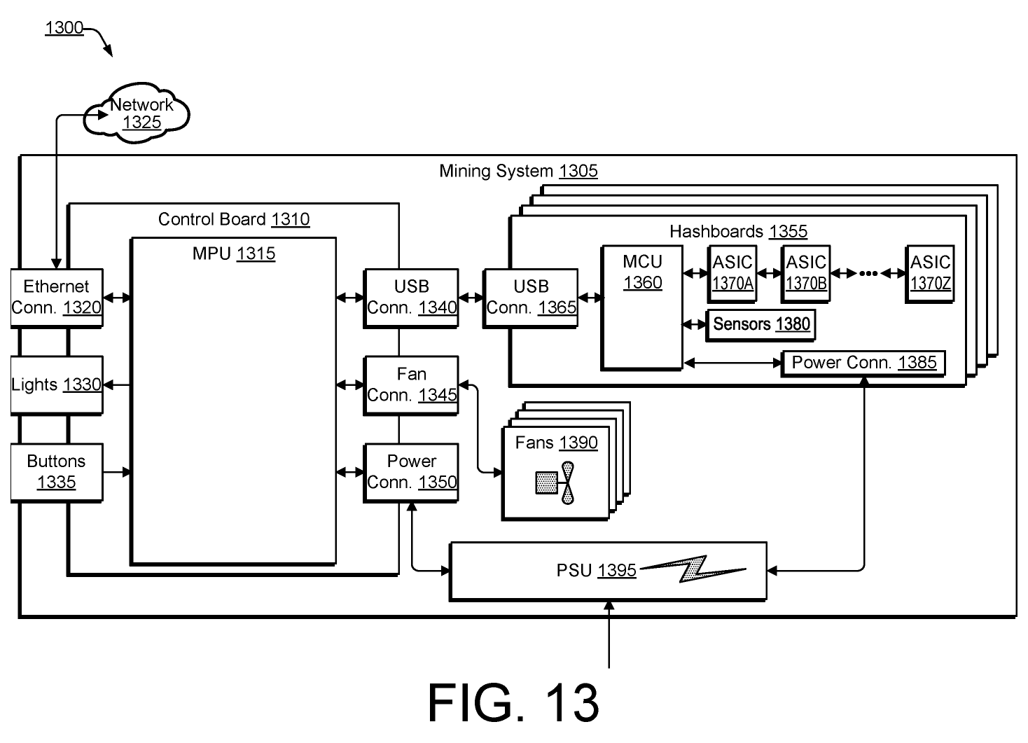

FIG. 13 is a block diagram 1300 illustrating an example of a mining system 1305 that includes one control board 1310, three hashboards 1355, four fans 1390, and a power supply unit (PSU 1395). The mining system 1305 can be used to perform hashing according to the hashing process 100, for instance using the one control board 1310 and the three hashboards 1355.

The PSU 1395 can receive power from an external power source, such as a power cable coupled to a power outlet (e.g., AC power (220V/110V)). The one control board 1310 can include a micro-processor unit (MPU 1315). The control board 1310 can be coupled to a network 1325 (e.g., the Internet), in some examples via an ethernet connection 1320 and/or a wireless communication interface (e.g., wi-fi and/or wireless local area network (WLAN)). The control board 1310 (e.g., the MPU 1315) can be coupled to lights 1330, which may for include indicator lights that can be used to indicate status(es) and/or potential issue(s) with the mining system 1305 or component(s) thereof, status(es) and/or potential issue(s) with hashing calculations, or a combination thereof. The control board 1310 (e.g., the MPU 1315) can be coupled to buttons 1335, which may be used to receive inputs at the one control board 1310, for instance to reconfigure the mining system 1305, reboot the mining system 1305, shut down the mining system 1305, reconfigure the three hashboards 1355, or a combination thereof. The control board 1310 (e.g., the MPU 1315) can be coupled to the fans 1390 through fan connectors 1345. The one control board 1310 can include a coupling or connection (a power connector 1350) through which the one control board 1310 receives power from the PSU 1395. In some examples, the fans 1390 receive power from the PSU 1395 directly. In some examples, the fans 1390 receive power from the PSU 1395 indirectly, for instance passed by the one control board 1310 through the fan connectors 1345.

Each of the three hashboards 1355 includes a coupling or connection, such as a USB connector 1365, to a corresponding coupling or connection, such as a USB connector 1340, of the one control board 1310. Each of the three hashboards 1355 includes a coupling or connection (a power connector 1385) through which the hashboards 1355 receive power from the PSU 1395. Each of the three hashboards 1355 also includes its own micro-controller unit (MCU) 1360 and multiple mining application-specific integrated circuits (ASICs), labeled ASIC 170A, ASIC 170B, and so forth, until ASIC 170Z. In an illustrative example, each hashboard includes 1300 ASICs. In some examples, each hashboard can include more or fewer ASICs. In some examples, the three hashboards 1355 include sensor(s) 1380, such as temperature sensor(s) (e.g., sensing temperatures of each of the ASICs 1370A-1370Z individually, sensing temperatures of groups of the ASICs 1370A-1370Z, sensing temperatures of the hashboards 1355, sensing temperatures elsewhere in the mining system 1305), airflow sensors (e.g., pressure, flow, and/or other aspects of air blown through the mining system 1305 by the fans 1390), fluid flow sensors (e.g., pressure, flow, and/or other aspects of fluids and/or liquids moved through the mining system 1305 by the fans 1390), power monitoring sensors (e.g., monitoring voltage, current, resistance, power, and/or other characteristics of power from the PSU 1395), other sensors discussed herein, or a combination thereof. In an illustrative example, the mining system 1305 includes three hashboards 1355. In some examples, the mining system 1305 can include more or fewer three hashboards 1355. In some examples, the MCU 1360 of a hashboard allocates various hashing calculations among the various ASICs 1370A-1370Z of the hashboard. In some examples, the one control board 1310 (e.g., the MPU 1315) allocates various hashing calculations among the various hashboards 1355, and/or among the various ASICs 1370A-1370Z of the various hashboards 1355.

In some examples, the mining system 1305 can include, or be included by, for instance, the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the hashing management architecture 1400, the mining system 1500, the hashing system that performs the process 1600, the hashing system that performs the process 1700, the environment 1800 for application interface customization, the environment 1900, the system 2000, or a combination thereof.

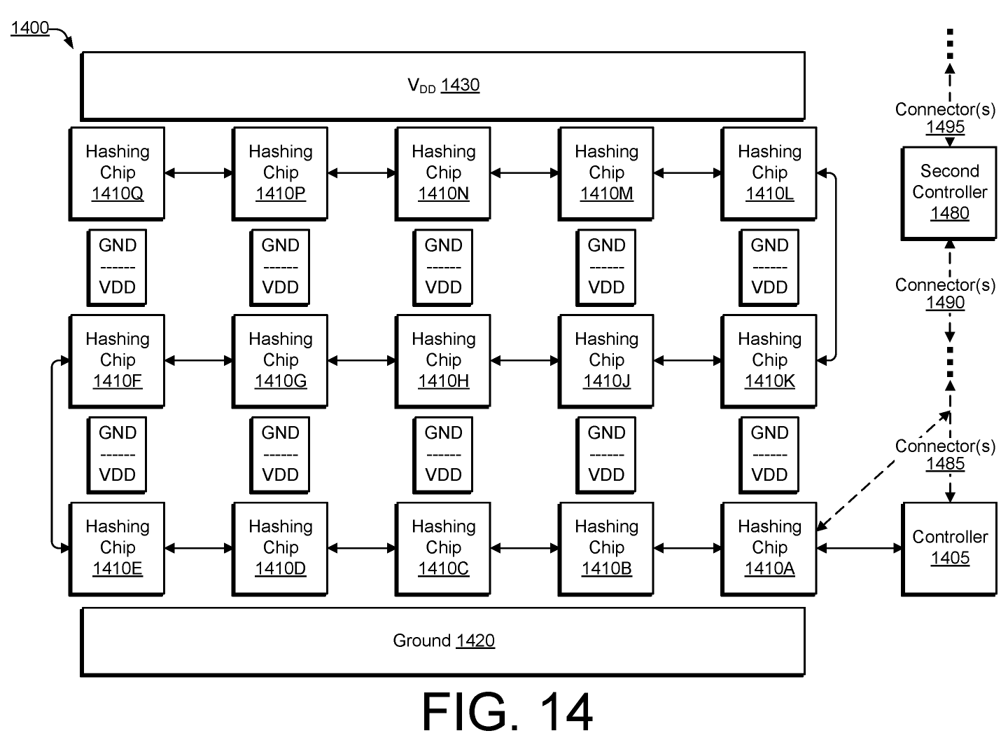

FIG. 14 is a block diagram illustrating an architecture of a mining hashboard. The architecture 1400 include (as an example) fifteen hashing chips 1410A-1410Q. In some examples, the hashing management architecture 1400 can be referred to as mining hashboards. The mining hashboard may also be referred to as a circuit board. The hashing management architecture 1400 can be an example of an architecture of one of the three hashboards 1355 of the block diagram 1300. The hashing chips 1410A-1410Q are examples of the ASICs 1370A-1370Z.

The hashing chips 1410A-1410Q are coupled to a voltage (V_{DD}) 1430 and to ground (Gnd) 1420, thus receiving power. The voltage (V_{DD}) 1430 and/or the ground (Gnd) 1420 can be part of the PSU 1395 and/or the power connector 1385, in some examples. The hashing management architecture 1400 includes a controller 1405 that can likewise be coupled to voltage (V_{DD}) 1430 and ground (Gnd) 1420, thus receiving power. The controller 1405 can be an example of the MCU 1360 of the three hashboards 1355. The hashing chips 1410A-1410Q receive instructions from the controller 1405, which may for instance instruct the hashing chips 1410A-1410Q to perform certain hashing operations, thus apportioning hashing calculations among the hashing chips 1410A-1410Q. The controller 1405 can send the instructions through the daisy chain to reach each of the various hashing chips 1410A-1410Q. The hashing chips 1410A-1410Q send data (e.g., computed hash digest(s)) back to the controller 1405, for instance through other hashing chips of the hashing chips 1410A-1410Q along the daisy chain. The controller 1405 is coupled to the hashing chips 1410A-1410Q, which are coupled to one another in a daisy chain (e.g., daisy chain arrangement and/or daisy chain configuration). For instance, the controller 1405 is coupled to the hashing chip 1410A, the hashing chip 1410A is coupled to the hashing chip 1410B, the hashing chip 1410B is coupled to the hashing chip 1410C, and so forth, with the hashing chip 1410P is coupled to the hashing chip 1410Q at the end of the daisy chain. The controller 1405 can be referred to as a microcontroller, a microcontroller unit (MCU), a processor, a computing system, or a combination thereof.

In some examples, the hashing management architecture 1400 can include additional hashing chips beyond the fifteen hashing chips 1410A-1410Q illustrated in FIG. 14. For instance, in some examples, additional hashing chips may be added between the controller 1405 and the hashing chip 1410A, after the hashing chip 1410Q (e.g., in an additional row of hashing chips coupled to hashing chip 1410Q similarly to how hashing chips 1410E-1410F are coupled), in between any two hashing chips of the hashing chips 1410A-1410Q, or a combination thereof. Likewise, one or more hashing chips of the hashing chips 1410A-1410Q can be omitted or removed from the hashing management architecture 1400.

The hashing management architecture 1400 include one or more connectors between each pair of adjacent hashing chips (e.g., between hashing chips 1410A-1410B, between hashing chips 1410B-1410C, and so forth) and between the controller 1405 and the hashing chip 1410A. The connectors of FIG. 14 are illustrated as double-sided arrows, with each double-sided arrow representing, one or more two-directional connectors, one or more single-directional connectors, or combinations thereof.

In some examples, the hashing chips 1410A-1410Q can be referred to as mining ASICs, chips, hash ASICs, hashing ASICs, hash dies, hash cores, hash chips, hashing dies, hashing cores, hashing chips, mining dies, mining cores, mining chips, ASICs, dies, cores, chips, or a combination thereof. In some examples, the hashing chips 1410A-1410Q can be coupled to one another. In some examples, instructions meant for a target hashing chip may pass through one or more other hashing chips before reaching the target hashing chip. In some examples, results (e.g., of mining and/or hashing calculations) performed by a specific hashing chip may pass through one or more other hashing chips before reaching the controller 1405.

In some examples, the controller 1405 can instruct different hashing chips 1410A-1410Q to generate hashes for different ranges of nonces, so that the mining computations can be parallelized across different hashing chips of the hashing chips 1410A-1410Q, increasing efficiency of hashing computations and/or mining computations. In some examples, the controller 1405 can instruct different hashing chips to generate hashes for different sets of data altogether (e.g., associated with different transaction(s) and/or different blocks), so that the hashing computations and/or mining computations can be parallelized across the different hashing chips, increasing efficiency of hashing computations and/or mining computations. In some examples, the controller 1405 can apportion different mining and/or hashing calculations across the different hashing chips based on characteristics (e.g., measured temperature) of the different hashing chips 1410A-1410Q, for instance instructing some hashing chips (e.g., those at a lower temperature or that are more powerful) to perform more mining and/or hashing calculations while instructing other hashing chips (e.g., those at a higher temperature or that are less powerful) to perform fewer mining and/or hashing calculations.

In some examples, the mining hashboard in the hashing management architecture 1400 can include connector(s) 1485, such as ports, plugs, wires, wireless communication interface(s), other connectors, or combinations thereof. In some examples, the hashing management architecture 1400 can include a second controller 1480 that is separate from the controller 1405, and in some cases that is separate from the mining hashboard in the hashing management architecture 1400. The second controller 1480 can be on a control board that is separate from the mining hashboard in the hashing management architecture 1400. In some examples, the hashing management architecture 1400 includes the control board that the second controller 1480 is on. For instance, the hashing management architecture 1400 can be an example of the mining system 1305, including the one control board 1310 and the three hashboards 1355. In some examples, the second controller 1480 and/or the control board (that includes the second controller 1480) includes connector(s) 1490, such as ports, plugs, wires, wireless communication interface(s), other connectors, or combinations thereof. The connector(s) 1485 of the mining hashboard can couple (e.g., in a wired or wireless fashion) to the connector(s) 1490 of the second controller 1480 and/or the control board (that includes the second controller 1480). For instance, the second controller 1480 can be an example of the one control board 1310 and/or the MPU 1315. The connector(s) 1485 can be examples of the USB connector 1340. The connector(s) 1490 can be examples of the USB connector 1365.

In some examples, instructions from the second controller 1480 to the controller 1405 and/or the hashing chips 1410A-1410Q can be sent by the 1480, conveyed by the connector(s) 1490 and/or the connector(s) 1485, and received by the controller 1405 and/or the hashing chips 1410A-1410Q. Results of the hashing computations and/or mining computations can be output from the hashing chips 1410A-1410Q and/or the controller 1405, conveyed by the connector(s) 1485 and/or the connector(s) 1490, and received by the second controller 1480. In some examples, the second controller 1480 and/or the control board (that includes the second controller 1480) includes other connector(s) 1495. In some examples, the connector(s) 1495 can couple the second controller 1480 and/or the control board (that includes the second controller 1480) to other mining hashboards, to a power supply (e.g., to the voltage (V_{DD}) 1430 and/or to ground (Gnd) 1420), to a third controller (e.g., that can also control aspect(s) of the performance of the hashing calculations), or a combination thereof.

In some examples, the connector(s) 1485 of the mining hashboard include at least one connector that is coupled to the controller 1405, so the controller 1405 conveys communications between the mining hashboard and the second controller 1480. This can provide a benefit in that the controller 1405 can parse and/or interpret instructions from the second controller 1480 for the hashing chips 1410A-1410Q, and/or can arrange instructions (from the second controller 1480 and/or from the controller 1405 itself) in an optimal order, improving efficiency of the hashing management architecture 1400. In some examples, the connector(s) 1485 of the mining hashboard include at least one connector that is coupled to at least one of the hashing chips 1410A-1410Q directly (e.g., hashing chip 1410A), bypassing the controller 1405. This can provide a benefit by allowing the second controller 1480 to exert independent control over the hashing chips 1410A-1410Q without interference from the controller 1405 (e.g., if the controller 1405 is compromised or damaged), improving security, reliability, and flexibility of the hashing management architecture 1400.

In some examples, a first aspect of performance of the hashing calculations (controlled by the controller 1405) controls aspects that are specific to the mining hashboard that the controller 1405 and the hashing chips 1410A-1410Q are located on, while the second aspect of performance of the hashing calculations (controlled by the second controller 1480) controls aspects of both the mining hashboard (that the controller 1405 and the hashing chips 1410A-1410Q are located on) and other mining hashboards (separate from the specific mining hashboard) that the second controller 1480 (and/or its control board) is also coupled to (e.g., via the connector(s) 1495).

In some examples, the hashing management architecture 1400 can include, or be included by, for instance, the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the mining system 1500, the hashing system that performs the process 1600, the hashing system that performs the process 1700, the environment 1800 for application interface customization, the environment 1900, the system 2000, or a combination thereof.

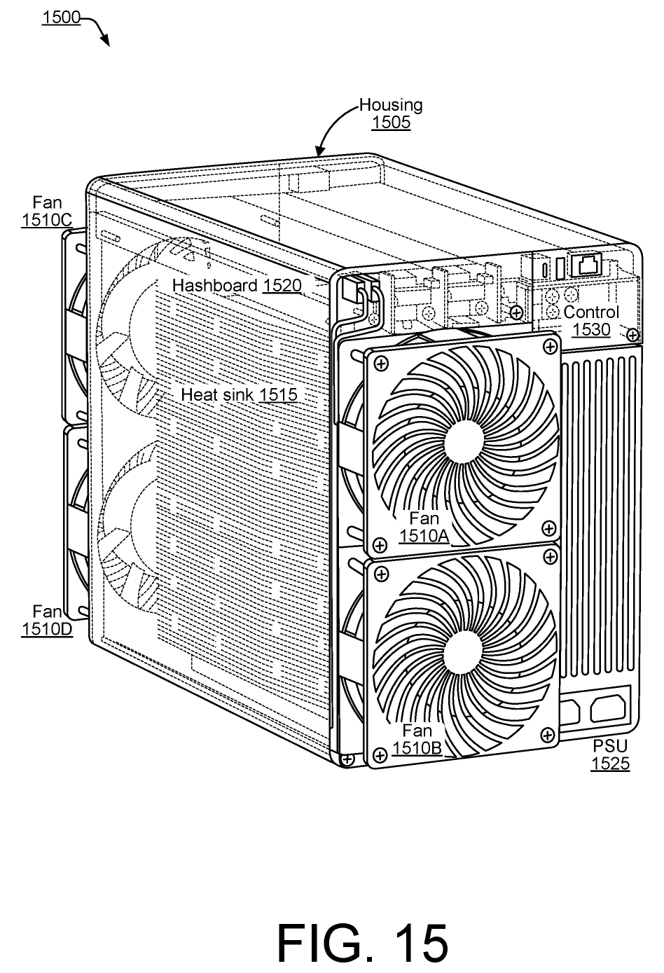

FIG. 15 is an isometric diagram illustrating a mining system 1500 with hashboards (e.g., hashboard 1520 with heat sink 1515), a control board 1530, fans 1510A-1510D, and a power supply unit 1525 (PSU) within a housing 1505. In some examples, the mining system 1500 can include multiple hashboards as in the three hashboards 1355 of the mining system 1305. For instance, additional hashboards may be arranged side-by-side next to (e.g., to the right of) the hashboard 1520 within the housing 1505 of the mining system 1500, so that the fans 1510A-1510D blow air (and/or another fluid) across all of the hashboards to cool the hashboards. All of the hashboards can be coupled to the control board 1530. In some examples, the control board 1530 can be coupled to, and/or include, a user interface, for instance including the lights 1330, the buttons 1335, a display (e.g., a touchscreen display), and/or other input and/or output devices.

The mining system 1500 can include, or be included by, for instance, the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the hashing system that performs the process 1700, the environment 1800 for application interface customization, the environment 1900, the system 2000, or a combination thereof.

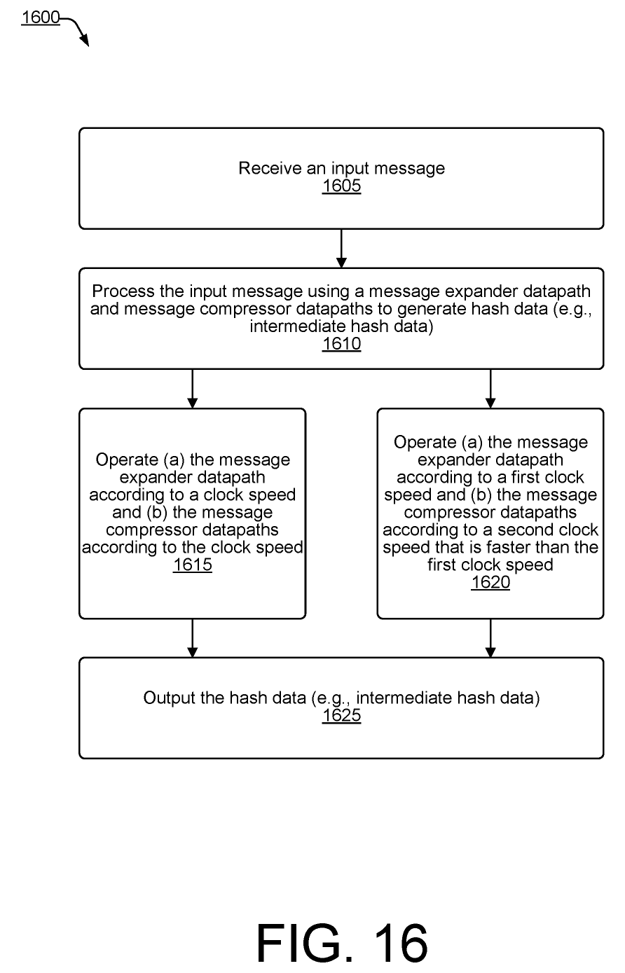

FIG. 16 is a flow diagram illustrating a process 1600 for hashing (e.g., for a primary hash process). The process 1600 can be performed by, and/or using, a hashing system. The hashing system can include, for instance, the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1700, the environment 1800 for application interface customization, the environment 1900, the system 2000, a system, an apparatus, a point of sale (POS) system or terminal, a transaction instrument reader device, a processor that performs instructions stored in a non-transitory computer-readable storage medium, any subsystems or components of any of the above-listed systems, any other computing systems disclosed herein, or a combination thereof.

The process 1600 can be, correspond to, and/or include, a primary hash process, such as the primary hash process 115, the primary hash process 290, the primary hash process performed by the hashing engine 300, the primary hash process performed by the hashing engine 400, the primary hash process 590, the primary hash process 990, the primary hash process 1290, another primary hash process discussed herein, or a combination thereof. The process 1600 can be, correspond to, and/or include, an SHA-1 subroutine of an SHA process (e.g., for SHA-256).

At operation 1605, the hashing system (or a subsystem thereof) is configured to, and can, receive an input message (e.g., the message 105, the message input 350, and/or the message input 450).

At operation 1610, the hashing system (or a subsystem thereof) is configured to, and can, process the input message using a message expander datapath and a plurality of message compressor datapaths to generate hash data (e.g., the intermediate hash data 120). Each temporal stage of the message expander datapath outputs intermediate expanded data to a corresponding temporal stage of the plurality of message compressor datapaths. The hash data may be referred to as intermediate hash data or partially-hashed digest data, as the process 1600 may represent an example of the primary hash process 115 that feeds into the secondary hash process 125 (of which the process 1700 is an example).

Examples of the message expander datapath include the ME 140, the ME 215, the expander datapath 315 (ME), the expander datapath 415 (ME), and/or the ME 915. Examples of the plurality of message compressor datapaths include the MCs 145A-145D, the MC 205, the MC 210, the MC 220, the MC 225, the compressor datapath 305, the compressor datapath 310, the compressor datapath 320, the compressor datapath 325, the compressor datapath 405, the compressor datapath 410, the compressor datapath 420, the compressor datapath 425, the MC 905, the MC 910, the MC 920, and/or the MC 925.

Operation 1610 can be followed by, or performed according to, either operation 1615 or operation 1620.

In some aspects, the hashing system (or a subsystem thereof) is configured to, and can, partition the input message into a plurality of words (e.g., 32-bit words). In some aspects, processing the input message using the message expander datapath and the plurality of message compressor datapaths (as in operation 1610, operation 1615, and/or operation 1620) includes processing the plurality of words using the message expander datapath and the plurality of message compressor datapaths.

In some aspects, the plurality of message compressor datapaths include at least four message compressor datapaths (e.g., as illustrated in the primary hash process 115, the primary hash process 290, the hashing engine 300, the hashing engine 400, the primary hash process 590, the primary hash process 990, and the primary hash process 1290).

At operation 1615, the hashing system (or a subsystem thereof) is configured to, and can, operate (a) the message expander datapath according to a clock speed and (b) the message compressor datapaths according to the (same) clock speed. Examples of the operation 1615 include the primary hash process 115 as performed by the hashing engine 200 (e.g., the primary hash process 290), the hashing engine 300, and the hashing engine 900 (e.g., the primary hash process 990).

At operation 1620, the hashing system (or a subsystem thereof) is configured to, and can, operate (a) the message expander datapath according to a first clock speed and (b) the message compressor datapaths according to a second clock speed that is faster than the first clock speed. In some aspects, the second clock speed is at least double the first clock speed. In some aspects, the second clock speed is double the first clock speed. Examples of the operation 1620 include the primary hash process 115 as performed by the hashing engine 400, the hashing engine 500 (e.g., the primary hash process 590), and the hashing engine 1200 (e.g., the primary hash process 1290).

In some aspects, the message expander datapath operates according to message expander clock cycles, and the plurality of message compressor datapaths operate according to message compressor clock cycles. In some aspects, the message expander clock cycles are at least twice as long as the message compressor clock cycles (e.g., the ME cycle 435 are twice as long as each of the MC cycles 430A-430B).

In some aspects, the message expander datapath includes one flop in each of the message expander clock cycles (e.g., one flop in the ME cycle 435). In some aspects, the plurality of message compressor datapaths each include a plurity of flops in each of the message expander clock cycles (e.g., two flops in the ME cycle 435, one flop in each of the MC cycle 430A and the MC cycle 430B).

In some aspects, the message expander datapath performs a full round of message expansion logic per message expander clock cycle (e.g., ME cycle 435), while the plurality of message compressor datapaths each perform a partial round of message expansion logic (e.g., 0.5x Logic) per message compressor clock cycle (e.g., per each of the MC cycles 430A-430B).

At operation 1625, the hashing system (or a subsystem thereof) is configured to, and can, output the hash data (e.g., intermediate hash data 120). In some examples, the hash data can be referred to as a hash, a hash digest, hash data, hash digest data, intermediate data, intermediate digest data, intermediate hash digest data, partially-hashed data, partially-hashed hash data, partially-hashed hash digest data, or a combination thereof. The hash data may be referred to as intermediate hash data or partially-hashed digest data, as the process 1600 may represent an example of the primary hash process 115 that feeds into the secondary hash process 125 (of which the process 1700 is an example).

In some aspects, outputting the intermediate hash data (as in operation 1625) includes outputting the hash data (e.g., the intermediate hash data 120) to be further processed in a secondary hashing process. Examples of the secondary hashing process include the secondary hash process 125, the secondary hash process 295, the secondary hash process 595, the secondary hash process performed by the hashing engine 600, the secondary hash process performed by the hashing engine 700, the secondary hash process performed by the hashing engine 800, the secondary hash process 995, the secondary hash process 1295, the process 1700, or a combination thereof. In some examples, the hash data (e.g., intermediate hash data 120) is output from the primary hash process (i.e., the process 1600) to the secondary hash process as the intermediate hash data 120, the data that is transferred from the primary hash process 290 to the secondary hash process 295, the output of the primary hash process of the hashing engine 300, the output of the primary hash process of the hashing engine 400, the data that is transferred from the primary hash process 590 to the secondary hash process 595, the input(s) to the secondary hash process of the hashing engine 600 (e.g., the message input 640 and/or the digest input 645), the input(s) to the secondary hash process of the hashing engine 700 (e.g., the message input 740 and/or the digest input 745), the input(s) to the secondary hash process of the hashing engine 800 (e.g., the message input 840 and/or the digest input 845), the data that is transferred from the primary hash process 990 to the secondary hash process 995, the data that is transferred from the primary hash process 1290 to the secondary hash process 1295, or a combination thereof. In some aspects, processing the input message using the message expander datapath and the plurality of message compressor datapaths (as in operation 1610, operation 1615, and/or operation 1620) is part of a first portion (e.g. SHA-1) of a secure hash algorithm 256 (SHA-256) process. In some aspects, the secondary hashing process is a second portion (e.g., SHA-2) of the SHA-256 process.

In some aspects, the hashing system (or a subsystem thereof) includes at least one application-specific integrated circuit (ASIC) on a hashboard, as in the ASICs 1370A-1370Z on the hashboards 1355, the hashing chips 1410A-1410Q on the hashing management architecture 1400, and/or ASICs on the hashboard 1520 of the mining system 1500.

In some aspects, the message expander datapath is a shift register path. In some aspects, the plurality of message compressor datapaths are shift register paths. In some aspects, the message expander logic includes combinational logic and/or arithmetic logic. In some aspects, the message compressor logic includes combinational logic and/or arithmetic logic.

In some aspects, the hashing system (or a subsystem thereof) is configured to, and can, perform the process 1700 using the hash data (e.g., intermediate hash data 120) output at operation 1625. For instance, in some aspects, the hashing system (or a subsystem thereof) is configured to, and can, receive the hash data (e.g., the intermediate hash data 120) (e.g., at a secondary hash process) (as in operation 1705). In some aspects, the hashing system (or a subsystem thereof) is configured to, and can, process the hash data (e.g., intermediate hash data 120) using at least one secondary message expander datapath (e.g., the at least one message expander datapath of operation 1710) and a secondary message compressor datapath (e.g., the message compressor datapath of operation 1710) to generate a hash digest (e.g., hash digest 130, the hash digest of operation 1730) of the input message (e.g., as in operation 1710). The at least one secondary message expander datapath alternates temporally (e.g., clock cycle by clock cycle) between a first message expander logic configuration and a second message expander logic configuration (e.g., according to operation 1715, operation 1720, or operation 1725). The at least one secondary message expander datapath outputs intermediate expanded data to each temporal stage of the secondary message compressor datapath. In some aspects, the hashing system (or a subsystem thereof) is configured to, and can, output the hash digest (as in operation 1730).

To perform the process 1600, the hashing system can split certain logic operations in two, with an additional data insertion opportunity at a flop inserted in between two portions of each such logic operation, ultimately increasing throughput. In some examples, the hashing system also increases the quantity of certain types of datapaths relative to other types of datapaths (e.g., increasing the quantity of MC datapaths relative to ME datapaths, or vice versa) to allow parallel processing of certain types of logic (e.g., ME logic and/or MC logic) to further improve throughput.

In cryptocurrency mining and in many other SHA use cases, throughput (e.g., hashes per second) is an important metric. By using temporal shared version unrolling, the hashing system can keep adding pipeline stages where they matter the most (e.g., in the MC) without needing to add equally deep pipelines everywhere else, since ME logic can be reused across multiple temporal cycles in the process 1600.

By splitting logic rounds (e.g., in an unconventional manner) and adding additional flops (e.g., to add data insertion opportunities) in between the split portions of logic, by processing certain functions in parallel, and by using temporal shared version unrolling, the hashing system that performs the process 1600 provides for improved memory management (e.g., using the flops) and improved hash processing. Improved hash processing in a SHA amounts to an improved cryptographic technique, resulting in improved security for cryptocurrency mining, secure communications over networks, and other applications of SHA.

As noted above, in some aspects, to perform the process 1600, the hashing system splits certain logic operations in two, which can also improve reliability with certain voltages (e.g., lower voltages than other hashing engines) and/or technology nodes (e.g., smaller transistors and/or other components than other hashing engines). For instance, inserting a flop in between portions of a logic operation can give a processor more time to complete each portion of the logic operation, if needed. In some examples, the hashing system also improves flexibility by increasing the number of flops (and therefore the number of opportunities for data insertion) in certain datapaths, improving reliability further by allowing for data to still be transferred on time between an ME datapath and an MC datapath even if the start of data transfer is delayed.

By improving reliability and flexibility of SHA as discussed above, the hashing system provides for a reduction in hashing error frequency, ultimately improving hashing quality and improving security for cryptocurrency mining, secure communications over networks, and other applications of SHA.

As noted above, to perform the process 1600, the hashing system splits certain logic operations in two, inserting an additional flop (and therefore an opportunity for data insertion) in between portions of the logic operations. In some examples, to perform the process 1600, the hashing system can block data transfer and/or insertion between datapaths (e.g., from an ME datapath to an MC datapath, or vice versa) until all data is settled and ready to transfer, preventing spurious logic state changes and/or signal transfers or transitions. This reduction in glitch power consumption ultimately reduces total power consumption in the hashing system.

This reduction in total power consumption can also reduce the need for thermal management systems (e.g., passive thermal management systems and/or active thermal management systems), such as heat sinks, heat spreaders, fans, liquid cooling systems, heat pumps, coolers, and/or other cooling systems. Reducing the need for thermal management systems can also further reduce total power consumption (e.g., by reducing use of active thermal management systems such as fans or pump-based liquid cooling systems that use power themselves) and/or reduce size (e.g., by reducing the size and/or quantity of heat sinks or other thermal management systems).

As noted above, in some examples, to perform the process 1600, the hashing system increases the quantity of certain types of datapaths relative to other types of datapaths (e.g., increasing the quantity of MC datapaths relative to ME datapaths, or vice versa) to allow parallel processing of certain types of logic (e.g., ME logic and/or MC logic) to further improve throughput. This increased datapath count, and the resulting parallel processing, can prevent missed or delayed data transfers and can thus further reduce total frequency and/or amount of flip-flops from start of hashing to completion of hashing.

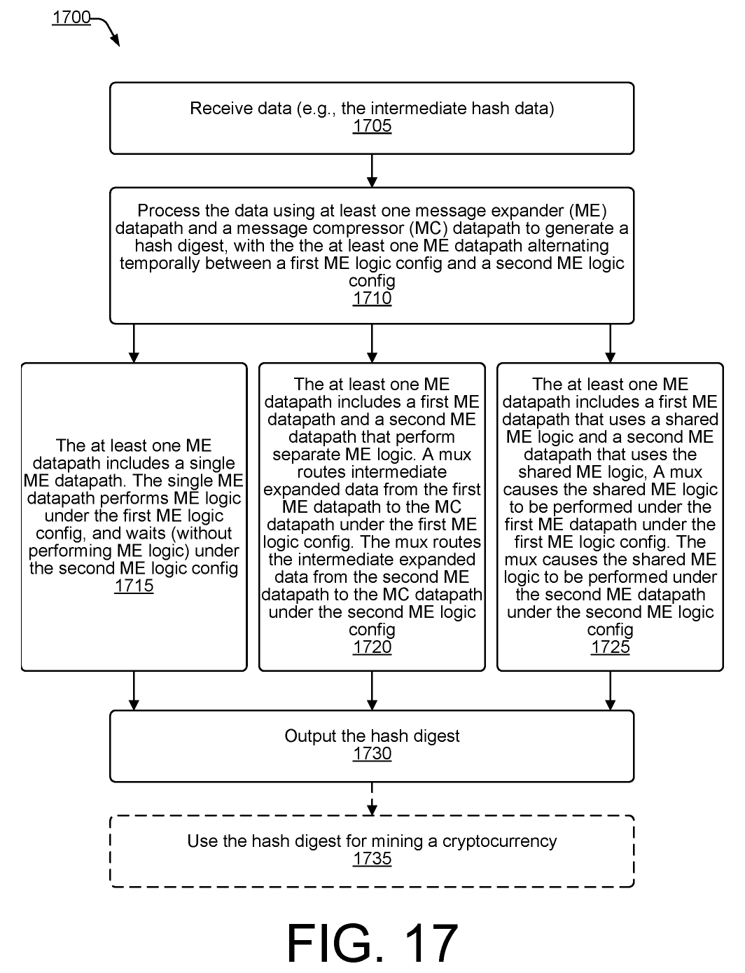

FIG. 17 is a flow diagram illustrating a process 1700 for hashing (e.g., for a secondary hash process). The process 1700 can be performed by, and/or using, a hashing system. The hashing system can include, for instance, the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the environment 1800 for application interface customization, the environment 1900, the system 2000, a system, an apparatus, a point of sale (POS) system or terminal, a transaction instrument reader device, a processor that performs instructions stored in a non-transitory computer-readable storage medium, any subsystems or components of any of the above-listed systems, any other computing systems disclosed herein, or a combination thereof.

The process 1700 can be, correspond to, and/or include, a secondary hash process, such as the secondary hash process 115, the secondary hash process 295, the secondary hash process performed by the hashing engine 300, the secondary hash process performed by the hashing engine 400, the secondary hash process 595, the secondary hash process 995, the secondary hash process 1295, another secondary hash process discussed herein, or a combination thereof. The process 1700 can be, correspond to, and/or include, an SHA-2 subroutine of an SHA process (e.g., for SHA-256).

At operation 1705, the hashing system (or a subsystem thereof) is configured to, and can, receive data. Examples of the data include the message 105, the intermediate hash data 120, the data that is transferred from the primary hash process 290 to the secondary hash process 295, the output of the primary hash process of the hashing engine 300, the output of the primary hash process of the hashing engine 400, the data that is transferred from the primary hash process 590 to the secondary hash process 595, the input(s) to the secondary hash process of the hashing engine 600 (e.g., the message input 640 and/or the digest input 645), the input(s) to the secondary hash process of the hashing engine 700 (e.g., the message input 740 and/or the digest input 745), the input(s) to the secondary hash process of the hashing engine 800 (e.g., the message input 840 and/or the digest input 845), the data that is transferred from the primary hash process 990 to the secondary hash process 995, the data that is transferred from the primary hash process 1290 to the secondary hash process 1295, or a combination thereof.

At operation 1710, the hashing system (or a subsystem thereof) is configured to, and can, process the data using at least one message expander datapath and a message compressor datapath to generate a hash digest (e.g., hash digest 130). The at least one message expander datapath alternates temporally (e.g., clock cycle by clock cycle) between a first message expander logic configuration and a second message expander logic configuration. The at least one message expander datapath outputs intermediate expanded data to each temporal stage of the message compressor datapath.

Examples of the at least one message expander datapath include the MEs 150A-150D, the ME 235, the ME 245, the ME 255, the ME 265, the ME 530, the ME 540, the ME 545, the ME 555, the ME 560, the ME 570, the ME 575, the ME 585, the expander datapath 605 (ME), the first expander datapath 705 (ME), the second expander datapath 710 (ME), first expander datapath 805 (ME), the compressor datapath 810 (ME), the ME 930, the ME 940, the ME 945, the ME 955, the ME 1235, the ME 1245, the ME 1255, the ME 1265, or a combination thereof.

Examples of the message compressor datapath include the MCs 155A-155D, the MC 230, the MC 240, the MC 250, the MC 260, the MC 535, the MC 550, the MC 565, the MC 580, the compressor datapath 610 (MC), the compressor datapath 715 (MC), the compressor datapath 815 (MC), the MC 935, the MC 950, the MC 1230, the MC 1240, the MC 1250, the MC 1260, or a combination thereof.

In some aspects, the at least one message expander datapath operates according to a clock speed, and the message compressor datapath operates according to the (same) clock speed. Examples of the at least one message expander datapath and the message compressor datapath operating at the same clock speed for a secondary hash process include the hashing engine 200 and the hashing engine 600.

In some aspects, the at least one message expander datapath operates according to a first clock speed, and the message compressor datapath operates according to a second clock speed that is faster than (e.g., at least double) the first clock speed. Examples of the at least one message expander datapath operating at a faster clock speed than the message compressor datapath for a secondary hash process include the hashing engine 500, the hashing engine 700, the hashing engine 800, the hashing engine 900, and the hashing engine 1200.

Operation 1710 can be followed by, or performed according to, either operation 1715 (e.g., as in the hashing engine 600), operation 1720 (e.g., as in the hashing engine 700), or operation 1725 (e.g., as in the hashing engine 800).

At operation 1715, the hashing system (or a subsystem thereof) is configured to, and can, operate such that the at least one message expander datapath includes a single message expander datapath (e.g., the expander datapath 605). The single message expander datapath performs message expander logic under the first message expander logic configuration (e.g., as in the expander datapath 605 in the ME cycle 635A). The single message expander datapath waits (without performing message expander logic) under the second message expander logic configuration (e.g., as in the expander datapath 605 in the ME cycle 635B).

In some aspects, the at least one message expander datapath alternating temporally between the first message expander logic configuration and the second message expander logic configuration (as in operation 1710) includes the single message expander datapath (of operation 1715) alternating temporally from clock cycle to clock cycle (e.g., from the ME cycle 635A to the ME cycle 635B) between the first message expander logic configuration and the second message expander logic configuration.

At operation 1720, the hashing system (or a subsystem thereof) is configured to, and can, operate such that the at least one message expander datapath includes a first message expander datapath (e.g., the first expander datapath 705) that performs first message expander datapath logic and a second message expander datapath (e.g., the second expander datapath 710) that performs second message expander datapath logic. A multiplexer (e.g. the multiplexer 720) routes the intermediate expanded data from the first message expander datapath (e.g., the first expander datapath 705) to the message compressor datapath (e.g., the compressor datapath 715) under the first message expander logic configuration. The multiplexer (e.g., the multiplexer 720) routes the intermediate expanded data from the second message expander datapath (e.g., the second expander datapath 710) to the message compressor datapath (e.g., the compressor datapath 715) under the second message expander logic configuration.

In some aspects, the intermediate expanded data is generated using the first message expander datapath logic under the first message expander logic configuration, and wherein the intermediate expanded data is generated using the second message expander datapath logic under the second message expander logic configuration.

In some aspects, the at least one message expander datapath alternating temporally between the first message expander logic configuration and the second message expander logic configuration includes the multiplexer (e.g., multiplexer 720) alternating temporally from message expander clock cycle to message expander clock cycle (e.g., from the ME cycle 735A to the ME cycle 735B) between the first message expander logic configuration and the second message expander logic configuration.

At operation 1725, the hashing system (or a subsystem thereof) is configured to, and can, operate such that the at least one message expander datapath includes a first message expander datapath (e.g., the first expander datapath 805) that uses a shared message expander logic (e.g., the shared ME logic 825) and a second message expander datapath (e.g., the compressor datapath 810) that uses the shared message expander logic (e.g., the shared ME logic 825). A multiplexer (e.g., the multiplexer 820) causes the shared message expander logic to be performed under the first message expander datapath under the first message expander logic configuration. The multiplexer causes the shared message expander logic to be performed under the second message expander datapath under the second message expander logic configuration.

In some aspects, the at least one message expander datapath alternating temporally between the first message expander logic configuration and the second message expander logic configuration includes the multiplexer (e.g., multiplexer 820) alternating temporally from message expander clock cycle to message expander clock cycle (e.g., from the ME cycle 835A to the ME cycle 835B) between the first message expander logic configuration and the second message expander logic configuration.

In some aspects, the first message expander datapath is a first shift register path and the second message expander datapath is a second shift register path. In some aspects, the message compressor datapath is a shift register path. In some aspects, the message expander logic (e.g., the shared message expander logic as in shared ME logic 825 or separate message expander logic as in the hashing engine 700) includes combinational logic and/or arithmetic logic. In some aspects, the message compressor logic includes combinational logic and/or arithmetic logic.

At operation 1730, the hashing system (or a subsystem thereof) is configured to, and can, output the hash digest.

In some aspects, the data (that is received in operation 1705 and processed in operation 1710) includes intermediate hash data from a previous hashing process. The intermediate hash data based on an input message block (e.g., the message 105, the message input 350, and/or the message input 450), and the hash digest is a hash of the input message block.

In some aspects, the hash digest is a hash of the data.

In some aspects, the hashing system (or a subsystem thereof) is configured to, and can, use the hash digest for mining a cryptocurrency.

In some aspects, the hashing system (or a subsystem thereof) is configured to, and can, perform the process 1600 to obtain the data of operation 1705. For instance, in some aspects, the hashing system (or a subsystem thereof) is configured to, and can, receive an input message (as in operation 1605). In some aspects, the hashing system (or a subsystem thereof) is configured to, and can, process the input message using a secondary message expander datapath (e.g., the message expander datapath of operation 1610) and a plurality of secondary message compressor datapaths (e.g., the plurality of message compressor datapaths of operation 1610) to generate intermediate hash data (as in operation 1610, operation 1615, and/or operation 1620). The secondary message expander datapath operates according to a first clock speed, and the plurality of secondary message compressor datapaths operate according to a second clock speed that is faster than the first clock speed. Each temporal stage of the secondary message expander datapath outputs intermediate expanded data to a corresponding temporal stage of the plurality of secondary message compressor datapaths. In some aspects, the hashing system (or a subsystem thereof) is configured to, and can, output the intermediate hash data to the process 1700 as the data of operation 1705.

In some aspects, processing the data using the at least one message esxpander datapath and the message compressor datapath (as in operation 1710, operation 1715, operation 1720, and/or operation 1725) is part of a second portion (e.g., SHA-2) of a secure hash algorithm 256 (SHA-256) process. In some aspects, processing the input message using the secondary message expander datapath and the plurality of secondary message compressor datapaths (as in operation 1610, operation 1615, and/or operation 1620) is part of a first portion (e.g. SHA-1) of the SHA-256 process.

In some apsects, the hashing system (or a subsystem thereof) includes at least one application-specific integrated circuit (ASIC) on a hashboard, as in the ASICs 1370A-1370Z on the hashboards 1355, the hashing chips 1410A-1410Q on the hashing management architecture 1400, and/or ASICs on the hashboard 1520 of the mining system 1500.

To perform the process 1700, the hashing system can split certain logic operations in two, with an additional data insertion opportunity at a flop inserted in between two portions of each such logic operation, ultimately increasing throughput. In some examples, the hashing system also increases the quantity of certain types of datapaths relative to other types of datapaths (e.g., increasing the quantity of MC datapaths relative to ME datapaths, or vice versa) to allow parallel processing of certain types of logic (e.g., ME logic and/or MC logic) to further improve throughput.

In cryptocurrency mining and in many other SHA use cases, throughput (e.g., hashes per second) is an important metric. By using temporal shared version unrolling, the hashing system can keep adding pipeline stages where they matter the most (e.g., in the MC) without needing to add equally deep pipelines everywhere else, since ME logic can be reused across multiple temporal cycles in the process 1700.

By splitting logic rounds (e.g., in an unconventional manner) and adding additional flops (e.g., to add data insertion opportunities) in between the split portions of logic, by processing certain functions in parallel, and by using temporal shared version unrolling, the hashing system that performs the process 1700 provides for improved memory management (e.g., using the flops) and improved hash processing. Improved hash processing in a SHA amounts to an improved cryptographic technique, resulting in improved security for cryptocurrency mining, secure communications over networks, and other applications of SHA.

As noted above, in some aspects, to perform the process 1700, the hashing system splits certain logic operations in two, which can also improve reliability with certain voltages (e.g., lower voltages than other hashing engines) and/or technology nodes (e.g., smaller transistors and/or other components than other hashing engines). For instance, inserting a flop in between portions of a logic operation can give a processor more time to complete each portion of the logic operation, if needed. In some examples, the hashing system also improves flexibility by increasing the number of flops (and therefore the number of opportunities for data insertion) in certain datapaths, improving reliability further by allowing for data to still be transferred on time between an ME datapath and an MC datapath even if the start of data transfer is delayed.

By improving reliability and flexibility of SHA as discussed above, the hashing system provides for a reduction in hashing error frequency, ultimately improving hashing quality and improving security for cryptocurrency mining, secure communications over networks, and other applications of SHA.

As noted above, to perform the process 1700, the hashing system splits certain logic operations in two, inserting an additional flop (and therefore an opportunity for data insertion) in between portions of the logic operations. In some examples, to perform the process 1700, the hashing system can block data transfer and/or insertion between datapaths (e.g., from an ME datapath to an MC datapath, or vice versa) until all data is settled and ready to transfer, preventing spurious logic state changes and/or signal transfers or transitions. This reduction in glitch power consumption ultimately reduces total power consumption in the hashing system.

This reduction in total power consumption can also reduce the need for thermal management systems (e.g., passive thermal management systems and/or active thermal management systems), such as heat sinks, heat spreaders, fans, liquid cooling systems, heat pumps, coolers, and/or other cooling systems. Reducing the need for thermal management systems can also further reduce total power consumption (e.g., by reducing use of active thermal management systems such as fans or pump-based liquid cooling systems that use power themselves) and/or reduce size (e.g., by reducing the size and/or quantity of heat sinks or other thermal management systems).

As noted above, in some examples, to perform the process 1700, the hashing system increases the quantity of certain types of datapaths relative to other types of datapaths (e.g., increasing the quantity of ME datapaths relative to MC datapaths, or vice versa) to allow parallel processing of certain types of logic (e.g., ME logic and/or MC logic) to further improve throughput. This increased datapath count, and the resulting parallel processing, can prevent missed or delayed data transfers and can thus further reduce total frequency and/or amount of flip-flops from start of hashing to completion of hashing.

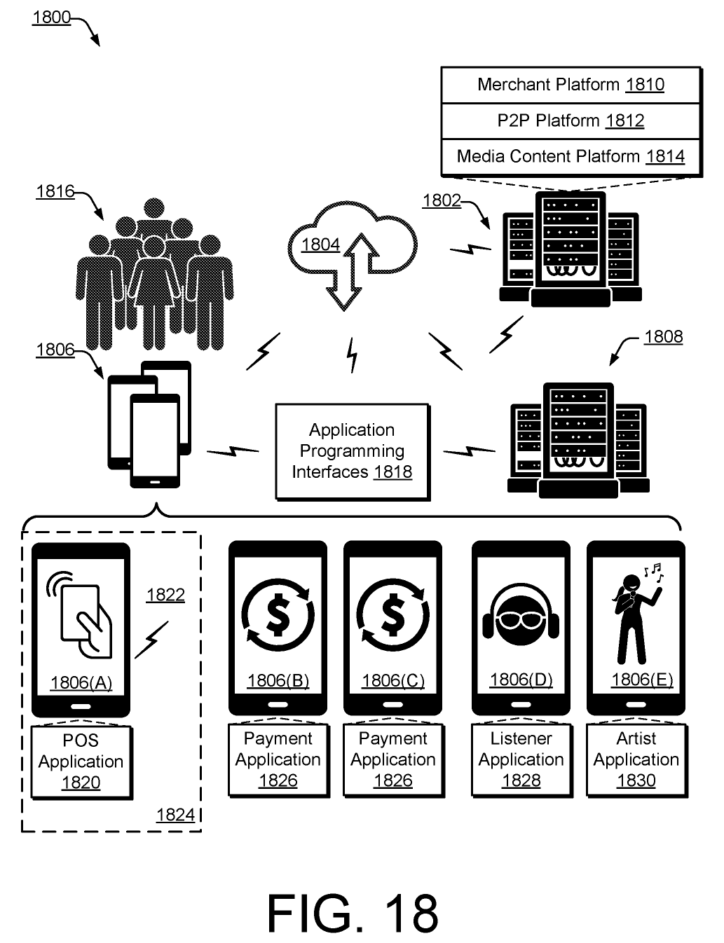

FIG. 18 illustrates an example environment 1800 for application interface customization. The environment 1800 includes server(s) 1802 that can communicate over a network 1804 with end user devices 1806 and/or server(s) 1808 associated with third-party service provider(s). In various examples, the end user devices 1806 may comprise one or more merchant devices 1806(A), one or more user devices 1806(B) and/or 1806(C) in a peer network, one or more content consumption devices 1806(D), one or more artist user devices 1806(E), combinations of these examples, or other categories of user devices. The server(s) 1802 can be associated with one or more service providers that can provide one or more services for the benefit of users 1816, as described below. For example, the server(s) 1802 may enable services of service providers such as in association with a merchant platform 1810 (which may further include a buyer platform), a peer-to-peer (P2P) payment platform 1812, a media content platform 1814, a combination of these platforms, or other platforms associated with other service providers. While services and features are referenced throughout in connection with a particular one of the merchant platform 1810, the P2P payment platform 1812, or the media content platform 1814, it should be understood that any of these platforms may perform the functionality described in relation to any of the other platforms. Actions attributed to the service provider(s) can be performed by the server(s) 1802.

In some examples, the end user devices 1806, merchant platform 1810, P2P platform 1812, and/or media content platform 1814 can be examples of the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the hashing system that performs the process 1700, or a combination thereof. In some examples, individual ones of the end user devices 1806 can be operable by users 1816 (e.g., user of any of the mining systems disclosed herein). The users 1816 (individually referred to herein as “user 1816”) can be referred to as miners, customers, buyers, merchants, sellers, borrowers, employees, employers, payors, payees, couriers, artists, musicians, listeners, fans, supervisors, hosts, audience members, and so on. The users 1816 can interact with the end user devices 1806 via user interfaces presented via the end user devices 1806. In at least one example, a user interface can be presented via a web browser, or the like. Alternatively or additionally, a user interface can be presented via an application, such as a mobile application or desktop application, which can be provided by the merchant platform 1810, the P2P payment platform 1812, and/or the media content platform 1814, or which can be an otherwise dedicated application. In some examples, individual end user devices 1806 can have an instance or versioned instance of an application, which can be downloaded from an application store, for example, which can present the user interface(s) described herein.

In at least one example, the users 1816 can include merchants that can operate the seller device(s) 1806(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1806(A) can have an instance of a point of sale (“POS”) application 1820 stored thereon. The POS application 1820 can configure the seller device 1806(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1820 can determine transaction data associated with the POS transactions. Transaction data can include payment information, which can be obtained from a reader device 1822 associated with the seller device 1806(A), user authentication data, purchase amount information, point-of-purchase information (e.g., item(s) purchased, date of purchase, time of purchase, subscription type, etc.), etc. The POS application 1820 can send transaction data to the server(s) 1802 such that the server(s) 1802 can track transactions of the customers, merchants, and/or the users 1816 over time. Furthermore, the POS application 1820 can present a UI to enable the merchant to interact with the POS application 1820 and/or the merchant platform 1810 via the POS application 1820.

In at least one example, the seller device 1806(A) can be a special-purpose computing device configured as a POS terminal (via the execution of the POS application 1820). In at least one example, the POS terminal may be connected to a reader device 1822, which is capable of accepting a variety of payment instruments, such as credit cards, debit cards, gift cards, short-range communication based payment instruments, and the like, as described below. In at least one example, the reader device 1822 can plug in to a port in the seller device 1806(A), such as a microphone port, a headphone port, an audio-jack, a data port, or other suitable port. In additional or alternative examples, the reader device 1822 can be coupled to the seller device 1806(A) via another wired or wireless connection, such as via Bluetooth®, BLE, and so on. In some examples, the reader device 1822 can be a software solution executing on the POS terminal, e.g., a mobile phone. In some examples, the reader device 1822 can read information from alternative payment instruments including, but not limited to, wristbands and the like.

In some examples, the reader device 1822 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1822, and communicate with the merchant platform 1810, which can provide, among other services, a payment processing service. The server(s) 1802 associated with the merchant platform 1810 can communicate with server(s) 1808, as described below. In this manner, the POS terminal and reader device 1822 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1822 of the POS system 1824 are shown as separate devices, in additional or alternative examples, the POS terminal and the reader device 1822 can be part of a single device. In some examples, the reader device 1822 can have a display integrated therein for presenting information to customers of a merchant. In additional or alternative examples, the POS terminal can have a display integrated therein for presenting information to the customers of the merchant. POS systems, such as the POS system 1824, may be mobile, such that POS terminals and reader devices may process transactions in disparate locations across the world. POS systems can be used for processing card-present transactions and card-not-present (CNP) transactions.

A card-present transaction is a transaction where both a customer and the customer’s payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1822, whereby the reader device 1822 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1824, the server(s) 1802, and/or the server(s) 1808 may exchange payment information and transaction data to determine whether transactions are authorized. For example, the POS system 1824 may provide encrypted payment data, user authentication data, purchase amount information, point-of-purchase information, etc. (collectively, transaction data) to server(s) 1802 over the network(s) 1804. The server(s) 1802 may send the transaction data to the server(s) 1808.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1808 associated therewith) can forward the fund transfer request to an issuing bank (e.g., “issuer”). The issuer is a bank or financial institution that offers a financial account (e.g., credit or debit card account) to a user. The issuer (e.g., the server(s) 1808 associated therewith) can make a determination as to whether the customer has the capacity to absorb the relevant charge associated with the payment transaction. In at least one example, the merchant platform 1810 can serve as an issuer and/or can partner with an issuer. The transaction is either approved or rejected by the issuer and/or the card payment network (e.g., the server(s) 1808 associated therewith), and a payment authorization message is communicated from the issuer to the POS device via a path opposite of that described above, or via an alternate path.

The server(s) 1808 may send an authorization notification over the network(s) 1804 to the server(s) 1802, which may send the authorization notification to the POS system 1824 over the network(s) 1804 to indicate whether the transaction is authorized. The server(s) 1802 may also transmit additional information such as transaction identifiers to the POS system 1824. In one example, the server(s) 1802 may include a merchant application and/or other functional components for communicating with the POS system 1824 and/or the server(s) 1808 to authorize or decline transactions (e.g., the API 1818). In examples, the merchant platform 1810 can enable the merchants to receive cash payments, payment card payments, and/or electronic payments from customers for POS transactions and the service provider can process transactions on behalf of the merchants.

Based on the authentication notification that is received by the POS system 1824 from server(s) 1802, the merchant may indicate to the customer whether the transaction has been approved. In some examples, approval may be indicated at the POS system 1824, for example, at a display of the POS system 1824. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 1810 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the end user devices 1806 can access all of the services. In some cases, the end user devices 1806 can have gradated access to the services, which can be based on risk tolerance, IDV outputs, subscriptions, and so on. In at least one example, access to such services can be availed to the merchants via the POS application 1820. In additional or alternative examples, each service can be associated with its own access point (e.g., application, web browser, etc.).

As the merchant platform 1810 processes transactions on behalf of the merchants, the merchant platform 1810 can maintain accounts or balances for the merchants in one or more ledgers. For example, the merchant platform 1810 can analyze transaction data received for a transaction to determine an amount of funds owed to a merchant for the transaction and deposit funds into an account of the merchant. The account can have a stored balance, which can be managed by the merchant platform 1810. The account can be different from a conventional bank account at least because the stored balance is managed by a ledger of the merchant platform 1810 and the associated funds are accessible via various withdrawal channels including, but not limited to, scheduled deposit, same-day deposit, instant deposit, and a linked payment instrument.

A scheduled deposit can occur when the merchant platform 1810 transfers funds associated with a stored balance of the merchant to a bank account of the merchant that is held at a bank or other financial institution (e.g., associated with the server(s) 1808). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 1810 to the bank account of the merchant.

In at least one example, the merchant platform 1810 may provide inventory management services. That is, the merchant platform 1810 may provide inventory tracking and reporting. Inventory management services may enable the merchant to access and manage a database storing data associated with a quantity of each item that the merchant has available (i.e., an inventory). Furthermore, in at least one example, the merchant platform 1810 can provide catalog management services to enable the merchant to maintain a catalog, which can be a database storing data associated with items that the merchant has available for acquisition (i.e., catalog management services). The merchant platform 1810 can offer recommendations related to pricing of the items, placement of items on the catalog, and multi-party fulfillment of the inventory, to name a few examples.

In at least one example, the merchant platform 1810 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 1810 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 1810 can provide financing services for offering and/or lending a loan to a borrower that is to be used for, in some instances, financing the borrower’s short-term operational needs (e.g., a capital loan). Additionally or alternatively, the merchant platform 1810 can provide financing services for offering and/or lending a loan to a borrower that is to be used for, in some instances, financing the borrower’s consumer purchase (e.g., a consumer loan). In at least one example, a borrower can submit a request for a loan to enable the borrower to purchase an item from a merchant. The merchant platform 1810 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 1810 can provide web-development services, which enable users 1816 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 1810 can recommend and/or generate content items to supplement omni-channel presences of the merchants.

Furthermore, the merchant platform 1810 can provide payroll services to enable employers to pay employees for work performed on behalf of employers. In at least one example, the merchant platform 1810 can receive data that includes time worked by an employee (e.g., through imported timecards and/or POS interactions), sales made by the employee, gratuities received by the employee, and so forth. Based on such data, the merchant platform 1810 can make payroll payments to employee(s) on behalf of an employer via the payroll service. For instance, the merchant platform 1810 can facilitate the transfer of a total amount to be paid out for the payroll of an employee from the bank of the employer to the bank of the merchant platform 1810 to be used to make payroll payments. In at least one example, when the funds have been received at the bank of the merchant platform 1810, the merchant platform 1810 can pay the employee, such as by check or direct deposit.

Moreover, in at least one example, the merchant platform 1810 can provide employee management services for managing schedules of employees. Further, the merchant platform 1810 can provide appointment services for enabling users 1816 to set schedules for scheduling appointments and/or users 1816 to schedule appointments.

In some examples, the merchant platform 1810 can provide restaurant management services to enable users 1816 to make and/or manage reservations, to monitor front-of-house and/or back-of-house operations, and so on. In such examples, the seller device(s) 1806(A) and/or server(s) 1802 can be configured to communicate with one or more other computing devices, which can be located in the front-of-house (e.g., POS device(s)) and/or back-of-house (e.g., kitchen display system(s) (KDS)). In at least one example, the merchant platform 1810 can provide order management services and/or fulfillment services to enable restaurants (or other merchant types) to manage open tickets, split tickets, and so on and/or manage fulfillment services.

In some examples, the merchant platform 1810 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 1810 can leverage other merchants and/or sales channels that are part of the merchant platform 1810 to fulfill the customer’s order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 1810 can enable conversational commerce via conversational commerce services, which can use one or more machine learning mechanisms to analyze messages exchanged between two or more users 1816, voice inputs into a virtual assistant or the like, to determine intents of user(s) 1816. In some examples, the merchant platform 1810 can utilize determined intents to automate customer service, offer promotions, provide recommendations, or otherwise interact with customers in real-time. In at least one example, the merchant platform 1810 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1816 may be new to the merchant platform 1810 such that the user 1816 that has not registered (e.g., subscribed to receive access to one or more services offered by the merchant platform 1810) with the merchant platform 1810. The merchant platform 1810 can offer onboarding services for registering a potential user 1816 with the merchant platform 1810. In some examples, onboarding can involve presenting various questions, prompts, and the like to a potential user 1816 to obtain information that can be used to generate a profile for the potential user 1816. In at least one example, the merchant platform 1810 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 1810 can be transitioned to more permissive (e.g., less limited) or longer-term access to such services.

The merchant platform 1810 can be associated with IDV services, which can be used by the merchant platform 1810 for compliance purposes and/or can be offered as a service, for instance to third-party service providers (e.g., associated with the server(s) 1808). That is, the merchant platform 1810 can offer IDV services to verify the identity of users 1816 seeking to use or using their services. Identity verification may involve requesting a customer (or potential customer) to provide information that is used by compliance departments to prove that the information is associated with an identity of a real person or entity (e.g., an artist). In at least one example, the merchant platform 1810 can perform services for determining whether identifying information provided by a user 1816 accurately identifies the customer (or potential customer).

Techniques described herein can be configured to operate in both real-time/online and offline modes. “Online” modes refer to modes when devices are capable of communicating with the merchant platform 1810 while offline mode refers to modes when devices are unable to communicate with the server(s) 1808 due to network connectivity issue, for example. In such examples, devices may operate in “offline” mode where at least some payment data is stored (e.g., on the seller device(s) 1806(A)) and/or the server(s) 1802 until connectivity is restored and the payment data can be transmitted to the server(s) 1802 and/or the server(s) 1808 for processing.

In at least one example, the merchant platform 1810 can be associated with a hub, such as an order hub, an inventory hub, a fulfillment hub and so on, which can enable integration with one or more additional service providers (e.g., associated with the additional server(s) 1808). In some examples, such additional service providers can offer additional or alternative services and the service provider can provide an interface or other computer-readable instructions to integrate functionality of the service provider into the one or more additional service providers.

Turning now to the P2P functionality provided by the environment 1800, the P2P platform 1812 can provide a peer-to-peer payment service that enables peer-to-peer payments between two or more of the users 1816. Two or more of the users 1816 may be considered “peers” in a peer-to-peer interaction, such as a payment. In at least one example, the P2P platform 1812 can communicate with instances of a payment application 1826 (or other access point) installed on end user devices 1806 configured for operation by the users 1816. In an example, an instance of the payment application 1826 executing on a first user device 1806(B) operated by a payor (e.g., one of the users 1816) can send a request to the P2P platform 1812 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1816) via a peer-to-peer payment. In some examples, assets associated with an account of the payor are transferred to an account of the payee. In some examples, assets can be held at least temporarily in an account of the P2P platform 1812 prior to transferring the assets to the account of the payee.

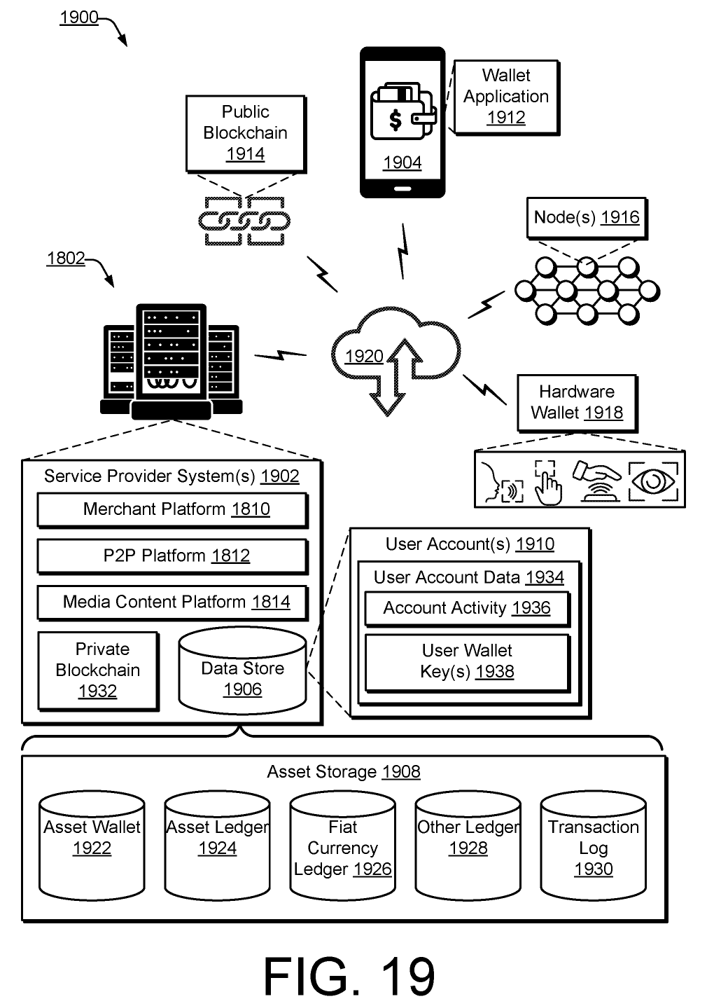

In some examples, the P2P platform 1812 can utilize a ledger system to track transfers of assets between users 1816. FIG. 19, below, provides additional details associated with such a ledger system. The ledger system can enable users 1816 to own fractional shares of assets that are not conventionally available. For instance, a user can own a fraction of a Bitcoin, an NFT, or a stock. Additional details are described herein.

In at least one example, the P2P platform 1812 can facilitate transfers and can send notifications related thereto to instances of the payment application 1826 executing on user device(s) of payee(s). As an example, the P2P platform 1812 can transfer assets from an account of a first user to an account of a second user and can send a notification to the user device 1806(B) of the second user for presentation via a user interface. The notification can indicate that a transfer is in process, a transfer is complete, or the like. In some examples, the P2P platform 1812 can send additional or alternative information to the instances of the payment application 1826 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1812 funds the request to payee on behalf of the payor, to speed up the transfer process and compensate for lags that may be attributed to the payor’s financial network.

In some examples, the P2P platform 1812 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1802 to treat the inputs as a request from the payor to transfer assets, where detection of the syntax triggers a transfer of assets. The currency indicator can correspond to various currencies including but not limited to, dollar ($), euro (€), pound (£), rupee (₹), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1826 executing on the end user devices 1806. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1812 can generate the landing page to enable the recipient to conveniently receive one or more payments from one or more senders.

In some examples, the peer-to-peer payment process can be implemented within a forum. The term “forum,” as used here, refers to a content provider’s media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 18 or a third-party service provider associated with the server(s) 1808. In examples where the content provider is a third-party service provider, the server(s) 1808 can be accessible via one or more APIs 1818 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1812 (e.g., the P2P platform 1812 offers a chat or messaging service that is within the payment application or accessible via the payment application). In some examples, the messaging application can be external to the P2P platform 1812. (e.g., the messaging application is hosted by a third-party service provider associated with the server(s) 1808, which can be accessible via one or more of the APIs 1818 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1812 can enable users 1816 to perform banking transactions via instances of the payment application 1826. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1812 can enable users to allocate funds between different accounts, sub-accounts, or balances (e.g., spending, saving, different assets, different currencies), etc. Further, users 1816 can configure bill pay, recurring payments, and/or the like using assets associated with their accounts. In some examples, the P2P platform 1812, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1812 enables users to buy and/or sell assets via asset networks such as cryptocurrency networks, securities networks, and/or the like. In some examples, acquisition of such assets can be in whole or fractional shares. The ledger system described below with reference to FIG. 19 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1812 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1812 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1812 can automatically apply the amount of funds associated with the gift card to the transaction.

In some examples, users can configure their account such that when they use their payment instruments, the P2P platform 1812 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1812 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent’s account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1812 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1812 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1812.

In some examples, components of the environment 1800 may be integrated to enable payments at the point-of-sale using assets associated with user accounts of the P2P platform 1812. As illustrated in the environment 1800, the components can communicate with one another via the network 1804, where one or more APIs 1818 or other functional components can be used to facilitate such communication.

In at least one example, an integration can enable a customer to participate in a transaction via their own computing device (e.g., user device 1806(B)) instead of interacting with a merchant device of a merchant, such as the seller device 1806(A). In such an example, the POS application 1820, associated with a payment processing platform and executable by the seller device 1806(A) of the merchant, can present a Quick Response (QR) code, or other code that can be used to identify a transaction (e.g., a transaction code), in association with a transaction between the customer and the merchant. The QR code, or other transaction code, can be provided to the POS application 1820 via an API 1818 associated with the peer-to-peer payment platform. In an example, the customer can utilize their own computing device, such as the user device 1806(B), to capture the QR code, or the other transaction code, and to provide an indication of the captured QR code, or other transaction code, to server(s) 1802.

Based at least in part on the integration of the peer-to-peer payment platform and the payment processing platform (e.g., via the API 1818), the server(s) 1802 of the merchant platform 1810 can exchange communications with a payment application 1826 associated with the P2P platform 1812 and/or the POS application 1820 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1812 and merchant platform 1810 (which can be a first- or third-party integration) such that a QR code, or other transaction code, specific to the transaction can be used for providing transaction details, location details, customer details, or the like to a computing device of the customer, such as the user device 1806(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1806(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1820 and the payment application 1826, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1806(B), can be specially configured as a buyer-facing device having functionality similar to the functionality described above in the brick-and-mortar example.

In some examples, based at least in part on capturing the QR code, or other transaction code, the merchant platform 1810 can provide transaction data to the P2P platform 1812 for presentation via the payment application 1826 on the computing device of the customer, such as the user device 1806(B), to enable the customer to complete the transaction via their own computing device. In some examples, in response to receiving an indication that the QR code, or other transaction code, has been captured or otherwise interacted with via the customer computing device, the P2P platform 1812 can determine that the customer authorizes payment of the transaction using funds associated with a stored balance of the customer that is managed and/or maintained by the P2P platform 1812. Such authorization can be implicit such that the interaction with the transaction code can imply authorization of the customer. Alternatively or additionally, the P2P platform 1812 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1812 can transfer funds from the stored balance of the customer to the merchant platform 1810. In at least one example, the merchant platform 1810 can deposit the funds, or a portion thereof, into a stored balance of the merchant that is managed and/or maintained by the merchant platform 1810. In such an example, the merchant platform 1810 can be a “peer” to the customer in a peer-to-peer transaction.

In some examples, techniques described herein can enable the customer to interact with the transaction after payment for the transaction has been settled. For example, in at least one example, the merchant platform 1810 can cause a total amount of a transaction to be presented via a user interface associated with the payment application 1826 such that the customer can provide gratuity, feedback, loyalty information, or the like, via an interaction with the user interface. In another example, the merchant platform 1810 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1812, if the customer inputs a tip and/or an event affecting the total amount of the transaction is triggered, the P2P platform 1812 can transfer additional funds, associated with the tip or event, to the merchant platform 1810. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1826 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1812 as described herein (e.g., a debit card linked to a stored balance of a customer) such that when the payment instrument is caused to interact with a payment reader, the merchant platform 1810 can exchange communications with the P2P platform 1812 to authorize payment for a transaction and/or provision associated transaction data to a computing device of the customer associated with the transaction.

Turning now to media content functionality provided by the environment 1800, the media content platform 1814 can provide digital media to a content consumption device 1806(D) where playback may occur using “streaming.” In examples, “streaming” media content involves encoding the media content and transmitting the encoded media content over the network 1804 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1814 can provide a digital media streaming service (e.g., subscription-based, non-subscription-based) that enables a content consumption device 1806(D) to stream and/or download digital media content via a listener application 1828 installed on the content consumption device 1806(D). For instance, the media content platform 1814 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1806(D), the listener application 1828 may verify access rights to the digital media content items at time intervals, for instance intermittently (e.g., when the content consumption device 1806(D) has a network connection with the media content platform 1814 via the network(s) 1804), and/or at regular intervals (e.g., daily, weekly, monthly, etc.). In examples, access rights to the digital media content items may be provided when a subscription to the media content platform 1814 is active, while access rights to the digital media content items may be withheld when the subscription to the media content platform 1814 is terminated. Enabling storage on the end user devices 1806 and subsequent access to digital media content items via the listener application 1828 provides the users 1816 with the ability to access the digital media content items “offline” such as when a connection to the media content platform 1814 via the network(s) 1804 is unavailable or unreliable.

In some examples, the media content platform 1814 may additionally or alternatively provide an artist management service that enables the users 1816 to manage aspects of artist business via an artist application 1830 installed on the artist device 1806(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1816 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1816 may have access to a single user account via respective end user devices 1806, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1830 and the listener application 1828 may be distinct applications having differing user experiences and verification processes for access, such as illustrated in the environment 1800. For instance, the media content platform 1814 may request additional verification, such as a link to an artist website, a sample of an artist’s work, a verified credential supplied by a third party, etc. to grant access to the artist application 1830 in addition to information requested to access the listener application 1828. Further, the artist application 1830 may provide the artist management services described herein, without the subscription-based digital media streaming services described herein, and vice versa. However, examples are also considered in which functionality provided by the artist application 1830 and the listener application 1828 partially or fully overlap, and/or where verification processes for access are substantially similar.

In at least some examples, the media content platform 1814 enables interaction between the users 1816 utilizing the listener application 1828 installed on the content consumption devices 1806(D), and the users 1816 utilizing the artist application 1830 installed on the artist end user devices 1806(E). For example, the media content platform 1814 may provide interconnectivity between the subscription-based digital media streaming service and the artist management service. Functionality provided by the media content platform 1814 in such instances may include a communication channel between one or more of the users 1816 (e.g., a listener, fan, music supervisor, publisher, etc.) utilizing the listener application 1828 and another user (e.g., an artist) of the users 1816 utilizing the artist application 1830. The communication channel may include, for instance, a messaging platform (also referred to as a “messaging application” herein), a live streaming platform, a videoconferencing or teleconferencing platform, and/or a combination of these.

Additionally, in some cases, the media content platform 1814 may facilitate a resource transfer between the listener application 1828 and the artist application 1830. In an example, the media content platform 1814 may direct a resource, such as a portion of a subscription fee paid by one of the users 1816 designated as a listener, to one or more of the users 1816 designated as artists based on a number of instances that the listening user consumed (e.g., streamed, downloaded, etc.) content created by respective ones of the artist users. Alternatively or additionally, the media content platform 1814 may direct a resource, such as funds, from an account associated with a listening user to an account associated with an artist user (or vice versa), in accordance with transfers between accounts as described herein. The media content platform 1814 may facilitate resource transfers in examples such as merchandise purchases, event ticket purchases, “tipping” an artist, payments for royalties or other fees, and so forth.

In some examples, the media content platform 1814 enables interaction between individual ones of the users 1816 with one another via the listener application 1828 installed on the content consumption device 1806(D) and other of the content consumption devices 1806(D) via a communication channel as described above. In an example, the listener application 1828 may provide functionality via a communication channel for a user to stream an individual digital media item, a playlist, or the like to an audience comprising other ones of the content consumption devices 1806(D). Alternatively or additionally, the communication channel may facilitate sharing of individual digital media items, playlists, user and/or artist profiles, and the like between the users 1816 via messages, uniform resource locators (URLs), quick response (QR) codes, and so forth.

In some cases, the media content platform 1814 enables interaction between individual ones of the users 1816 with one another via the artist application 1830 installed on the artist device 1806(E) and other of the artist end user devices 1806 via a communication channel as described above. In some instances, the media content platform 1814 may provide recommendations for a particular user indicating which of the other users 1816 to communicate with. Such a recommendation may be based on a similarity (or dissimilarity) of content created by two or more of the users 1816, an overlap (or lack thereof) of audience members of the users 1816, a geographic location of the users 1816, a coinciding event location of the users 1816, and so forth. In some examples, a user may input parameters for a desired connection via the artist application 1830, and the media content platform 1814 may filter which of the users 1816 to surface for recommendations to the user based on the input parameters. Alternatively or additionally, the media content platform 1814 may implement one or more machine learning models to filter which of the users 1816 to surface for recommendations to the user. The recommendations provided by the media content platform 1814 may be data driven and thus increase relevance of communications presented to the users 1816 and reduce unsolicited communications that may be received by the users 1816.

The media content platform 1814 may interact with the server(s) 1808 associated with the third-party service providers to, for instance, ingest digital media items, report digital media consumption data, pay royalties, and the like. In some examples, the server(s) 1808 may be accessible by the media content platform 1814 via one or more APIs 1818 or other integrations. In some cases, the third-party service provider may be a digital media content provider (e.g., a record label, a performance rights organization (PRO), an independent artist, etc.). In such cases, the media content platform 1814 may receive digital media content items from the server(s) 1808, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1814 may use the metadata to associate the digital media content item as being created by a particular user, to provide search results to the users 1816, to generate playlists, and so forth. Further, the media content platform 1814 may provide payments (e.g., royalties) to the third-party service provider based on a number of streams and/or downloads of individual digital media content items by the users 1816 via the listener application 1828.

Techniques described herein are directed to services provided via a distributed system of end user devices 1806 that are in communication with server(s) 1802 of the service provider. That is, techniques described herein are directed to a specific implementation—or, a practical application—of utilizing a distributed system of end user devices 1806 that are in communication with server(s) 1802 of the merchant platform 1810, the P2P platform 1812, and/or the media content platform 1814 to perform a variety of services, as described above. The unconventional configuration of the distributed system described herein enables the server(s) 1802 that are remotely-located from end-users (e.g., users 1816) to intelligently offer services based on aggregated data associated with the end-users, such as the users 1816 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 1810, the P2P platform 1812, and/or the media content platform 1814, and those outside of the control of these service providers, to track the standing (payables, receivables, payroll, invoices, appointments, capital, balances, collaborations, etc.) of the users 1816. The techniques herein provide a consolidated view of a user’s cash flow, predict needs, preemptively offer recommendations or services, such as capital, coupons, etc., and/or enable money movement between disparate accounts (merchant’s, another merchant’s, or even payment service’s) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1816 and end user devices 1806. Furthermore, such features are changed dynamically based on the profiles of the users involved interacting with the GUIs. As such, techniques described herein are directed to improvements to computing systems.

The merchant platform 1810, the P2P platform 1812, and/or the media content platform 1814 are capable of providing additional or alternative services, and the services described above are offered as a sampling of services. In at least one example, the merchant platform 1810, the P2P platform 1812, and/or the media content platform 1814 can exchange data with the server(s) 1808 associated with third-party service providers. Such third-party service providers can provide information that enables the merchant platform 1810, the P2P platform 1812, and/or the media content platform 1814 to provide services, such as those described above. In additional or alternative examples, such third-party service providers can access services of the merchant platform 1810, the P2P platform 1812, and/or the media content platform 1814. That is, in some examples, the third-party service providers can be subscribers, or otherwise access, services of the merchant platform 1810, the P2P platform 1812, and/or the media content platform 1814.

FIG. 19 illustrates an example environment 1900 including a service provider system 1902 which may be associated with the server(s) 1802 of FIG. 18. The environment 1900 may also include a user device 1904, which may correspond to any of the end user devices 1806 described in relation to FIG. 18. In examples, the service provider system 1902 may include one or a combination of the merchant platform 1810, the P2P platform 1812, or the media content platform 1814, as well as one or more data store(s) 1906 that can store assets in an asset storage 1908, as well as data in user account(s) 1910. In some examples, the environment 1900 may also include a public blockchain 1914, one or more nodes 1916, and/or a hardware wallet 1918. The service provider system 1902, the user device 1904, public blockchain 1914, the node(s) 1916, and the hardware wallet 1918 may be connected and able to communicate via one or more networks 1920, which may have the same or similar functionality described in relation to the network 1804 of FIG. 18.

In some examples, user account(s) 1910 can include merchant account(s), customer account(s), media content subscriber account(s), artist account(s), and so forth. In at least one example, the asset storage 1908 can be used to record whether individual assets are registered to a user account 1910. For example, the asset storage 1908 can include asset wallet(s) 1922 for storing records of assets owned by the service provider system 1902, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1808 of FIG. 18 can be associated therewith.

The asset wallet 1922 can be associated with one or more addresses and can vary addresses used to acquire assets (e.g., from the asset network(s)) so that its holdings are represented under a variety of addresses on the asset network. In examples where the service provider system 1902 has holdings of cryptocurrency (e.g., in the asset wallet 1922), a user can acquire cryptocurrency directly from the service provider system 1902. In some examples, the service provider system 1902 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1902 can provide the same or similar functionality for securities or other assets.

The asset storage 1908 may contain ledgers that store records of assignments of assets to users 1816. Specifically, the asset storage 1908 may include asset ledger 1924, fiat currency ledger 1926, and/or other ledger(s) 1928, which can be used to record transfers of assets between users 1816 and/or one or more third-parties (e.g., merchant network(s), payment card network(s), ACH network(s), equities network(s), the asset network, securities networks, etc.). In doing so, the asset storage 1908 can maintain a running balance of assets managed by the service provider system 1902. The ledger(s) of the asset storage 1908 can further indicate some of the running balance for individual ledger(s) stored in the asset storage 1908 are assigned or registered to one or more user account(s) 1910.

In at least one example, the asset storage 1908 can include transaction logs 1930, which can include, as transaction data, records of past transactions involving the service provider system 1902 and/or the user account 1910. In some examples, the data store(s) 1906 can store a private blockchain 1932. A private blockchain 1932 can function to record sender addresses, recipient addresses, public keys, values of cryptocurrency transferred, and/or can be used to verify ownership of cryptocurrency tokens to be transferred. In some examples, the service provider system 1902 can record transactions involving cryptocurrency until the number of transactions has exceeded a determined limit (e.g., number of transactions, storage space allocation, etc.). Based at least in part on determining that the limit has been reached, the service provider system 1902 can publish the transactions in the private blockchain 1932 to the public blockchain 1914 (e.g., associated with the asset network), where miners can verify the transactions and record the transactions to blocks on the public blockchain 1914. In at least one example, the service provider system 1902 can participate as miner(s) at least for transactions to which the respective platform is a party to, to be posted to the public blockchain 1914.

In some cases, the data store(s) 1906 can store and/or manage multiple user accounts, an example of which is described in relation to the user account 1910. In at least one example, the user account 1910 can include user account data 1934, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1934 can include account activity 1936 and user wallet key(s) 1938. In some examples, the user wallet key(s) 1938 can include a public-private key-pair and a respective address associated with the asset network or other asset networks. In some examples, the user wallet key(s) 1938 may include one or more key pairs, which can be unique to the asset network or other asset networks.

In addition to the user account data 1934, the user account 1910 can include ledger(s) for account(s) managed by the service provider system 1902, for the user. For example, the user account 1910 may include an asset ledger 1924, a fiat currency ledger 1926, and/or one or more other ledgers 1928. The ledger(s) can indicate that a corresponding user utilizes the service provider system 1902 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1902.

In some examples, the asset ledger 1924 can store a balance for each of one or more cryptocurrencies (e.g., Bitcoin, Ethereum, Litecoin, etc.) registered to the user account 1910. In at least one example, the asset ledger 1924 can further record transactions of cryptocurrency assets associated with the user account 1910. For example, the user account 1910 can receive cryptocurrency from the asset network using the user wallet key(s) 1938. In some examples, the user wallet key(s) 1938 may be generated for the user upon request. User wallet key(s) 1938 can be requested by the user in order to send, exchange, or otherwise control the balance of cryptocurrency held by the service provider system 1902 (e.g., in the asset wallet 1922) and registered to the user. In some examples, the user wallet key(s) 1938 may not be generated until a user account requires such. This on-the-fly wallet key generation provides enhanced security features for users, reducing the number of access points to a user account’s balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 1902 and the value is credited as a balance in asset ledger 1924), by purchasing currency in the form associated with the account using currency in a different form (e.g., buying a value of cryptocurrency from the service provider system 1902 using a value of fiat currency reflected in fiat currency ledger 12391226, and crediting the value of cryptocurrency in asset ledger 1924), or by conducting a transaction with another user (customer or merchant) of the service provider system 1902 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1902 (i.e., an external account). Such a transaction can request that the user to transfer an amount of the cryptocurrency in a message signed by user’s private key to an address provided by the service provider system 1902. In at least one example, the transaction can be sent to miners to bundle the transaction into a block of transactions and to verify the authenticity of the transactions in the block. Once a miner has verified the block, the block is written to the public blockchain 1914 where the service provider system 1902 can then verify that the transaction has been confirmed and can credit the user’s asset ledger 1924 with the transferred amount. When an account is funded by transferring cryptocurrency from a third-party cryptocurrency wallet, an update can be made to the public blockchain 1914. In some cases, this update of the public blockchain 1914 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1902. As described above, in some examples, the service provider system 1902 can acquire cryptocurrency from a third-party source. In examples where the service provider system 1902 has its own cryptocurrency assets, cryptocurrency transferred in a transaction (e.g., data with address provided for receipt of transaction and a balance of cryptocurrency transferred in the transaction) can be stored in an asset wallet 1922 associated with the service provider system 1902. In at least one example, the service provider system 1902 can credit the asset ledger 1924 of the user. Additionally, while the service provider system 1902 recognizes that the user retains the value of the transferred cryptocurrency through crediting the asset ledger 1924, an inspection of the blockchain will show the cryptocurrency as having been transferred to the service provider system 1902. In some examples, the asset wallet 1922 can be associated with many different addresses. In such examples, an inspection of the blockchain may not necessarily associate all cryptocurrency stored in asset wallet 1922 as belonging to the same entity. The presence of a private ledger used for real-time transactions and maintained by the service provider system 1902, combined with updates to the public ledger at other times, allows for extremely fast transactions using cryptocurrency to be achieved. In some examples, the “private ledger” can refer to the asset ledger 1924, which in some examples, can utilize the private blockchain 1932, as described herein. The “public ledger” can correspond to the public blockchain 1914 associated with the asset network.

In at least one example, an asset ledger 1924, fiat currency ledger 1926, or the like associated with the user account 1910 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1924. In some examples, a user can receive fiat currency or another currency in the form of payment for a transaction with another user. In at least one example, at least a portion of such funds can be converted into cryptocurrency by the service provider system 1902 and used to fund the asset ledger 1924 of the user.

In examples, a user can also have an account in U.S. dollars, which can be tracked, for example, via the fiat currency ledger 1926. Such an account can be funded by transferring money from a bank account at a third-party bank to an account maintained by the service provider system 1902 as is conventionally known. In some examples, a user can receive fiat currency in the form of payment for a transaction with another user. In such examples, at least a portion of such funds can be used to fund the fiat currency ledger 1926.

In some examples, a user can have one or more internal payment cards registered with the service provider system 1902. Internal payment cards can be linked to one or more of the accounts associated with the user account 1910. In some embodiments, options with respect to internal payment cards can be adjusted and managed using an application (e.g., the payment application 1826, a wallet application 1912, etc.).

In at least one example, the user account 1910 can be associated with the asset wallet accessible via a wallet application 1912 of the user device 1904, or a stored balance for use in payment transactions, peer-to-peer transactions, payroll payments, etc. In at least one example, the asset wallet 1922 can store data indicating an address provided for receipt of a cryptocurrency transaction. In at least one example, the balance of the asset wallet 1922 can be based at least in part on a balance of the asset ledger 1924. In at least one example, funds availed via the asset wallet 1922 can be stored in the asset wallet 1922. Funds availed via the asset wallet 1922 can be tracked via the asset ledger 1924. The asset wallet 1922, however, can be associated with additional cryptocurrency funds.

In at least one example, when the service provider system 1902 includes a private blockchain 1932 for recording and validating cryptocurrency transactions, the asset wallet 1922 can be used instead of, or in addition to, the asset ledger 1924. For example, a merchant can provide the address of the asset wallet 1922 for receiving payments. In an example where a customer is paying in cryptocurrency and the customer has their own cryptocurrency wallet account associated with the service provider system 1902, the customer can send a message signed by its private key including its wallet address (i.e., of the customer) and identifying the cryptocurrency and value to be transferred to the merchant’s asset wallet 1922. The service provider system 1902 can complete the transaction by reducing the cryptocurrency balance in the customer’s cryptocurrency wallet and increasing the cryptocurrency balance in the merchant’s asset wallet 1922. In addition to recording the transaction in the respective cryptocurrency wallets, the transaction can be recorded in the private blockchain 1932 and the transaction can be confirmed. A user can perform a similar transaction with cryptocurrency in a peer-to-peer transaction as described above.

While the asset ledger 1924 and/or asset wallet 1922 are each described above with reference to cryptocurrency, the asset ledger 1924 and/or asset wallet 1922 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1902 is an aspect of the technology disclosed that enables technical advantages of increased processing speed and improved security.

The description of the environment 1900 above generally relates to a centralized service provider system 1902 that at least partially facilitates storing and managing assets in the data store 1906. However, the environment 1900 may also facilitate decentralized storage and management of assets alternatively or in addition to centralized storage and management as described above. For instance, the environment 1900 may include a decentralized platform implemented using a plurality of nodes (e.g., web nodes), an example of which is illustrated as node 1916. The node 1916 is representative of a computer or other device tasked with validating transactions and/or maintaining a copy of a blockchain ledger, such as a ledger associated with the public blockchain 1914. The decentralized platform may be implemented via the environment 1900 through use of decentralized identifiers and verifiable credentials that are stored and managed by user devices 1904. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1902). The decentralized identity referenced by a decentralized identifier gives an entity control over what data can be accessed, stored, modified, and so forth by other entities, such as the service provider system 1902.

The node 1916, as representative of one of a plurality of decentralized nodes (e.g., decentralized web nodes), supports data storage and relays that allows entities, service provider systems, individuals, organizations and so forth to send, store, and receive encrypted or public messages and data. The node 1916 is universally addressable and is “crawlable” using data addressing in relation to the decentralized identifiers. The node 1916 is also configured to support decentralized replication of data across the nodes that is consistent across multiple nodes over time through continued data communication between the nodes in the decentralized platform. The node 1916 is configurable to support secure encryption through use of a cryptographic key associated with an individual’s decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1904 may be an issuer, a holder, and/or a verifier, as can the service provider system 1902.

In some examples, the user device 1904 may implement a wallet application 1912 configured to manage decentralized identifiers and/or verifiable credentials. For instance, the wallet application 1912 may provide a user interface for implementation of access controls to various data associated with the decentralized identifier by the service provider system 1902, to other user devices, and so forth. Additionally, the wallet application 1912 may be configured to provide functionality for resource transfers (e.g., cryptocurrency, fiat currency, etc.) with the service provider system 1902, other user devices, and the like, based on techniques described herein.

In some examples, the hardware wallet 1918 may store cryptocurrency assets in combination with the wallet application 1912 and the service provider system 1902. For instance, the hardware wallet 1918, the wallet application 1912, and the service provider system 1902 may each store a respective, different private key, where a transaction with the cryptocurrency assets is signed by at least two of the three private keys. The user interface provided by the wallet application 1912 may allow a user to request a transaction. The wallet application 1912 may then sign the transaction with the private key of the wallet application 1912, have either the hardware wallet 1918 or the service provider system 1902 use a second of the three private keys to sign the transaction, and then provide the transaction with two signatures to the public blockchain 1914 for processing.

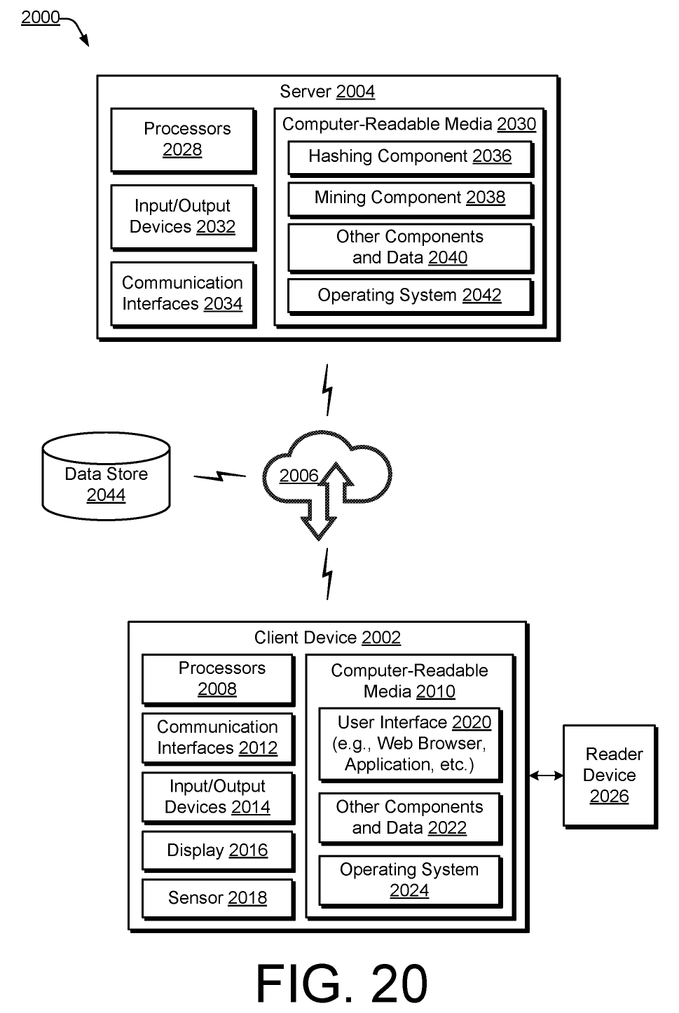

FIG. 20 depicts an illustrative block diagram illustrating a system 2000 for performing techniques described herein. The system 2000 includes a user device 2002, that communicates with server computing device(s) (e.g., server(s) 2004) via network(s) 2006 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 2002 is illustrated, in additional or alternate examples, the system 2000 can have multiple user devices, as described above with reference to FIG. 18.

In some examples, the client device 2002 and/or the server 2004 can include, and/or be examples of, hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the hashing system that performs the process 1700. The user interface 2020 can be an example of user interfaces associated with mining and/or hashing (e.g., the lights 1330 and/or buttons 1335 and/or control board 1530), for instance in the context of any of the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the hashing system that performs the process 1700, or vice versa.

In at least one example, the user device 2002 can be any suitable type of computing device, e.g., portable, semi-portable, semi-stationary, or stationary. Some examples of the user device 2002 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 2002 can be any computing device capable of sending communications and performing the functions according to the techniques described herein. The user device 2002 can include devices, e.g., payment card readers, or components capable of accepting payments, as described below. The user device 2002 may be representative of, and provide functionality for, the user devices 1806 described in relation to FIG. 18.

In the illustrated example, the user device 2002 includes one or more processors 2008, one or more computer-readable media 2010, one or more communication interface(s) 2012, one or more input/output (I/O) devices 2014, a display 2016, sensor(s) 2018, one or more encoders 2046, and one or more decoders 2048.

In at least one example, each processor 2008 can itself comprise one or more processors or processing cores. For example, the processor(s) 2008 can be implemented as one or more microprocessors, microcomputers, microcontrollers, digital signal processors, central processing units, state machines, logic circuitries, and/or any devices that manipulate signals based on operational instructions. In some examples, the processor(s) 2008 can be one or more hardware processors and/or logic circuits of any suitable type specifically programmed or configured to execute the algorithms and processes described herein. The processor(s) 2008 can be configured to fetch and execute computer-readable processor-executable instructions stored in the computer-readable media 2010.

Depending on the configuration of the user device 2002, the computer-readable media 2010 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 2010 can include, but is not limited to, RAM, ROM, EEPROM, flash memory, solid-state storage, magnetic disk storage, optical storage, and/or other computer-readable media technology. Further, in some examples, the user device 2002 can access external storage, such as RAID storage systems, storage arrays, network attached storage, storage area networks, cloud storage, or any other medium that can be used to store information and that can be accessed by the processor(s) 2008 directly or through another computing device or network. Accordingly, the computer-readable media 2010 can be computer storage media able to store instructions, components or components that can be executed by the processor(s) 2008. Further, when mentioned, non-transitory computer-readable media exclude media such as energy, carrier signals, electromagnetic waves, and signals per se.

The computer-readable media 2010 can be used to store and maintain any number of functional components that are executable by the processor(s) 2008. In some implementations, these functional components comprise instructions or programs that are executable by the processor(s) 2008 and that, when executed, implement operational logic for performing the actions and services attributed above to the user device 2002. Functional components stored in the computer-readable media 2010 can include a user interface 2020 to enable users to interact with the user device 2002, and thus the server(s) 2004 and/or other networked devices. In some examples, the user interface 2020 can include a UI associated with a mining application used to perform, control, and/or monitor the mining operations disclosed herein, as performed using the mining ASIC(s) of the hashboard(s) disclosed herein. In at least one example, a user can interact with the user interface via touch input, spoken input, gesture, or any other type of input. The word “input” is also used to describe “contextual” input that may not be directly provided by the user via the user interface 2020. For example, user’s interactions with the user interface 2020 are analyzed using, e.g., natural language processing techniques, user movement tracking techniques, eye tracking techniques, etc. to determine context or intent of the user, which may be treated in a manner similar to “direct” user input.

Depending on the type of the user device 2002, the computer-readable media 2010 can also optionally include other functional components and data, such as other components and data 2022, which can include programs, drivers, etc., and the data used or generated by the functional components. In addition, the computer-readable media 2010 can also store data, data structures and the like, that are used by the functional components. Further, the user device 2002 can include many other logical, programmatic and physical components, of which those described are merely examples that are related to the discussion herein.

In at least one example, the computer-readable media 2010 can include additional functional components, such as an operating system 2024 for controlling and managing various functions of the user device 2002 and for enabling user interactions.

The communication interface(s) 2012 can include one or more interfaces and hardware components for enabling communication with various other devices, such as over the network(s) 2006 or directly. For example, communication interface(s) 2012 can enable communication through one or more network(s) 2006, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 2006 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be disclosed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 2002 can further include one or more input/output (I/O) devices 2014. The I/O devices 2014 can include speakers, a microphone, a camera, and various user controls (e.g., buttons, a joystick, a keyboard, a keypad, etc.), a haptic output device, and so forth. The I/O devices 2014 can also include attachments that leverage the accessories (audio-jack, USB-C, Bluetooth, etc.) to connect with the user device 2002.

In at least one example, user device 2002 can include a display 2016. Depending on the type of computing device(s) used as the user device 2002, the display 2016 can employ any suitable display technology. For example, the display 2016 can be a liquid crystal display, a plasma display, a light emitting diode display, an OLED (organic light-emitting diode) display, an electronic paper display, or any other suitable type of display able to present digital content thereon. In at least one example, the display 2016 can be an augmented reality display, a virtual reality display, or any other display able to present and/or project digital content. In some examples, the display 2016 can have a touch sensor associated with the display 2016 to provide a touchscreen display configured to receive touch inputs for enabling interaction with a graphic interface presented on the display 2016. Accordingly, implementations herein are not limited to any particular display technology. In some examples, the user device 2002 may not include the display 2016, and information can be presented by other means, such as aurally, haptically, etc.

In addition, the user device 2002 can include sensor(s) 2018. The sensor(s) 2018 can include a global positioning system (“GPS”) device able to indicate location information. Further, the sensor(s) 2018 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 1810, the P2P platform 1812, and/or the media content platform 1814, described above, to provide one or more services. That is, in some examples, the service provider can implement geofencing to provide particular services to users by the merchant platform 1810, the P2P platform 1812, and/or the media content platform 1814.

In examples, the user device 2002 includes a codec system, which may comprise an encoder 2046 and/or a decoder 2048. The encoder 2046 is configured to encode a data stream or signal from an analog signal (e.g., an analog audio signal, an analog video signal, etc.) to a digital signal for transmission or storage. The decoder 2048 is configured to convert the digital signal back to an analog signal, such as for playback or editing. In some cases, the encoder 2046 may be configured to encode the data stream or analog signal in an encrypted format, and the decoder 2048 may accordingly be configured to decrypt the digital signal as part of the decoding process (e.g., using a cryptographic key). Additionally, in some examples, the encoder 2046 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 2046 and/or the decoder 2048 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 2000, the server 2004 may include an encoder 2046 and/or a decoder 2048 as well.

Additionally, the user device 2002 can include various other components that are not shown, examples of which include removable storage, a power source, such as a battery and power control unit, a barcode scanner, a printer, a cash drawer, and so forth.

In addition, as described in relation to FIG. 18, the user device 2002 can include, be connectable to, or otherwise be coupled to a reader device 2026, for reading payment instruments and/or identifiers associated with payment objects. The reader device 2026 can include a read head for reading a magnetic strip of a payment card, and further can include encryption technology for encrypting the information read from the magnetic strip. Additionally or alternatively, the reader device 2026 can be an EMV payment reader, which in some examples, can be embedded in the user device 2002. Moreover, numerous other types of readers can be employed with the user device 2002 herein, depending on the type and configuration of the user device 2002.

The reader device 2026 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 2026 may include hardware implementation, such as slots, magnetic tracks, and rails with one or more sensors or electrical contacts to facilitate detection and acceptance of a payment instrument. That is, the reader device 2026 may include hardware implementations to enable the reader device 2026 to interact with a payment instrument via a swipe , a dip , or a tap to obtain payment data associated with a customer. Additionally or optionally, the reader device 2026 may also include a biometric sensor to receive and process biometric characteristics and process them as payment instruments, given that such biometric characteristics are registered with the payment service and connected to a financial account with a bank server. The reader device 2026 may include processing unit(s), computer-readable media, a reader chip, a transaction chip, a timer, a clock, a network interface, a power supply, and so on. That is, the reader device 2026 may include any of the computing components described herein with reference to the user device 2002 to implement the functionality provided by the reader device 2026.

In examples, the reader device 2026 includes a reader chip, which may perform functionality to control the power supply, among other functionality of the reader device 2026. The power supply may include one or more power supplies such as a physical connection to AC power or a battery. Power supply may include power conversion circuitry for converting AC power and generating a plurality of DC voltages for use by components of reader device 2026. When power supply includes a battery, the battery may be charged via a physical power connection, via inductive charging, or via any other suitable method.

The reader device 2026 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 2002, which can be a POS terminal, and the reader device 2026 are shown as separate devices, in additional or alternative examples, the user device 2002 and the reader device 2026 can be part of a single device, which may be a battery-operated device. In some examples, the reader device 2026 can have a display integrated therewith, which can be in addition to (or as an alternative of) the display 2016 associated with the user device 2002.

The server(s) 2004 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 2004 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 2004 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 2004 can include one or more processors 2028, one or more computer-readable media 2030, one or more I/O devices 2032, and one or more communication interfaces 2034. Each processor 2028 can be a single processing unit or a number of processing units, and can include single or multiple computing units or multiple processing cores. The processor(s) 2028 can be implemented as one or more microprocessors, microcomputers, microcontrollers, digital signal processors, central processing units, state machines, logic circuitries, and/or any devices that manipulate signals based on operational instructions. For example, the processor(s) 2028 can be one or more hardware processors and/or logic circuits of any suitable type specifically programmed or configured to execute the algorithms and processes described herein. The processor(s) 2028 can be configured to fetch and execute computer-readable instructions stored in the computer-readable media 2030, which can program the processor(s) 2028 to perform the functions described herein.

The computer-readable media 2030 can include volatile and nonvolatile memory and/or removable and non-removable media implemented in any type of technology for storage of information, such as computer-readable instructions, data structures, program components, or other data. Such computer-readable media 2030 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 2004, the computer-readable media 2030 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 2030 can be used to store any number of functional components that are executable by the processor(s) 2028. In many implementations, these functional components comprise instructions or programs that are executable by the processors 2028 and that, when executed, specifically configure the one or more processors 2028 to perform the actions attributed above to the merchant platform 1810, the P2P platform 1812, and/or the media content platform 1814. Functional components stored in the computer-readable media 2030 can optionally include a hashing component 2036, a mining component 2038, and one or more other components and data 2040. The computer-readable media 2030 can additionally include an operating system 2042 for controlling and managing various functions of the server(s) 2004.

In some examples, the hashing component 2036 can perform hashing operations, for instance including the hashing process 100, the primary hash process 115, and/or the secondary hash process 125. Examples of the hashing component 2036 can include the hashing engine 110, the hashing engine 200, the hashing engine 300, the hashing engine 400, the hashing engine 500, the hashing engine 600, the hashing engine 700, the hashing engine 800, the hashing engine 900, the architecture 1105, the architecture 1110, the architecture 1115, the architecture 1120, the hashing engine 1200, the mining system 1305, the hashing management architecture 1400, the mining system 1500, the hashing system that performs the process 1600, the hashing system that performs the process 1700, or a combination thereof.

In some examples, the mining component 2038 can perform mining operations using the hashing operations performed using the hashing component 2036. Examples of the mining component 2038 can include the mining system 1305, the hashing management architecture 1400, the mining system 1500, or a combination thereof.

The payment component can be configured to receive transaction data from POS systems. The payment component can transmit requests (e.g., authorization, capture, settlement, etc.) to payment service server computing device(s) to facilitate POS transactions between merchants and customers. The payment component can communicate the successes or failures of the POS transactions to the POS systems.

The training component can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 2002 and/or the server(s) 2004 for use at a time after the data models have been trained (e.g., at runtime).

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 2034 can include one or more interfaces and hardware components for enabling communication with various other devices, such as over the network(s) 2006 or directly. For example, communication interface(s) 2034 can enable communication through one or more network(s) 2006, which can include, but are not limited any type of network known in the art, as described herein.

The server(s) 2004 can further be equipped with various I/O devices 2032. Such I/O devices 2032 can include a display, various user interface controls (e.g., buttons, joystick, keyboard, mouse, touch screen, biometric or sensory input devices, etc.), audio speakers, connection ports and so forth.

In at least one example, the system 2000 can include a datastore 2044 that can be configured to store data that is accessible, manageable, and updatable. In some examples, the datastore 2044 can be integrated with the user device 2002 and/or the server(s) 2004. In other examples, as shown in FIG. 20, the datastore 2044 can be located remotely from the server(s) 2004 and can be accessible to the server(s) 2004. The datastore 2044 can comprise multiple databases and/or servers connected locally and/or remotely via the network(s) 2006. In at least one example, the datastore 2044 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist’s performance or stage name, band name, artist’s legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 2044 can store inventory database(s) and/or catalog database(s). As described above, an inventory can store data associated with a quantity of each item that a merchant has available to the merchant. Furthermore, a catalog can store data associated with items that a merchant has available for acquisition. The datastore 2044 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The following clauses are provided as examples of the disclosure:

Clause 1. A method for operating a fine-grained pipelined micro-architecture for a primary-stage secure hash algorithm 256 (SHA-256) process, the method comprising: receiving an input message block partitioned into a plurality of 32-bit words; process the plurality of 32-bit words using a message expander datapath and a plurality of message compressor datapaths to generate intermediate hash data, wherein the message expander datapath operates according to a first clock speed, wherein the plurality of message compressor datapaths operate according to a second clock speed that is at least double the first clock speed, and wherein each temporal stage of the message expander datapath outputs intermediate expanded data to a corresponding temporal stage of the plurality of message compressor datapaths; and outputting the intermediate hash data to be further processed in a secondary-stage SHA-256 process.

Clause 2. The method of Clause 1, further comprising: receiving the intermediate hash data; processing the intermediate hash data using at least one secondary message expander datapath and a secondary message compressor datapath to generate a hash digest of the input message block, wherein the at least one secondary message expander datapath alternates temporally between a first message expander logic configuration and a second message expander logic configuration, and wherein the at least one secondary message expander datapath outputs intermediate expanded data to each temporal stage of the secondary message compressor datapath; and outputting the hash digest.

Clause 3. The method of any one of Clauses 1 to 2, wherein the second clock speed is double the first clock speed.

Clause 4. The method of any one of Clauses 1 to 3, wherein the message expander datapath operates according to message expander clock cycles, wherein the plurality of message compressor datapaths operate according to message compressor clock cycles, wherein the message expander clock cycles are at least twice as long as the message compressor clock cycles.

Clause 5. The method of any one of Clauses 1 to 4, wherein the message expander datapath performs a full round of message expansion logic per message expander clock cycle, and wherein the plurality of message compressor datapaths each perform a partial round of message expansion logic per message compressor clock cycle.

Clause 6. The method of any one of Clauses 1 to 5, wherein the primary-stage SHA-256 process is a SHA-1 portion of a SHA-256 process, and wherein the secondary-stage SHA-256 process is a SHA-2 portion of the SHA-256 process.

Clause 7. A method for secure hashing, the method comprising: receiving an input message; processing the input message using a message expander datapath and a plurality of message compressor datapaths to generate hash data, wherein the message expander datapath operates according to a first clock speed, wherein the plurality of message compressor datapaths operate according to a second clock speed that is faster than the first clock speed, and wherein each temporal stage of the message expander datapath outputs intermediate expanded data to a corresponding temporal stage of the plurality of message compressor datapaths; and outputting the hash data.

Clause 8. The method of Clause 7, further comprising: partitioning the input message into a plurality of words, wherein processing the input message using the message expander datapath and the plurality of message compressor datapaths includes processing the plurality of words using the message expander datapath and the plurality of message compressor datapaths.

Clause 9. The method of any one of Clauses 7 to 8, wherein outputting the hash data includes outputting the hash data to be further processed in a secondary hashing process.

Clause 10. The method of Clause 9, wherein processing the input message using the message expander datapath and the plurality of message compressor datapaths is part of a first portion of a secure hash algorithm 256 (SHA-256) process, and wherein the secondary hashing process is a second portion of the SHA-256 process.

Clause 11. The method of any one of Clauses 7 to 10, further comprising: receiving the hash data; processing the hash data using at least one secondary message expander datapath and a secondary message compressor datapath to generate a hash digest of the input message, wherein the at least one secondary message expander datapath alternates temporally between a first message expander logic configuration and a second message expander logic configuration, and wherein the at least one secondary message expander datapath outputs intermediate expanded data to each temporal stage of the secondary message compressor datapath; and outputting the hash digest.

Clause 12. The method of any one of Clauses 7 to 11, wherein the second clock speed that is double the first clock speed.

Clause 13. The method of any one of Clauses 7 to 12, wherein the message expander datapath operates according to message expander clock cycles, wherein the plurality of message compressor datapaths operate according to message compressor clock cycles, wherein the message expander clock cycles are at least twice as long as the message compressor clock cycles.

Clause 14. The method of Clause 13, wherein the message expander datapath includes one flop in each of the message expander clock cycles, and wherein plurality of message compressor datapaths each include a plurity of flops in each of the message expander clock cycles.

Clause 15. The method of any one of Clauses 7 to 14, wherein the message expander datapath performs a full round of message expansion logic per message expander clock cycle, and wherein the plurality of message compressor datapaths each perform a partial round of message expansion logic per message compressor clock cycle.

Clause 16. The method of any one of Clauses 7 to 15, wherein plurality of message compressor datapaths include at least four message compressor datapaths.

Clause 17. A system for secure hashing, the system comprising: at least one memory storing instructions; and at least one processor, wherein execution of the instructions by the at least one processor causes the at least one processor to: receive an input message; process the input message using a message expander datapath and a plurality of message compressor datapaths to generate hash data, wherein the message expander datapath operates according to a first clock speed, wherein the plurality of message compressor datapaths operate according to a second clock speed that is faster than the first clock speed, and wherein each temporal stage of the message expander datapath outputs intermediate expanded data to a corresponding temporal stage of the plurality of message compressor datapaths; and output the hash data.

Clause 18. The system of Clause 17, wherein the at least one processor includes at least one application-specific integrated circuit (ASIC) on a hashboard.

Clause 19. The system of any one of Clauses 17 to 18, wherein the execution of the instructions by the at least one processor causes the at least one processor to: receive the hash data; process the hash data using at least one secondary message expander datapath and a secondary message compressor datapath to generate a hash digest of the input message, wherein the at least one secondary message expander datapath alternates temporally between a first message expander logic configuration and a second message expander logic configuration, and wherein the at least one secondary message expander datapath outputs intermediate expanded data to each temporal stage of the secondary message compressor datapath; and output the hash digest.

Clause 20. The system of any one of Clauses 17 to 19, further comprising operations according to any one of Clauses 8 to 16.

Clause 21. A method for operating a fine-grained pipelined micro-architecture for a secondary-stage SHA-256 process, the method comprising: receiving intermediate hash data from a primary-stage SHA-256 process, the intermediate hash data based on an input message block; processing the intermediate hash data using at least one message expander datapath and a message compressor datapath to generate a hash digest of the input message block, wherein the at least one message expander datapath alternates temporally between a first message expander logic configuration and a second message expander logic configuration, and wherein the at least one message expander datapath outputs intermediate expanded data to each temporal stage of the message compressor datapath; and outputting the hash digest.

Clause 22. The method of Clause 21, wherein the at least one message expander datapath includes a single message expander datapath, wherein the single message expander datapath performs message expander logic under the first message expander logic configuration, and wherein the single message expander datapath waits without performing message expander logic under the second message expander logic configuration.

Clause 23. The method of any one of Clauses 21 to 22, wherein the at least one message expander datapath includes a first message expander datapath that performs first message expander datapath logic and a second message expander datapath that performs second message expander datapath logic, wherein a multiplexer routes the intermediate expanded data from the first message expander datapath to the message compressor datapath under the first message expander logic configuration, and wherein the multiplexer routes the intermediate expanded data from the second message expander datapath to the message compressor datapath under the second message expander logic configuration.

Clause 24. The method of any one of Clauses 21 to 23, wherein the at least one message expander datapath includes a first message expander datapath that uses a shared message expander logic and a second message expander datapath that uses the shared message expander logic, wherein a multiplexer causes the shared message expander logic to be performed under the first message expander datapath under the first message expander logic configuration, and wherein the multiplexer causes the shared message expander logic to be performed under the second message expander datapath under the second message expander logic configuration.

Clause 25. A method for secure hashing, the method comprising: receiving data; processing the data using at least one message expander datapath and a message compressor datapath to generate a hash digest, wherein the at least one message expander datapath alternates temporally between a first message expander logic configuration and a second message expander logic configuration, and wherein the at least one message expander datapath outputs intermediate expanded data to each temporal stage of the message compressor datapath; and outputting the hash digest.

Clause 26. The method of Clause 25, wherein the at least one message expander datapath includes a single message expander datapath, wherein the single message expander datapath performs message expander logic under the first message expander logic configuration, and wherein the single message expander datapath waits without performing message expander logic under the second message expander logic configuration.

Clause 27. The method of Clause 26, wherein the at least one message expander datapath alternating temporally between the first message expander logic configuration and the second message expander logic configuration includes the single message expander datapath alternating temporally from clock cycle to clock cycle between the first message expander logic configuration and the second message expander logic configuration.

Clause 28. The method of any one of Clauses 25 to 27, wherein the at least one message expander datapath includes a first message expander datapath that performs first message expander datapath logic and a second message expander datapath that performs second message expander datapath logic, wherein a multiplexer routes the intermediate expanded data from the first message expander datapath to the message compressor datapath under the first message expander logic configuration, and wherein the multiplexer routes the intermediate expanded data from the second message expander datapath to the message compressor datapath under the second message expander logic configuration.

Clause 29. The method of Clause 28, wherein the intermediate expanded data is generated using the first message expander datapath logic under the first message expander logic configuration, and wherein the intermediate expanded data is generated using the second message expander datapath logic under the second message expander logic configuration.

Clause 30. The method of any one of Clauses 28 to 29, wherein the at least one message expander datapath alternating temporally between the first message expander logic configuration and the second message expander logic configuration includes the multiplexer alternating temporally from message expander clock cycle to message expander clock cycle between the first message expander logic configuration and the second message expander logic configuration.

Clause 31. The method of any one of Clauses 25 to 30, wherein the at least one message expander datapath includes a first message expander datapath that uses a shared message expander logic and a second message expander datapath that uses the shared message expander logic, wherein a multiplexer causes the shared message expander logic to be performed under the first message expander datapath under the first message expander logic configuration, and wherein the multiplexer causes the shared message expander logic to be performed under the second message expander datapath under the second message expander logic configuration.

Clause 32. The method of Clause 31, wherein the at least one message expander datapath alternating temporally between the first message expander logic configuration and the second message expander logic configuration includes the multiplexer alternating temporally from message expander clock cycle to message expander clock cycle between the first message expander logic configuration and the second message expander logic configuration.

Clause 33. The method of any one of Clauses 31 to 32, wherein the first message expander datapath is a first shift register path, wherein the second message expander datapath is a second shift register path, and wherein the shared message expander logic includes combinational logic and arithmetic logic.

Clause 34. The method of any one of Clauses 25 to 33, wherein the at least one message expander datapath operates according to a first clock speed, wherein the message compressor datapath operates according to a second clock speed that is at least double the first clock speed.

Clause 35. The method of any one of Clauses 25 to 34, wherein the at least one message expander datapath operates according to a clock speed, wherein the message compressor datapath operates according to the clock speed.

Clause 36. The method of any one of Clauses 25 to 35, wherein the data includes intermediate hash data from a previous hashing process, the intermediate hash data based on an input message block, and wherein the hash digest is a hash of the input message block.

Clause 37. The method of any one of Clauses 25 to 36, wherein the hash digest is a hash of the data.

Clause 38. The method of any one of Clauses 25 to 37, further comprising: using the hash digest for mining a cryptocurrency.

Clause 39. A system for secure hashing, the system comprising: at least one memory storing instructions; and at least one processor, wherein execution of the instructions by the at least one processor causes the at least one processor to: receive data; process the data using at least one message expander datapath and a message compressor datapath to generate a hash digest, wherein the at least one message expander datapath alternates temporally between a first message expander logic configuration and a second message expander logic configuration, and wherein the at least one message expander datapath outputs intermediate expanded data to each temporal stage of the message compressor datapath; and output the hash digest.

Clause 40. The system of Clause 39, wherein the at least one processor includes at least one application-specific integrated circuit (ASIC) on a hashboard.

Clause 41. The system of any one of Clauses 39 to 40, further comprising operations according to any one of Clauses 26 to 38.

Clause 42. A non-transitory computer-readable medium having stored thereon instructions that, when executed by one or more processors, cause the one or more processors to perform operations according to any one of Clauses 1 to 41.

Clause 43. An apparatus comprising one or more means for performing operations according to any one of Clauses 1 to 41.

What is claimed is:

1. A method for operating a fine-grained pipelined micro-architecture for a secondary-stage SHA-256 process, the method comprising:
receiving intermediate hash data from a primary-stage SHA-256 process, the intermediate hash data based on an input message block;
processing the intermediate hash data using at least one message expander datapath and a message compressor datapath to generate a hash digest of the input message block, wherein the at least one message expander datapath alternates temporally between a first message expander logic configuration and a second message expander logic configuration, and wherein the at least one message expander datapath outputs intermediate expanded data to each temporal stage of the message compressor datapath; and
outputting the hash digest.

2. The method of claim 1, wherein the at least one message expander datapath includes a single message expander datapath, wherein the single message expander datapath performs message expander logic under the first message expander logic configuration, and wherein the single message expander datapath waits without performing message expander logic under the second message expander logic configuration.

3. The method of claim 1, wherein the at least one message expander datapath includes a first message expander datapath that performs first message expander datapath logic and a second message expander datapath that performs second message expander datapath logic, wherein a multiplexer routes the intermediate expanded data from the first message expander datapath to the message compressor datapath under the first message expander logic configuration, and wherein the multiplexer routes the intermediate expanded data from the second message expander datapath to the message compressor datapath under the second message expander logic configuration.

4. The method of claim 1, wherein the at least one message expander datapath includes a first message expander datapath that uses a shared message expander logic and a second message expander datapath that uses the shared message expander logic, wherein a multiplexer causes the shared message expander logic to be performed under the first message expander datapath under the first message expander logic configuration, and wherein the multiplexer causes the shared message expander logic to be performed under the second message expander datapath under the second message expander logic configuration.

5. A method for secure hashing, the method comprising:
receiving data;
processing the data using at least one message expander datapath and a message compressor datapath to generate a hash digest, wherein the at least one message expander datapath alternates temporally between a first message expander logic configuration and a second message expander logic configuration, and wherein the at least one message expander datapath outputs intermediate expanded data to each temporal stage of the message compressor datapath; and
outputting the hash digest.

6. The method of claim 5, wherein the at least one message expander datapath includes a single message expander datapath, wherein the single message expander datapath performs message expander logic under the first message expander logic configuration, and wherein the single message expander datapath waits without performing message expander logic under the second message expander logic configuration.

7. The method of claim 6, wherein the at least one message expander datapath alternating temporally between the first message expander logic configuration and the second message expander logic configuration includes the single message expander datapath alternating temporally from clock cycle to clock cycle between the first message expander logic configuration and the second message expander logic configuration.

8. The method of claim 5, wherein the at least one message expander datapath includes a first message expander datapath that performs first message expander datapath logic and a second message expander datapath that performs second message expander datapath logic, wherein a multiplexer routes the intermediate expanded data from the first message expander datapath to the message compressor datapath under the first message expander logic configuration, and wherein the multiplexer routes the intermediate expanded data from the second message expander datapath to the message compressor datapath under the second message expander logic configuration.

9. The method of claim 8, wherein the intermediate expanded data is generated using the first message expander datapath logic under the first message expander logic configuration, and wherein the intermediate expanded data is generated using the second message expander datapath logic under the second message expander logic configuration.

10. The method of claim 8, wherein the at least one message expander datapath alternating temporally between the first message expander logic configuration and the second message expander logic configuration includes the multiplexer alternating temporally from message expander clock cycle to message expander clock cycle between the first message expander logic configuration and the second message expander logic configuration.

11. The method of claim 5, wherein the at least one message expander datapath includes a first message expander datapath that uses a shared message expander logic and a second message expander datapath that uses the shared message expander logic, wherein a multiplexer causes the shared message expander logic to be performed under the first message expander datapath under the first message expander logic configuration, and wherein the multiplexer causes the shared message expander logic to be performed under the second message expander datapath under the second message expander logic configuration.

12. The method of claim 11, wherein the at least one message expander datapath alternating temporally between the first message expander logic configuration and the second message expander logic configuration includes the multiplexer alternating temporally from message expander clock cycle to message expander clock cycle between the first message expander logic configuration and the second message expander logic configuration.

13. The method of claim 11, wherein the first message expander datapath is a first shift register path, wherein the second message expander datapath is a second shift register path, and wherein the shared message expander logic includes combinational logic and arithmetic logic.

14. The method of claim 5, wherein the at least one message expander datapath operates according to a first clock speed, wherein the message compressor datapath operates according to a second clock speed that is at least double the first clock speed.

15. The method of claim 5, wherein the at least one message expander datapath operates according to a clock speed, wherein the message compressor datapath operates according to the clock speed.

16. The method of claim 5, wherein the data includes intermediate hash data from a previous hashing process, the intermediate hash data based on an input message block, and wherein the hash digest is a hash of the input message block.

17. The method of claim 5, wherein the hash digest is a hash of the data.

18. The method of claim 5, further comprising:
using the hash digest for mining a cryptocurrency.

19. A system for secure hashing, the system comprising:
at least one memory storing instructions; and
at least one processor, wherein execution of the instructions by the at least one processor causes the at least one processor to:
receive data;
process the data using at least one message expander datapath and a message compressor datapath to generate a hash digest, wherein the at least one message expander datapath alternates temporally between a first message expander logic configuration and a second message expander logic configuration, and wherein the at least one message expander datapath outputs intermediate expanded data to each temporal stage of the message compressor datapath; and
output the hash digest.

20. The system of claim 18, wherein the at least one processor includes at least one application-specific integrated circuit (ASIC) on a hashboard.
